(19) United States
(12) Patent Application Publication
(10) Pub. No.: US 2004/0229194 A1
(43) Pub. Date: Nov. 18, 2004

(54) Study aid system

(76) Inventor: George L. Yang, North Brunswick, NJ (US)

Correspondence Address: George L. Yang, 9105 Saracen drive, Pikesville, MD, 21208, US

(21) Appl. No.: 10/437,100

(22) Filed: May 13, 2003

(51) Int. Cl. G09B 19/00

(52) U.S. Cl. 434/118

(57) ABSTRACT

The study aid system provides various interfaces to help author to describe objects and to help reader to access related information systematically and dynamically. First, the system enables author to produce an overall writing guide, to specify the default aspects of each type of object, and to link different type of object to a different subroutine. Each subroutine provides necessary interfaces for author to supply related information to fill each default aspect of an object methodically. Further, the system lets reader to specify the default aspects of each type of object, to generate a customized study course, to control how information to be accessed, and to explore an object from one aspect by another. Furthermore, the system guides reader to survey a resource to produce an overall reading guide by providing recommendations, questions, and interfaces. Moreover, the system helps reader to understand an object better by describing the object differently and by letting reader search, compare, display related objects from database, and jump from one object to another object. Besides, the system provides interfaces for reader to build a unified knowledge system by inputting objects into database, taking notes, putting tags on related objects, and linking an object to related objects in database. In addition, the system helps reader to solve a problem by capturing reader's feedback, raising proper questions at proper time during a problem-solving process, and letting reader to search for related objects from database. Additionally, the system generates blank-filling problems, true-and-false problems, multiple choice problems, partially completed lists, partially completed maps and asks reader to solve problems, complete the partially completed lists, and complete the partially completed maps.

### FIELD OF THE INVENTION

The invention is generally related to artificial intelligence. More particularly the invention is related to a study aid system for helping author to describe objects from many different aspects, for guiding reader to access information systematically, and for enabling user to link, compare, and display objects effectively.

### BACKGROUND OF THE INVENTION

Reading has played a very important role in people's daily life and it is necessary for a study aid system to help people on their reading. People take a lot of time and tremendous efforts to acquire knowledge by reading. First, modern society needs more people to have higher education. Starting from primary school, an ordinary person spends more than 20 years in school to obtain a doctor degree. One major task of a student is to read. Second, the information explosion era demands people to read intensively. Today since information is increasing exponentially and crossing many subjects, the competitions on many high technology industries are so intensive that these industries require their employees to update their knowledge all the time. Many people obtain most of the critical information closely related to their careers by reading professional books and magazines. Since speed and comprehension are two important issues related to reading, it is necessary to provide methods for helping people to increase their reading comprehension as well as speed and to solve their reading related problems.

A common problem related to reading is that people have no enough time to read in detail. To deal with the over-pouring information, many people have to gulp new information from time to time as machines. In order to overcome the problem, many programs on book, audiotape, and videotape teach people to read fast. Some programs coach people how to survey, how to move eyes quickly, how to focus by using a finger as a guide, how to turn page quickly, and so on. Other programs show people how to strength eye muscles, how to reduce eye fatigue, how to increase overall reading speed, how to enhance eye-brain connection, and so on. These programs may be very good for collecting some kind of information from a book such as names and addresses. Nevertheless, for information such as mathematical theorems, these programs alone may not be very helpful. To really understand mathematical theorems, people have to go through critical thinking. Without digesting information, people may become confused, find it is totally unreadable for the rest of a book, and finally give up. For this very reason, it is very difficult for people to speedily read an abstract book over night and really understand the book.

Another common problem related to reading is that different readers have different expectations on a book. Some reader may think a book very informative but other readers may find the same book totally unreadable. There could be some common requirements on a book for many readers. One common requirement for many readers is that a book should let them be able to see not only just each individual object but also the whole picture so that they will not get lost during study. Another common requirement for many readers is that a book should provide many connections and exercises. This requirement is based on the fact that people can understand new stuff when it is linked to what they have already known and remember better by actually doing. However, generally different readers have different demands for a book. Some of these requirements may even contradict each other. When people know little about a particular topic, they may hope that a book should have enough introductions on background. When people have difficulty to understand an object, they may hope that the book should give more explanations on that object or explain that object from a different aspect. However, when people know a particular object well, they may just want to find out what is new in the book. Therefore, an ideal book for a reader should be prepared especially for the reader. Sometimes even a same reader may have quite different requirements on a book during different study stages. A reader may hope that the same information appears differently on different study stage. What the reader is looking for from a book when the reader starts reading the book may be significantly different from what the reader needs when the reader review the book. For example, when a reader just encounters a theorem, the reader may wish a book having more explanations on the theorem. Nevertheless, after the reader has understood the theorem, the reader may wish the book being more concise. In order to meet the needs of different readers during different study stages, an ideal book should be represented dynamically. Regular book just can not meet all these requirements. If author tries to cover every aspect, the book will become too puffy for reader to locate a particular information.

Another common problem related to teaching by oneself is that it is difficult to obtain help. People usually feel that it is easier to study a course with an instructor than to read books by themselves. There are several reasons. The first reason is that based on the questions asked by students or the facial expressions on students, an instructor can review related objects, give examples, or explain differently. However, when people study by themselves, they could get confused at one point and could not proceed further. Another reason is that an instructor can assign students necessary problems. Solving the problems helps students to understand related concepts and theorems better and makes students be ready for further study. Nevertheless, when people teach them by themselves, people intend to ignore necessary exercises and leap forward too quickly. Third reason is that an instructor usually gives necessary introduction on the background to make students feel more natural and provides intuitive explanation when students have difficulty to understand. Nowadays some academic books and papers intend to omit backgrounds, drop the reasons for introducing particular concepts, miss the whole pictures, and hide intuitive ideas for more academic look. When reading such a book or paper, people may understand every sentence of a theorem and its proof, but people still have no confident feeling about the theorem. Instead, they feel being lost in a maze. Only after people have spent a lot of time to finish reading the book or paper, they may suddenly see the whole picture. At this moment, people may realize that the essential idea is just a little bit and the rest is nothing more than the applications of the essential idea under different situations. An ideal study aid system, therefore, should capture reader's response and provide reader necessary help when needed.

Another common problem related to reading is that different books may confuse people. Different books could describe a same object differently. First, different books could use different symbols to denote a same object. Further, a book may start from an assumption and derive a conclusion based on that assumption while another book may take a reverse approach. The second book may take the conclusion in the first book as its assumption and derive the assumption in the first book as its conclusion. Furthermore, a book may separate a theorem in another book into several theorems while merge several theorems in another book into a theorem. In addition, two different books could take totally different approaches to prove a same theorem. Sometimes people could feel more confused about a theorem on a professional magazine when they have only some vague impressions on the related theorems. These papers on professional magazines usually are concise. They may use different symbols and describe a theorem related to several theorems scattered widely on many different resources. To understand the theorem, people have to spend a lot of time to review related resources and to find out the connection between the theorem and the ones they have learnt before. After going through all these hard works, finally people could understand the theorem. An ideal study aid system, therefore, should be able to change symbol easily, display clearly the connections among different approaches, and provide related information.

Another common problem related to reading is that many people have good analytic capabilities but poor memory. People could forget what they have told, heard, and learnt when they have not made vivid connections to what they learned. People could also forget about the ideas occurred in their minds in a split of second. Although many books teach people how to remember better, people intend to take short cuts and ignore good advice. To combat the retention loss, people have to take notes on notebooks. These notes are helpful for students to prepare an examination. By the nature of notes, many notes are not well organized. It takes time for people to find a related portion on a book from a note on a notebook and vise versa. Unless well organized, notes on notebooks are no much use after a long period. An ideal study aid system, therefore, should let reader take notes easily, find corresponding text from notes directly, and locate corresponding notes from a text straightforward.

Solving a problem is one of activities associated closely with reading. People such as engineers, scientists, and students have to solve relatively complex problems from time to time. The several books by George Polya give people good advice and example on how to solve a problem. However, people without strict training intend to forget about the advice especially when they are under pressure and in hurry. In addition, they may have to take a lot of time to search for related information scattered on different books even they are willing to follow the advice. An ideal study aid system, therefore, should help reader to search related information and solve problem by giving proper advice when needed.

Organizing and applying what people have learnt is another activity associated closely with reading. To understand, organize, and apply the information scatted on various resources is a big concern to many people. In many application fields such as wireless communications, tremendous papers are published every year. In order to understand a topic in depth, usually people have to narrow their focus to a very narrow domain. Some people may have the freedom to choose their favorite topics to study, but many people such as many system engineers in today's wireless communication field do not have. First, a system engineer has to go through sky-high standardization material to familiarize various protocols and to read countless papers to search for related algorithms. Then the system engineer has to understand and organize all algorithms well in order to compare them and implement them in design. In addition, the system engineer may wish to organize all the algorithms and link each algorithm to a corresponding program or tool. An ideal study aid system, therefore, should help user to organize their knowledge effectively.

Linking is a very important activity related to reading. People learn new information by linking it to what learnt before. What helping people to understand better and remember better is linking. People feel that they understand a new object when they can build a link between the new object and the objects they learned. How fast people can learn the new object depends on how fast people can establish such a link and how well people can remember the new object depend on how vividly people can establish such a link. In addition, how deeply people can understand the new object depends on from how many different ways people can examine the new object. An ideal study aid system, therefore, should let user be able to search for related objects, link a new object to other objects by many different ways, and examine an object from many different aspects.

Comparing is a very important step for understanding objects in deep. By comparing objects to find out the similarities and the discrepancies among them, people may understand each object better, try a method used on an object to a similar object, generalize or specialize a method, and possibly discover new directions. When related objects are over many chapters or many books, people have to take time to find them and put them together in order to compare them. Since many people trend to take short cut especially when they are in hurry, they may prefer not to compare at all or compare without listing all related conditions. An ideal study aid system, therefore, should list related objects together and help people to do comparison.

According to above discussions, an effective study aid system should help people to organize information, to link related objects together, to search for related information, to display information in various ways, and to examine objects from many aspects. Further, an effective study aid system should capture people's response, offer necessary help, provide interface for people to take notes and to locate related objects, aid people to solve problems, help people to compare, and point out possible new directions.

### OBJECTIVES AND SUMMARY OF THE INVENTION

The basic fact behind the invention is that people can learn new knowledge when the new knowledge is linked to what they have learnt before.

Another fact behind the invention is that people can understand new knowledge better when they can establish more connections between the new knowledge and what that they have learnt before.

Another fact behind the invention is that people can remember new knowledge better when they can establish vivid connections between the new knowledge and what that they have learnt before.

Another fact behind the invention is that people can learn more effectively through interactive study with a customized study guide.

An observation behind the invention is that many people can learn better when they are interested and under no pressure.

Therefore, a basic objective of the invention is to let people focus on critical thinking, to provide people necessary help, and to let computer take care of all other works.

Another objective of the invention is a study aid system to provide author a writing guide for letting author have a whole picture in mind all the time and describe objects systematically.

Another objective of the invention is a study aid system to generate various descriptions of an object by providing author interfaces to describe the object from many aspects and describe each aspect of the object in different ways.

Another objective of the invention is a study aid system to let author provide reading guide by assigning layer number to each object.

Another objective of the invention is a study aid system to let author view one's work in many ways to finalize a regular book targeted for a specific audience.

Another objective of the invention is a study aid system to let reader design customized course based on the background and time schedule of the reader.

Another objective of the invention is a study aid system to provide reader a reading guide for letting reader have a whole picture in mind all the time and examine objects systematically.

Another objective of the invention is a study aid system to let reader choose a proper way to access information about each type of object.

Another objective of the invention is a study aid system to allow different readers access information differently by following different layers and to let same reader access information differently by following different layers at different stages.

Another objective of the invention is a study aid system to guide reader to survey, to produce a reading guide, to provide interfaces for the reader to take notes, make link, and search for information, and to display information.

Another objective of the invention is a study aid system to provide interfaces for people to preprocess input information, to make a description formalized and accurate, to describe the object in set language, and to compare object by set theory.

Another objective of the invention is a study aid system to guide reader to review systematically by providing overall review guide and individual review instruction for each type of objects.

Another objective of the invention is a study aid system to assist reader to solve a problem by raising proper questions at proper time and by letting the reader search related objects and display the objects in various forms.

Another objective of the invention is a study aid system to generate problems for reader to take a self-test, to make comparison, and to display answer. The generated problems could include blank-filling problems, multiple choice problems, and problems modified from saved problems.

Another objective of the invention is a study aid system to help reader to acquire information through playing game by displaying some objects, specifying requirements, and asking the reader to list other related objects, color a map, and make connections.

Another objective of the invention is a study aid system to provide interfaces for user to search object in database by subject, keyword, structure, tag, and property.

Another objective of the invention is a study aid system to provide interfaces for people to display objects in forms of map, table, boundary text, figure, and cascaded multi-windows with each window having a tab.

Another objective of the invention is a study aid system to provide interfaces for user to attach an object with voice file and present the object by both displaying the object and playing the attached voice file.

Another objective of the invention is a study aid system to provide interfaces for user to modify an object in database, to add a new object, to find an equivalent object, and to link an object to other objects.

Another objective of the invention is a study aid system to capture user's feedback, evaluate progress, adjust help level, and generate intelligent questions.

The study aid system of the invention provides writing guide for author to describe objects systematically, guides author to describe an object from different aspects, and lets author give several descriptions on each aspect. The system also lets author guide reader to access information by assigning layer number to each aspect of an object and to each description of an aspect. Further, the system enables author to convert information from one format to another to generate a presentation for a particular audience.

The study aid system of the invention provides reading guide for reader to access information systematically and guides reader to examine an object from different aspects. Further, the system also lets reader access information according to reader's background, familiarity, and time schedule by viewing objects with their layer numbers being same or within a range.

The study aid system of the invention help people to search related objects, to display information in various formats, to link related objects together, to compare objects, to review, and to solve problem. The system also lets people jump from one object to another, provides interface for people to take notes, and help people to locate related objects from notes and vice versa.

The study aid system of the invention guides reader to review a resource by letting reader generate a review guide, search and display related objects, explore an object from different aspects, take notes, establish links, and modify the links.

The study aid system of the invention helps reader to solve a problem by raising proper questions at each problem-solving stage and letting reader search and display related objects, explore an object from many aspects, take notes, and build links.

The study aid system of the invention helps people to preprocess input information, to modify an object, to create a new object, and to update database.

### BRIEF DESCRIPTION OF THE DRAWINGS

The accompanying drawings constituting a part of the specification, depict the preferred embodiments of the present invention, and together with the description, serve to explain the principle of the invention.

FIG. 1 illustrates the major procedures and tasks of a study aid system.

FIG. 2 illustrates the general structure of the study aid system.

FIG. 3 illustrates a dynamic teaching procedure with window interface.

FIG. 4 illustrates the description of a theorem and its related objects by layers.

FIG. 5A illustrates a relation among a set of definitions.

FIG. 5B illustrates a relation among a set of theorems and corollaries.

FIG. 6A illustrates a flowchart to prepare a theorem.

FIG. 6B illustrates a preparing theorem subroutine with window interface.

FIG. 7A illustrates a flowchart to learn a theorem.

FIG. 7B illustrates a learning theorem subroutine with window interface.

FIG. 8 illustrates a dynamic learning procedure with window interface.

FIG. 9 illustrates a studying theorem subroutine with window interface.

FIG. 10 illustrates a review procedure with a window interface.

FIG. 11 illustrates a reviewing theorem subroutine with window interface.

FIG. 12 illustrates a reviewing problem subroutine with window interface.

FIG. 13 illustrates a solving problem procedure with window interface.

FIG. 14 illustrates a taking test procedure with window interface.

FIG. 15 illustrates a playing game procedure with window interface.

FIG. 16 illustrates a searching database task with window interface.

FIG. 17 illustrates a preparing display task with window interface.

FIG. 18 illustrates the flowchart of a generating routine map procedure.

FIG. 19 illustrates the flowchart of a generating area map procedure.

FIG. 20 illustrates the flowchart of a generating table procedure.

FIG. 21 illustrates the flowchart of a generating boundary text procedure.

FIG. 22 illustrates a displaying object task with window interface.

FIG. 23 illustrates an updating database task with window interface.

FIG. 24 illustrates regulation task with window interface.

FIG. 25 illustrates an object in two different forms.

FIG. 26 illustrates a flowchart to check if two objects are identical.

FIG. 27 illustrates a flowchart to check if an object is contained in another object.

FIG. 28 illustrates a flowchart to find out the relative complement of two objects.

FIG. 29 illustrates a flowchart to find the union of two objects.

FIG. 30 illustrates a flowchart to check if an object is equivalent to another object.

FIG. 31 illustrates a flowchart to find the intersection of two objects.

FIG. 32 illustrates a flowchart to find the intersection of two objects, the relative complement of two objects, and the union of two objects.

FIG. 33 illustrates a map with a group of objects and their relations.

FIG. 34 illustrates a map with a group of objects, their relations, and more properties.

FIG. 35 illustrates the extra property assigned to a line, which gives more detail about the relation between two objects at each end of the line.

FIG. 36 illustrates a theorem from various aspects.

FIG. 37 illustrates a theorem in form of cascaded multi-windows with each window having a tab.

FIG. 38 illustrates three objects in the form of table.

### DETAILED DESCRIPTION OF THE PREFERRED EMBODIMENTS

Detailed description of the preferred embodiments is provided herein. The embodiments illustrate a study aid system by way of examples, not by way of limitations. Due to the great flexibility of software implementation, only the general functions of the study aid system will be described. It is to be understood that it could be easy for those skilled in the art to modify the embodiments in many different ways and implement the system by many different data structures and programming languages. Therefore, specific details disclosed are not to be interpreted as limitations, but rather as bases for the claims and as representative bases for teaching one to employ the present invention in virtually any appropriately detailed system, structure, and manner.

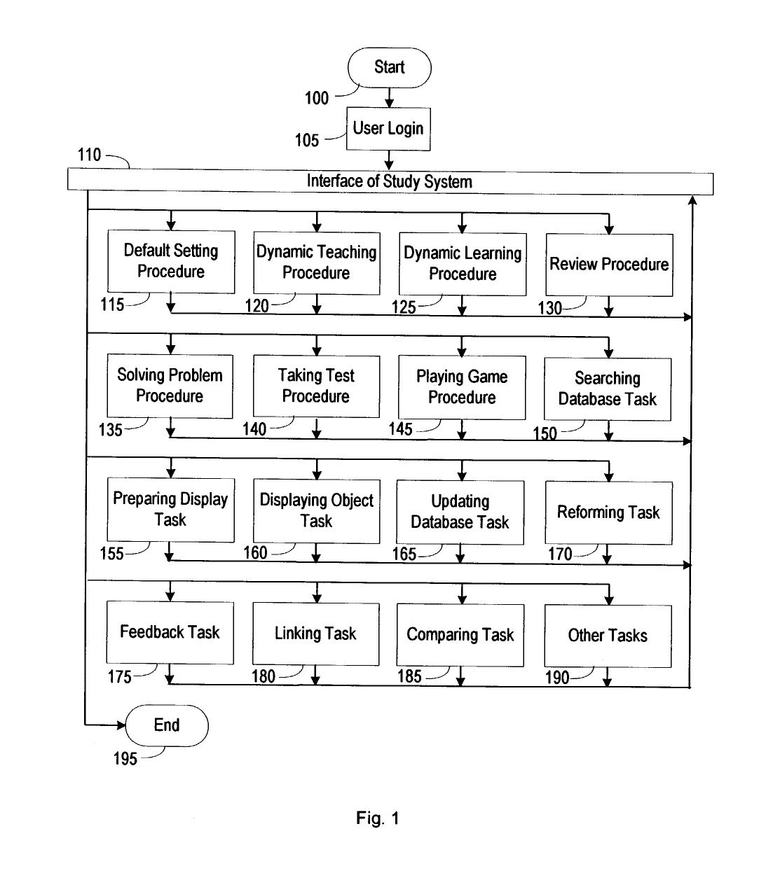

FIG. 1 shows the major procedures and tasks in a study aid system of the invention. The general functions will be given while the issues such as determining proper data structures and choosing right programming languages will be left as freedoms of an implementation.

When a user starts the system at 100, the system will provide interface so that the user can supply with account name and password to login in at 105. After identifying the user, the system will load the user information into computer memory. Then the system will provide a window interface 110 for user to start a computer routine. For description purpose, a computer routine may be referred as a procedure, a task, or a subroutine. A computer routine normally launched directly by user will be called as a procedure. A computer routine usually called by other computer routines will be entitled as a task. A computer routine generated by other computer routines will be labeled as a subroutine. In addition, in this detail description, an object is referred to any thing such a subject, a topic, a theorem, a definition, a figure, a property, or a group of sub-objects. The window interface 110 could be in any form such as menu, dialog box, or control box.

There are procedures 115 to 145, procedure 195, and tasks 150 to 190 under the control of the window interface 110. A procedure, a task, a subroutine, or a user could start other procedures, tasks, and subroutines to accomplish a particular goal. Some procedures and tasks have accompanied figures for their detail descriptions. For simplicity, only very important procedures, tasks, and subroutines will be displayed in the accompanied figures. Because procedures, tasks, and subroutine may interact with each other and a software program can be in many different forms, it is very difficult to cover all the possible cases. Therefore, usually a window interface will be used to describe the function of a procedure, a task, or a subroutine. If a procedure, a task, or a subroutine should start after another procedure, task, or subroutine, the first one will be grayed, disabled or unavailable until the second one has begun or finished. The arrow from a window interface to a procedure, a task, or a subroutine means that the window interface could start the procedure, the task, or the subroutine. The arrow from a procedure, a task, or a subroutine to a window interface means that the procedure, the task, or the subroutine returns the control back to the window interface after it finishes. Two or more procedures, tasks, or subroutines could run simultaneously.

The default setting procedure 115 provides necessary interfaces for user to set up the default global settings for the system and for each of the procedures 120 to 145 as well as the tasks 150 to 190. The default settings could include setting default subject, default topic, default displaying formats for different types of objects, help level for solving problem, search rule, time schedule, etc. A procedure or a task could have local setting. A local setting overwrites a global setting.

The dynamic teaching procedure 120 helps author to prepare information in electrical form systematically and reader to access the information dynamically.

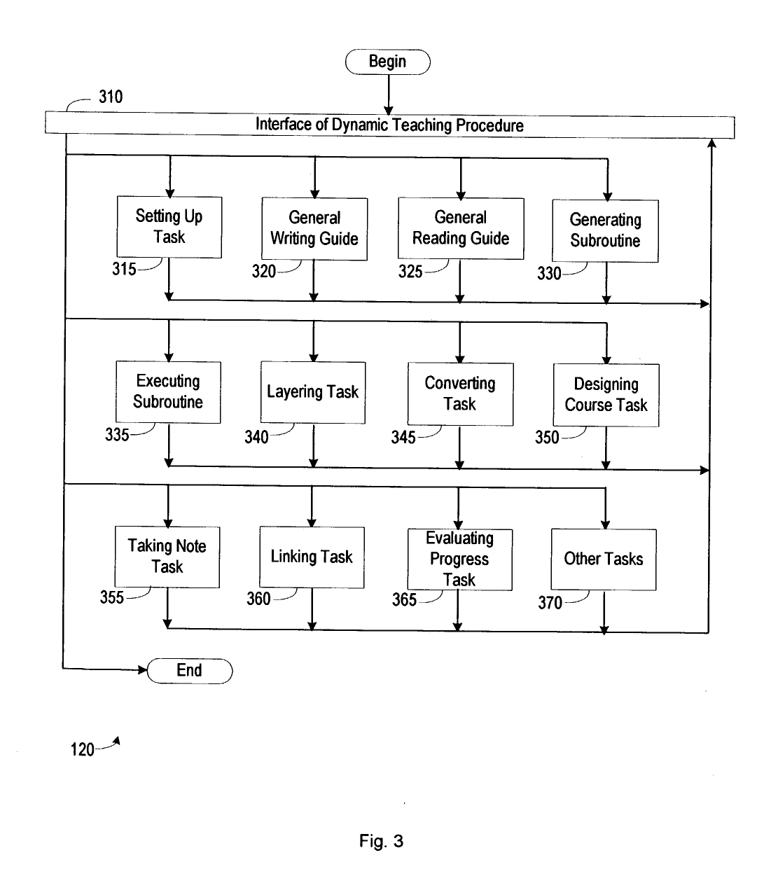

The dynamic teaching procedure 120 provides author interfaces for preparing information systematically from various aspects, in various formats, and in different levels to meet the needs of different readers. In addition, it provides reader interfaces for accessing the information in a best approach, examining object systematically, searching for specific information, and building customized links. The detail description of the dynamic teaching procedure 120 will be given in FIG. 3. For simplicity, a reader refers to any person reading an electrical book prepared with the system or any person reading a book and guided by the system. An author refers to any person writing an electrical book with the system. A user or a person refers to either an author or a reader.

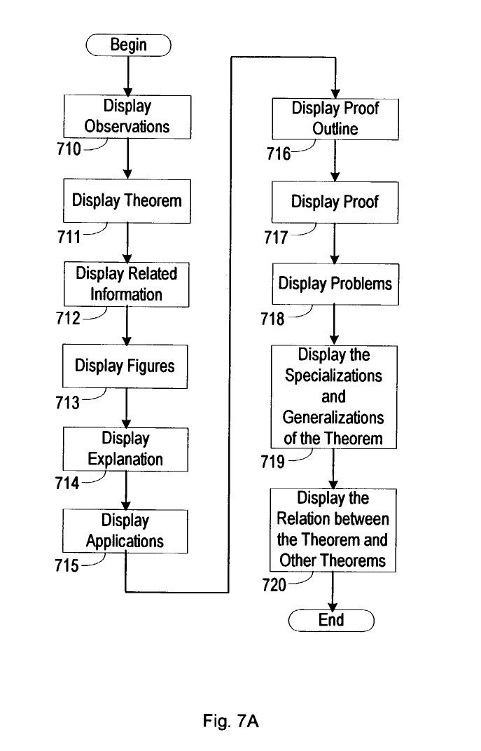

Since the information on a regular book or a regular magazine is not dynamically prepared, reader has to find the information by the reader himself or herself. The dynamic learning procedure 125 helps reader to access information systematically and understand information better. First, it guides reader to survey to obtain an overall picture of a book or a paper. Then it generates various subroutines to guide reader to examine every aspect of different types of objects systematically. Further, it provides interfaces for reader to input information, to link an object to databases, to search related information from database, to display the information in various formats, and to take notes. FIG. 8 will give detail description of the dynamic learning procedure 125.

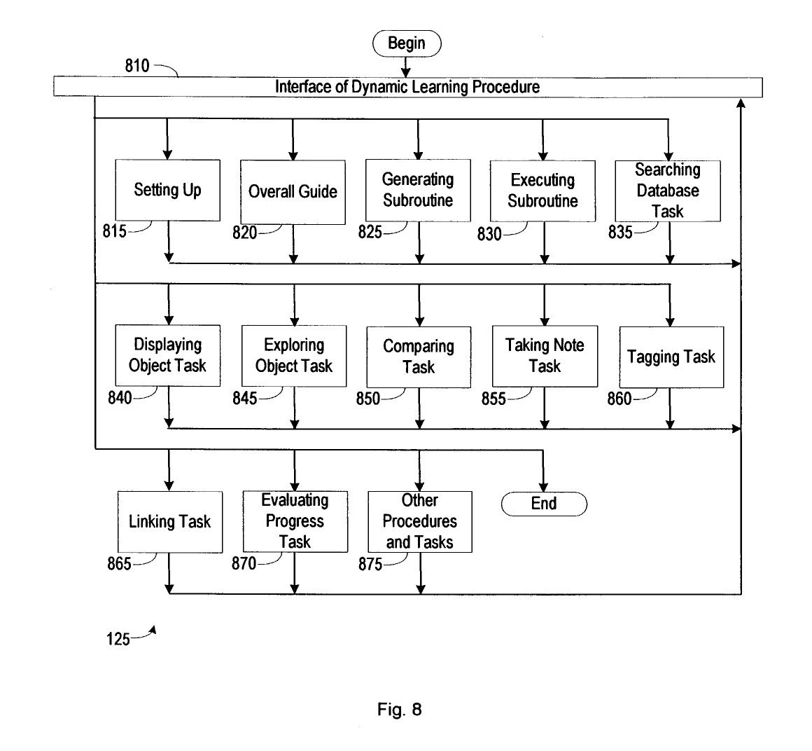

Effective review is one of essential elements to acquire long term memorization. The review procedure 130 guides reader to review efficiently, effectively, and systematically. Further, it lets reader take note, make link, search and display related information. FIG. 10 will give the detail of the review procedure 130.

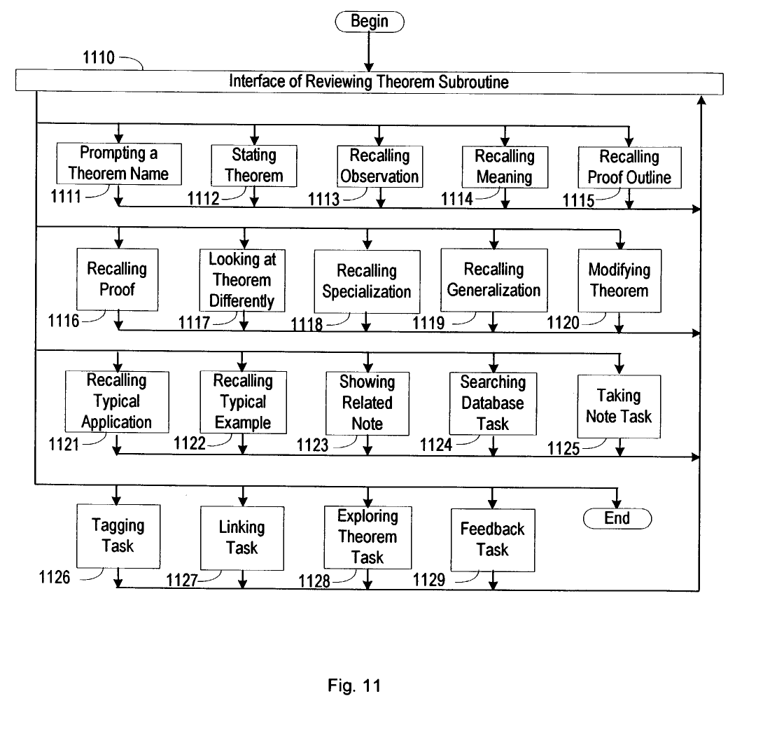

People do and people understand. Solving problems helps user to understand a complex theorem better. The solving problem procedure 135 supplies user proper advice at each stage of a solving problem process and captures user's feedback. Besides it lets user search for related information, display related objects, take notes, and make a typical problem and its solution become part of the user's database. The detail of the solving problem procedure 135 will be given in FIG. 13.

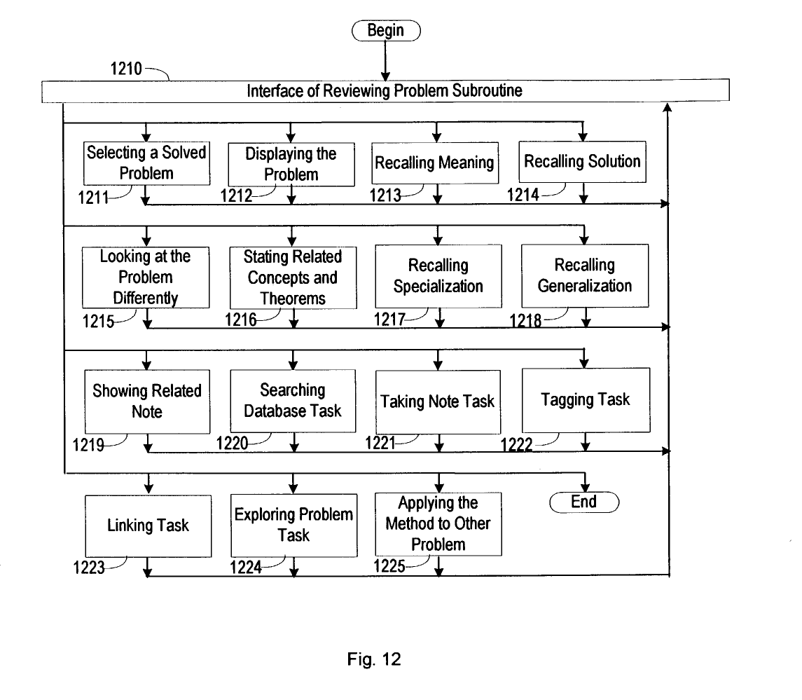

People take test to see how well they understand a subject for their own sake or by other people. Being a daily activity from primary school to graduate school, test plays a very important role in school. In order to get better test results, students have to review and therefore they can understand and remember better. Taking test procedure 140 shows that how the system generates self-test problems and questions. A student can use these problems and questions to take a self-test to prepare him or her better and to gain more confidence. FIG. 14 will present the taking test procedure 140 in detail.

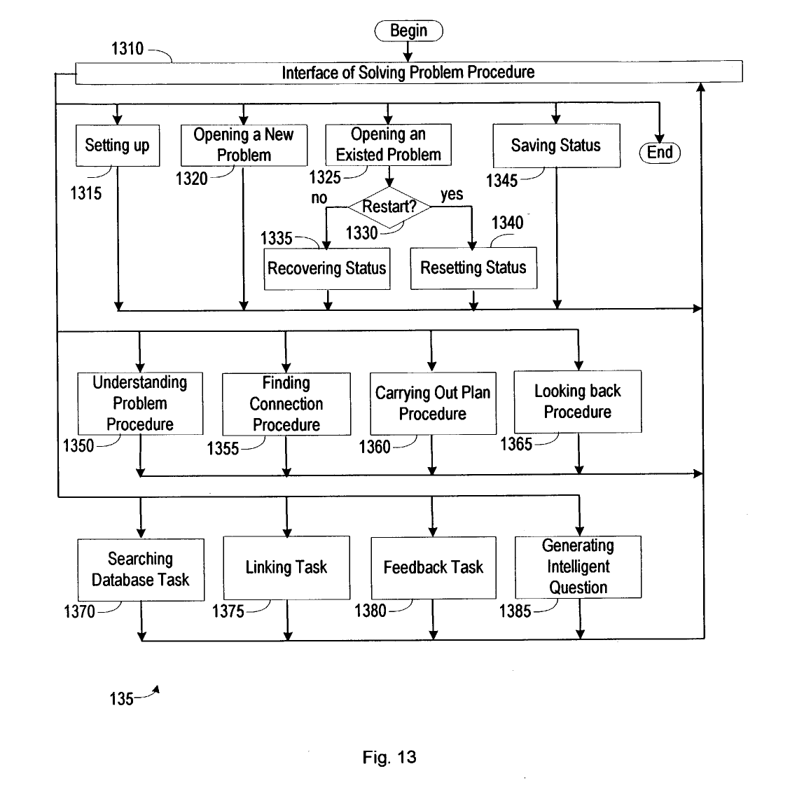

People have the capability to learn while playing. Many people find that they can learn better when they are under no pressure. The playing game procedure 145 shows how to generate games. This procedure relaxes people by letting people do easy works. While playing game, people will become familiar with related objects and remember them. The game could be in various forms such as coloring areas, making connections, filling blanks, selecting yes or no, and choosing one answer from multiple choices. The game could also let people search a path on a plane or in space, encourage people, and generate feedback. FIG. 15 will show the detail.

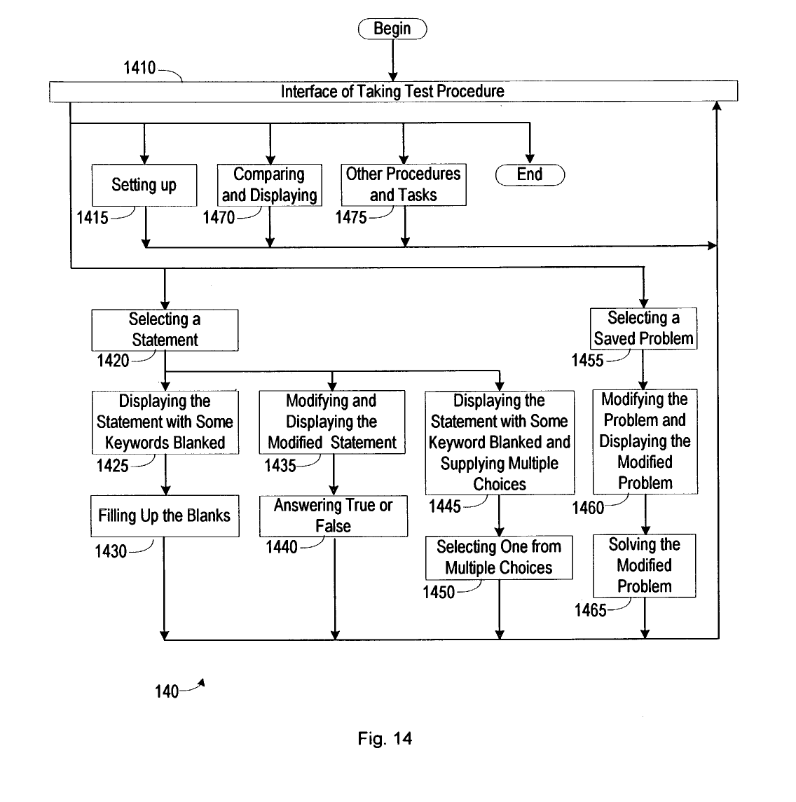

The searching database task 150 lets a user find related objects in database by keyword, subject, topic, links, similar structure, tag, or custom property. It lets user search for parent objects from a child object, search for child objects from a parent object, or search for sibling objects with one object is given. By examining all the related objects simultaneously, user may notice the connections, the similarities, and the differences among different objects and therefore could be stimulated to raise questions or to explore further. For detail see FIG. 16.

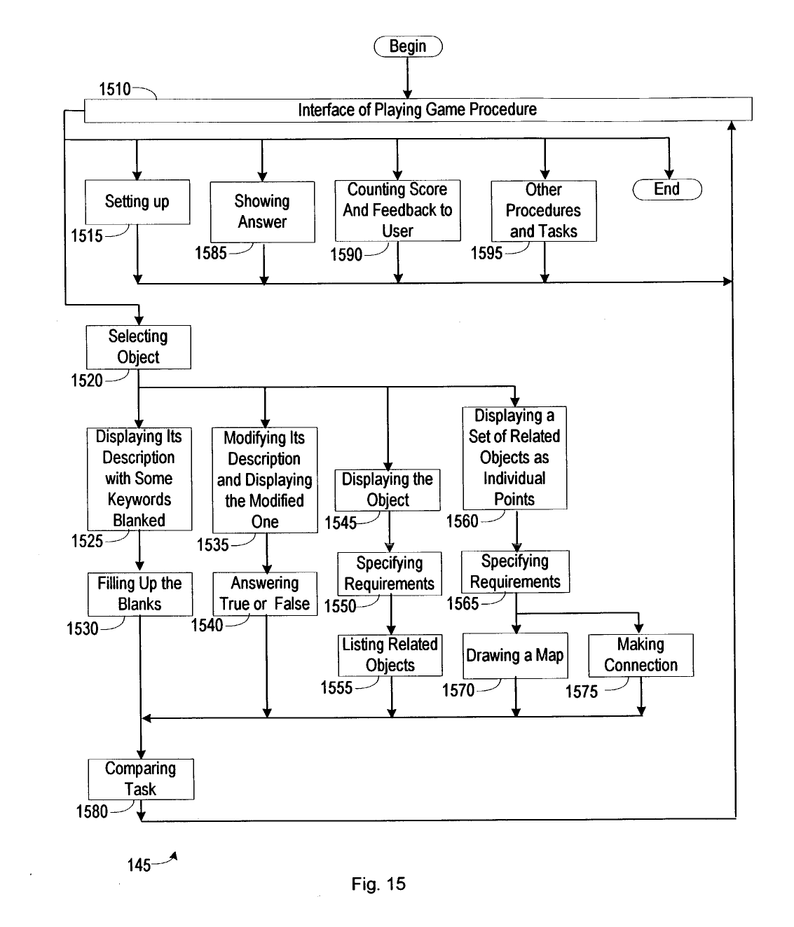

The preparing display task 155 lets a user start a corresponding subroutine to build a table, a boundary text, a tab control, or an information map. User can also link voice explanation to objects. FIG. 17 will give the details.

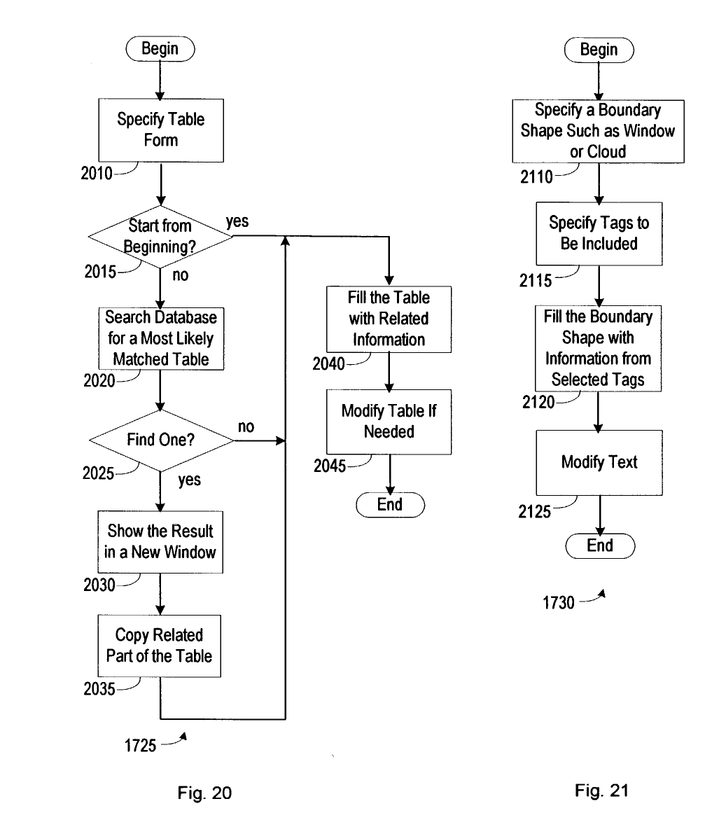

The displaying object task 160 displays an object or a group of objects in different ways to meet the needs of different users or the needs of a user at different study stages. The display forms could be information maps, tables, boundary texts, and bitmap figures. In addition, it could be a tab control, which is in form of cascaded multi-windows with each window having a tag. If an object has an associated voice file, the task also lets user listen to voice while displaying the object. The detail will be given in FIG. 22.

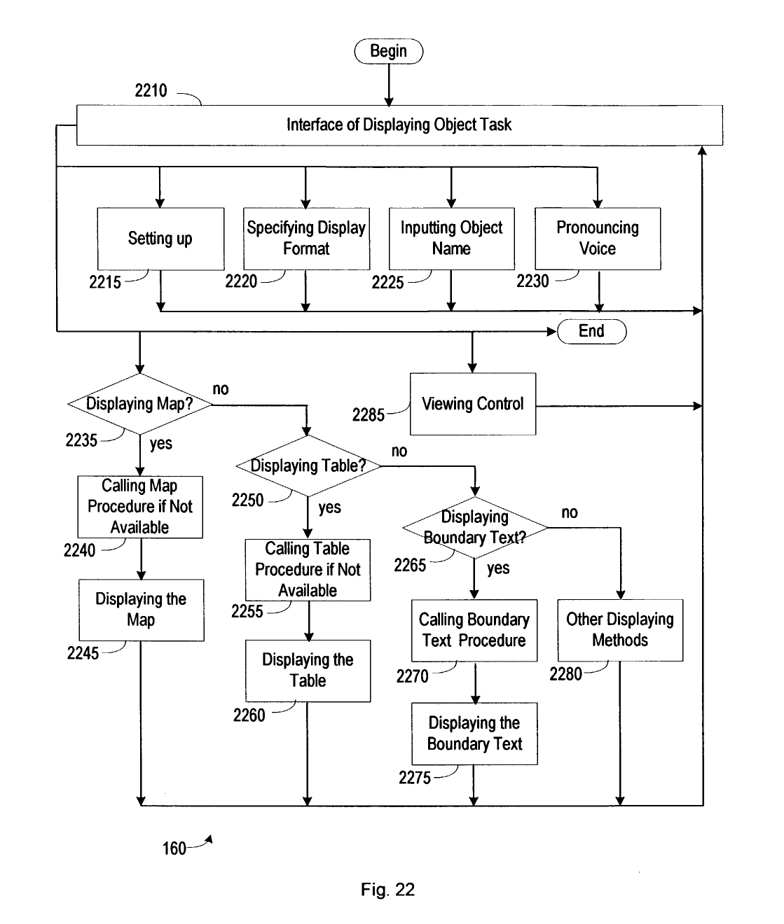

When user builds connections among objects, saves a theorem, a problem, or a note into database, attaches a new figure to an existed object, puts a tag on an object, or modifies an object, the database needs to be updated. The updating database task 165 is to update database. When an object is to be added into database, the task will check if there exists an identical object in database. If not, the task will check if there is an equivalent object in database. If not, the task will add the object into database. If there are some equivalent objects in database, the task will add the object into the database as one of the substitutes or simply discard the object. The detail of the updating database task 165 will be given in FIG. 23.

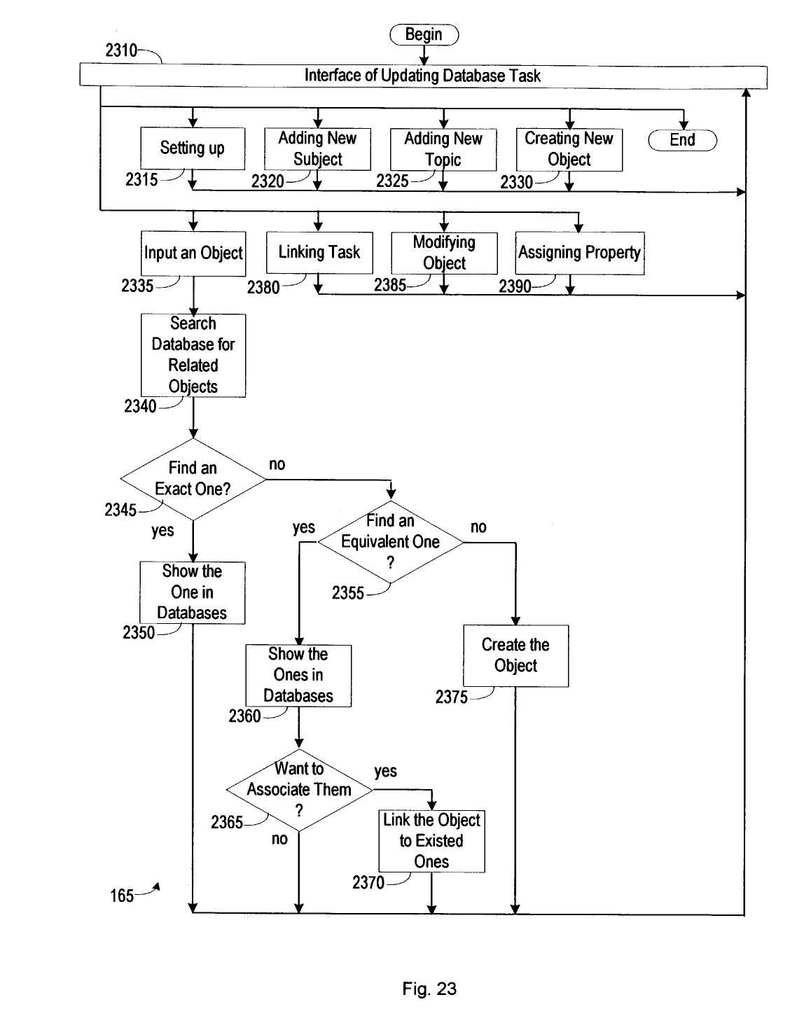

The reforming task 170 has two functions. The first function is to make the description of an object formalized in text and in formula. This function is referred as the regulation task. The detail of the regulation task will be given in FIG. 24. In many languages, people usually can describe an object in many different ways. The description of an object in one way appears differently from the description of the same object in a different way. Further, when an object has mathematical expression, there could be more than one of different mathematical expressions. Sometimes these different mathematical expressions could be obtained by replacing some symbols in an expression by different symbols. After the preprocessing of the regulation task, an input object could be identified correctly.

The second function of the reforming task 170 is to describe an object differently. The variant descriptions of an object will be saved by system. The system can exhibit an object differently by displaying a different description of the object. The system can also generate a new description of an object by substituting some components in its original description by their corresponding equivalents.

The feedback task 175 refers to capture user feedback and generate proper response by the system. The system may capture the text input, drawing, microphone input, time escaped, user selection, mouse movement, etc. Based on user feedback, the system may set up a proper help level, generate intelligent question, adjust teaching strategy, change problem assignment, display related objects, etc. For example, in the solving problem procedure 135, the system relies on user feedback to search and display objects, to review related objects, and to raise proper questions at proper time. Through this task, the system can collect information from user directly and indirectly. The typed text, figure scanned into system, and voice recorded into the system are information directly from user. The time escaped, how well user understands a topic, and so on are information indirectly from user. By capturing user information, the system can adjust guidance towards a particular user, obtain statistical estimation on a group of users on a specific topic, and help author to improve his or her work.

The linking task 180 may include any method of marking the relations between two objects or among a group of objects and any method to present the relations. Line, boundary shape, tag and highlight are some of the most common methods for showing the relations among objects.

A line is usually used to depict the relation between two objects. If two objects have a relation, user could use a line to connect these two objects. If two objects have multiple relations, user could use a line to connect these two objects with multiple relations attached to the line or use multiple lines to link these two objects with each relation attached to a corresponding line. In addition, lines with different line colors, line patterns, and line weights can be used to stand for different relations. If the relation between two objects is unsymmetrical, user could display the relation by a line with an arrow at one of its ends. If the relation is symmetrical, user could display the relation by a line with arrows at both of its ends or without arrow at either end. Further, user could specify the strength of a relation. When an object is heavily linked to another object, the relation could have heavier weight; while an object is loosely linked to another object, the relation could have less weight. For example, the conclusion of a theorem holds if all of the conditions of the theorem are valid. However, a condition may seem have more contribution on the conclusion than each of the rest conditions. To reflect this difference, user may wish to establish a heavier link between the conclusion and the condition and lighter links between the conclusion and each of the rest conditions.

A boundary shape is one of the most common ways to show a common property of a group of objects. Objects with a common property are included in a boundary shape while objects with a different common property are included in another boundary shape. For a group of objects, a sub set of the group may have a common property and a different sub set of the group may have a different common property. User could one boundary shape to include all the objects with the first common property and another boundary shape to include all the objects with the second common property. Further user could fill different boundary shapes with different colors and different area patterns.

A tag is another common way to mark a property on an object. User can examine an object from many different aspects with each different aspect of the object having a different tag. A tag could be a label for a well-defined property existing in many objects or a label for a custom defined property such as a specific question. With tags attached to objects, the system is able to list all the objects with a specific tag.

Usually there are two types of relations. One type of relations is temporal and another type is permanent. Some relations can be built easily. To save computer memory, people perhaps want to build these relations when needed. The relation based on a keyword among a group of theorems is an example of this type of relations. Some relations are difficult to build. To save time, people perhaps want to build these relations beforehand. Since usually the generalization of a theorem is a creative process, people perhaps want to link the generalization of the theorem with the theorem permanently. The permanent relation will be changed only when people explicitly tell the system to proceed.

The linking task 180 plays an important role to build a united knowledge database. When user reads a paper and finds some object interested, the user can input the object into user database and link it to related objects in database. With the links built among the objects in database, user can search database to find related objects.

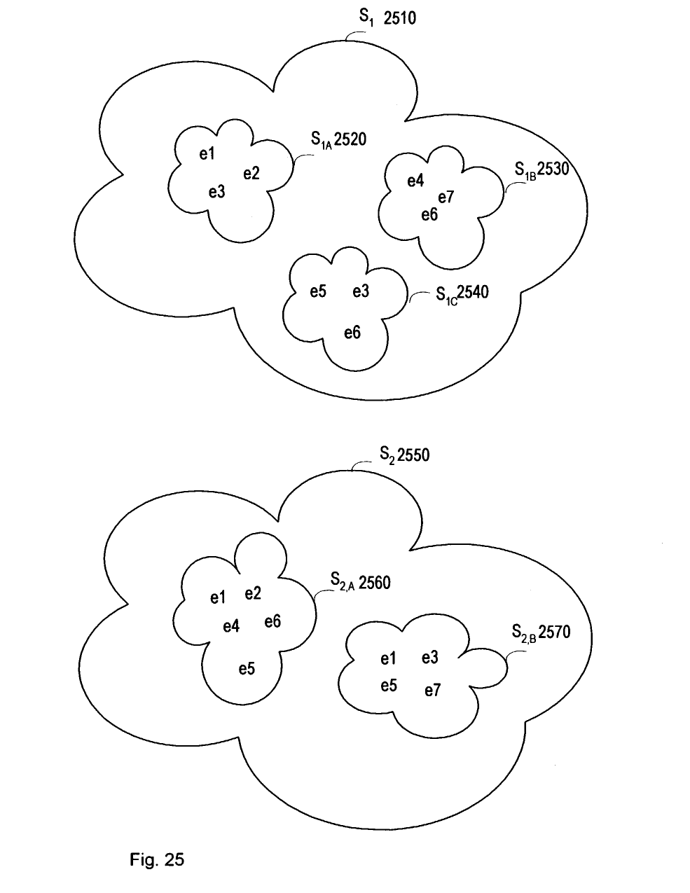

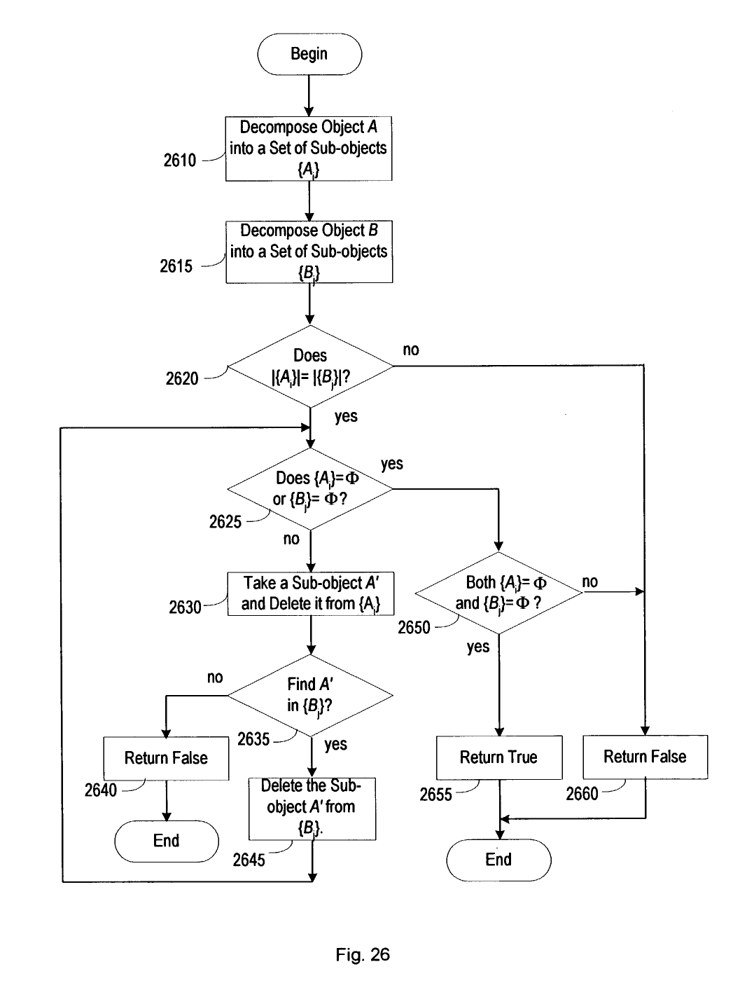

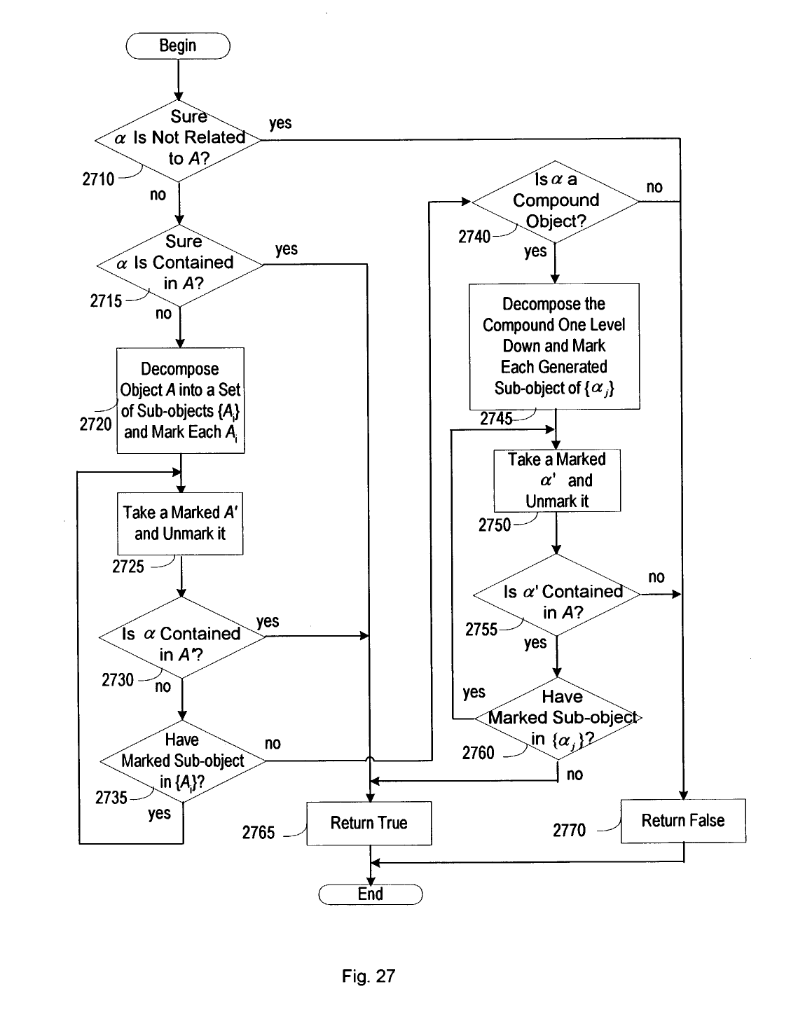

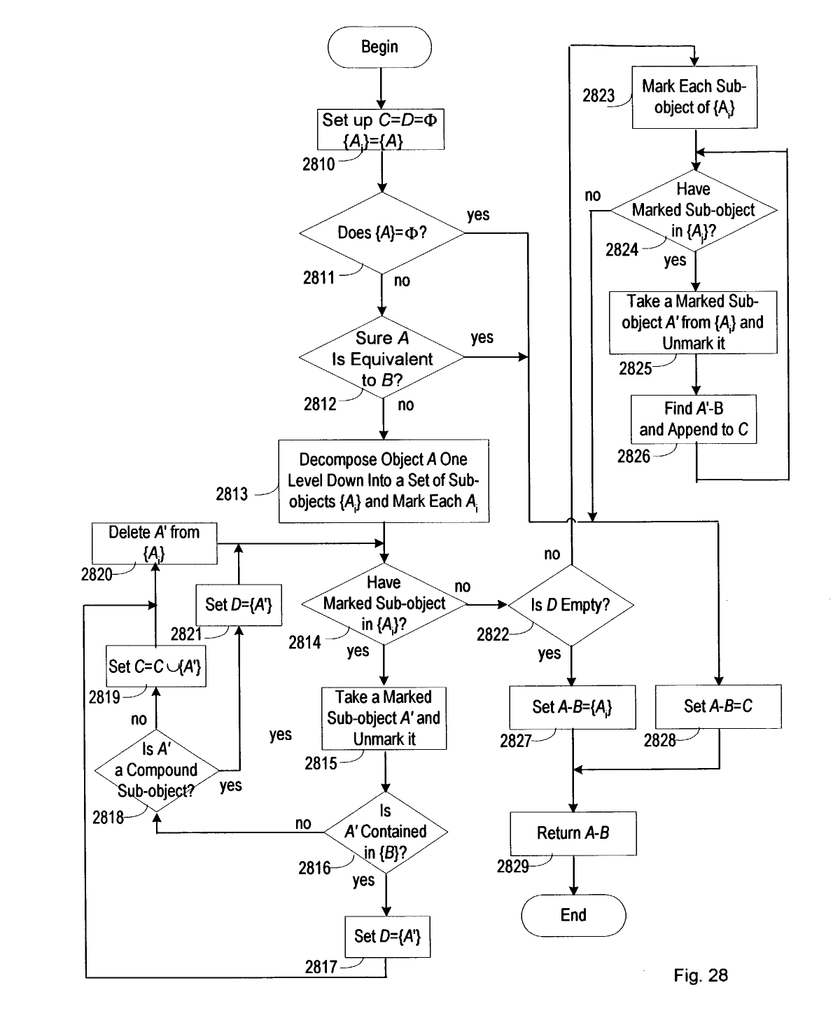

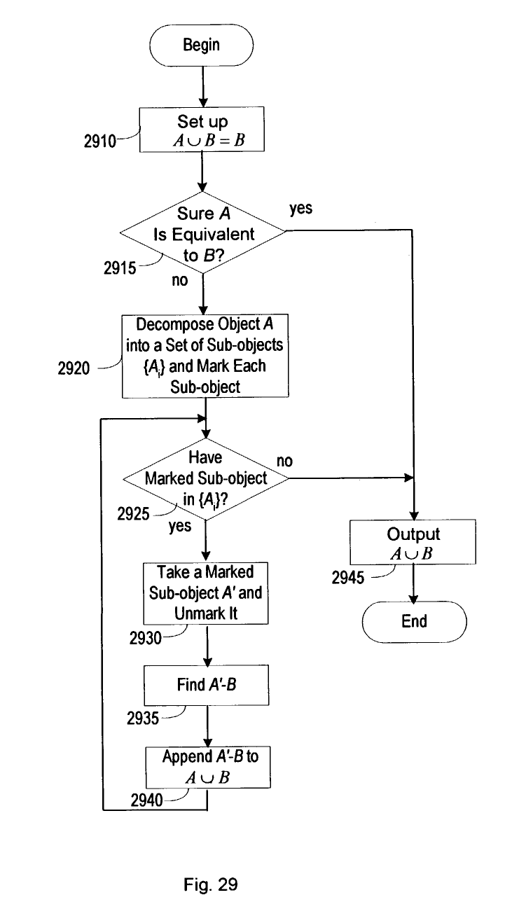

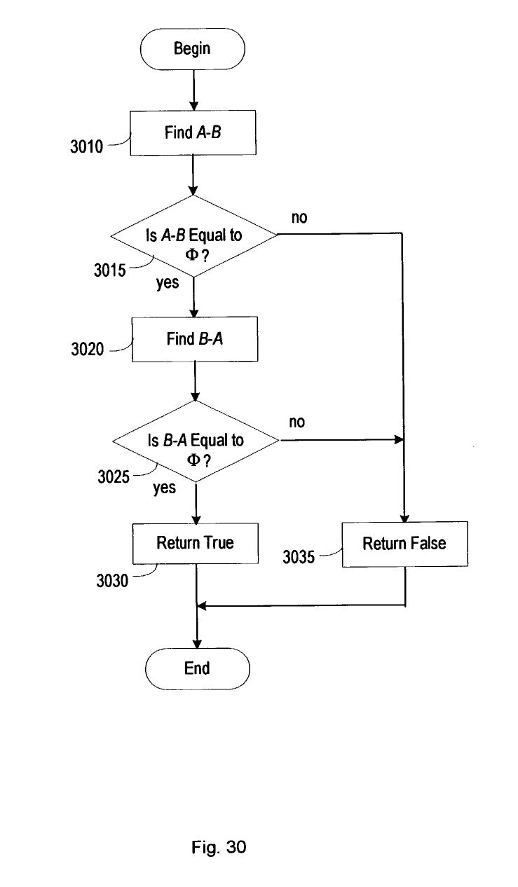

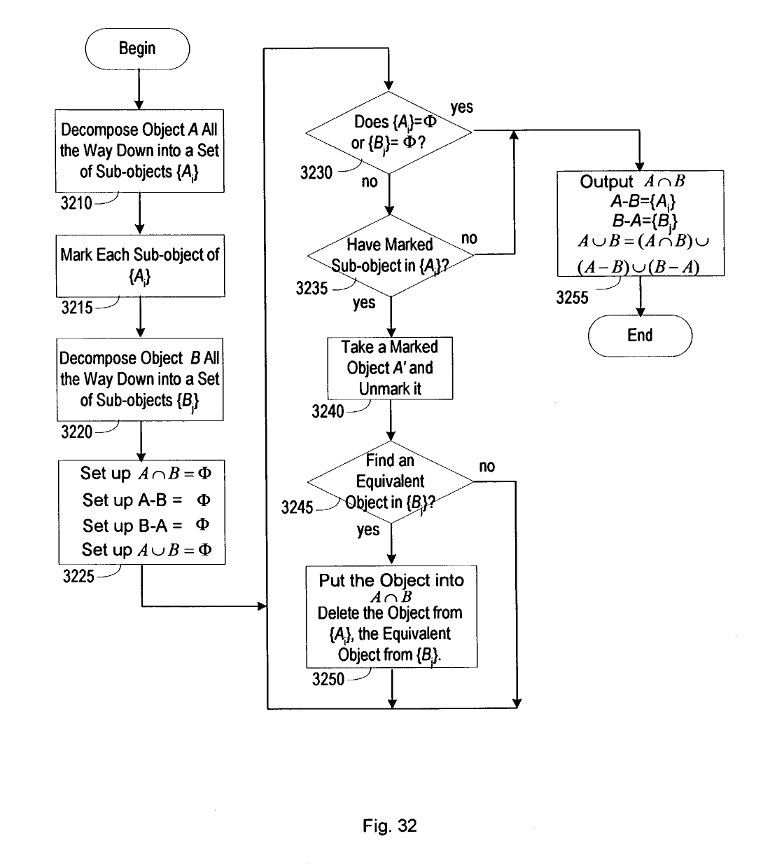

Since people learn by comparison, comparison is very important to study. People have to do many comparisons to understand objects in depth, to generate new problems, to check answers, to reform a statement, to point out a new direction, etc. The comparison task 185 could include any method to help user to find out the relations among a group of objects. After objects have been described internally in set language by a group of sub-objects, set theory will be used to identify the relation among the objects. One of the most important relations could be if an object is derived from another object. Other important relations are if two objects are identical, equivalent, complement, etc. Here two objects are said to be identical if each object consists of the same immediate sub-objects with the only difference being the appearance sequence of the sub-objects. Two objects are said to be equivalent if each object consists of the same very basic sub-objects. When two objects are identical, they are also equivalent. FIG. 26 shows the flowchart of judging if two objects are identical. FIG. 27 is the flowchart of deciding if an object is contained in another object. FIG. 28 depicts the flowchart of finding the relative complement of two objects, which is the portion of an object not contained in another object. FIG. 29 demonstrates the flowchart of obtaining the union of two objects. FIG. 30 is the flowchart of determining if two objects are equivalent. FIG. 31 illustrates the flowchart of finding the intersection of two objects. FIG. 33 shows how to find the intersection, the union, and the relative complements of two objects.

The other tasks 190 include all the tasks for providing auxiliary functions. One of such tasks is to load, to display, to modify, and to save user information. User information includes the one explicitly generated by user and the one generated automatically by the system. The default subject, topic, and display formats are examples of user information generated by user. The grade created by the system is an example of user information generated by the system. User information is critical for the system to generate proper questions, help user in a proper level, and set up proper default settings.

Another of such tasks is to generate time information for some procedures, tasks, and subroutines.

Another of such task is to generate smart question based on user's information and feedback.

Another of such task is to evaluate user progress based on the elapsed time, the searched objects, the grade of self-test, and the score on playing game.

The other tasks 190 could further include any computer routine to cultivate user's capability. For example, it could contain read training program, quick arithmetical calculation training program, and memory training program. By capturing user feedback information, these programs could work better than they are alone in form of audiotape, videotape, or book.

When user wants to exist, user could do so by launching the end procedure 195. This procedure does all the works that need to be done before exit. One work is to prompt user to save information if there is any change.

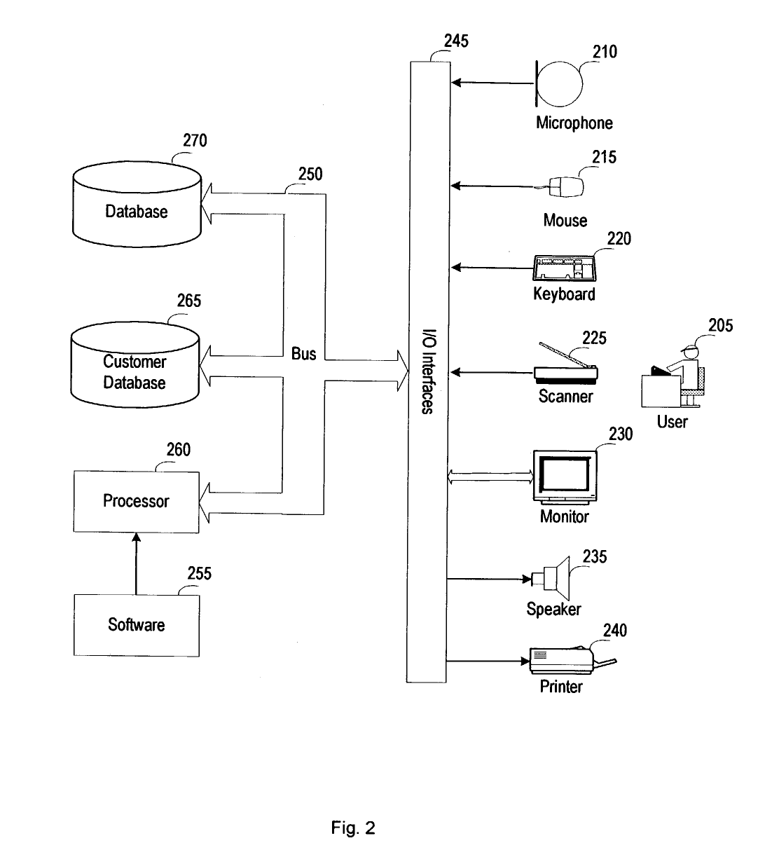

FIG. 2 shows the general structure of the study aid system. The user 205 interacts with the software 255 through various input devices 210 to 225 and output devices 230 to 240. Through the processor 260 and data bus 250, the software 255 controls database 265 and custom database 270. The I/O interface 245 converts the data to be output into proper format for outputting and convert the data to be input into proper format for processing. To emulate the human teaching environment, besides displaying information on monitor 230, the system could be programmed to ask some questions and give some voice explanations through the speaker 235. User can input information to the system through input devices such as microphone 210, mouse 215, keyboard 220, and scanner 225. The monitor 230 could be also an input device if it equips with touch sensors. Through these input devices, the software 255 obtains the feedback from the user 205. The system can output through output devices such as monitor 230, speaker 235, and printer 240. With the feedback from the user 205, the system could be an interactive system.

FIG. 3 shows a dynamic teaching procedure. The procedure has two functions. The first function is to help author to prepare teaching material dynamically and systematically and to help reader to access the teaching material dynamically and systematically.

When the procedure starts, a window interface 310 will appear. Under the control of this window interface, there are many tasks and numerous generated subroutines. A generated subroutine will guide author to describe an object from various aspects and in many different ways and guide reader to examine the object from many different approaches.

The setting up task 315 lets user select options for preparing dynamic teaching material and for accessing the dynamic teaching material. Based on user's selection, general guides and customized subroutines will be generated. Each of the generated subroutines involves a group of predefined actions. A general approach could be text-based approach or graph-based approach.

The setting up task 315 provides interface for author to select options for preparing dynamic teaching material. This task enables author to select options for building generated subroutines to guide author to describe objects from different aspects and in various ways. Broadly speaking, there could be three types of options. The first type of options is related to the general arrangement of a set of objects to be discussed. There could be more than one general arrangement for a same set of objects with each general arrangement for presenting information with a different approach. Since different subject deals with objects differently, the general arrangement for a subject may be significantly different from the general arrangement for a different subject. For instance, a chronological order approach could be a best approach for history but may not be a best approach for mathematics. The options for choosing a subject belong to the first type of options. Displaying in text or by graph is another example of this kind of options. The second type of options is the options to specify default aspects for each type of objects. For example, author may want to discuss the observation, proof, and description of each theorem by default and ignore all other aspects. The third type of options relates to the method for describing each aspect of every type of objects. The paragraph patterns for different aspects of objects are examples of this kind of options. The options for paragraph patterns could include chronological order approach, comparison and contrast approach, cause and effect approach, problem and solution approach, generalization and specifics approach, and classification approach. The setting up task 315 enables author to select options for each common used objects, add new option to a common used object, and create a new type of object.

The setting up task 315 also lets reader select options for specifying how to access the dynamic teaching material. This task enables reader to select options for building generated subroutines to guide reader to examine objects from different aspects and in different levels. Generally, there could be two major types of options. The first type of options regards to the general arrangement of the objects to be examined. This type of options specifies how related objects will be showing on a writing template. The options related to the selection of a subject or a topic belong to this of options. Another example of this type of options is the options regarding to a desired presentation approach. A reader may prefer top-to-down approach and another reader may prefer a down-to-top approach. The second type of options is to specify the default aspects for each type of object to be studied. A theorem could include many aspects such as observation, explanation, applications, proof outline, proof, problem, specialization, generalization, and the statement of the theorem itself Further, an aspect could be shown by many different forms, such as text, table, graph, etc. For whatever reason, reader may just want to know some of these aspects and examine an aspect in a particular form. The second type of options provides reader such choices. Through the setting up task 315, reader can select options to generate a customized reading guide at different study stages. When a reader just reads a mathematical book, the reader may wants to obtain the general ideas about the book, about each chapter, and about each of major theorems. After the reader has obtained the general ideas, the reader may wants to go into further detail such as proofs. Further, reader may prefer different descriptions of the same object at different study stages. The reader may prefer more background introduction, more intuition approach, and more examples at very first time. The same user may prefer more concise and formal approach as well as more links among different objects at later stages.

The setting up task 315 also provides interface for reader to set up help related options. Reflecting reader's requirements on help, these options could include help level, help format, and help scope. The help level will help the system to determine if the reader needs help. The help format will let the system offer help as a hint, a graph, or detail description, etc. The help aspect will tell the system the scope that the system should provide help if the system determines a need.

The general writing guide task 320 will generate a writing template based on author's selection at the setting up task 315. The writing template is in either text form or graphic form, consisting of objects representing the general writing approach with some objects, called hot spots, being linked to related tasks or subroutines. For example, there could be highlighted text labeled as historical event 1 and highlighted text labeled as historical event 2 on the template for history. Author could add more historical events on the writing template or delete some events from the writing template. Each highlighted text is linked to a type-specific subroutine for guiding author to describe each historical event from selected aspects. The task could also provide interface for author to change the writing template. Through the interface, for instance, author can rename historical event 1 to a real historical event name, add or delete some aspects on a particular historical event, and specify a different paragraph pattern for a specific aspect of an object. Now the modified writing template has becomes a writing guide. With the writing guide, author will have an overall picture in mind all the time and be able to describe an object systematically by running a corresponding subroutine. Further, the task could also provide interface for author to brainstorm such as free association and branch egg.

The general reading guide task 325 will generate a reading template according to reader's selection. The reading template is in either text form or graphic form, consisting of objects representing the general reading approach. Some objects on the template are linked to related tasks and generated subroutines. These objects are called hot objects. The task could also provide interface for reader to change the reading template. Through the interface, for instance, reader can delete an object, add or delete some aspects on a particular object, and specify a different display format for a specific aspect of an object. Reader could also specify the sequence of each aspect of every object when displaying the objects in sequence such as on a regular document format. Now the modified reading template has becomes a reading guide. With the reading guide, reader will be able to see objects in a general approach and examine each object systematically. When reader clicks a hot object, a corresponding subroutine will guide reader to go through each selected aspect of the object.

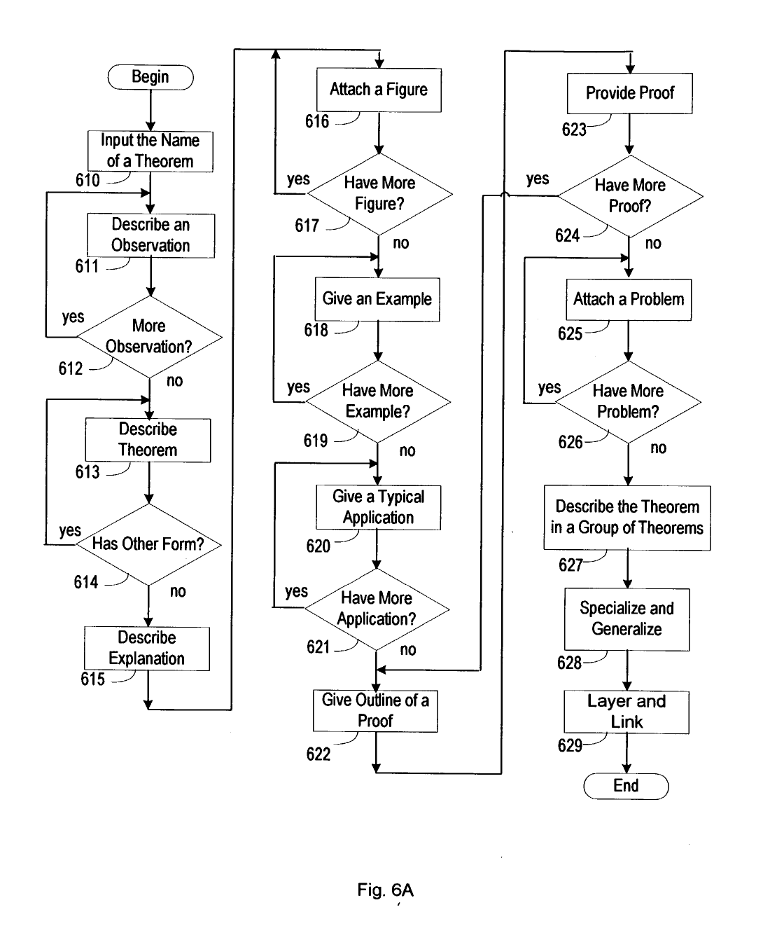

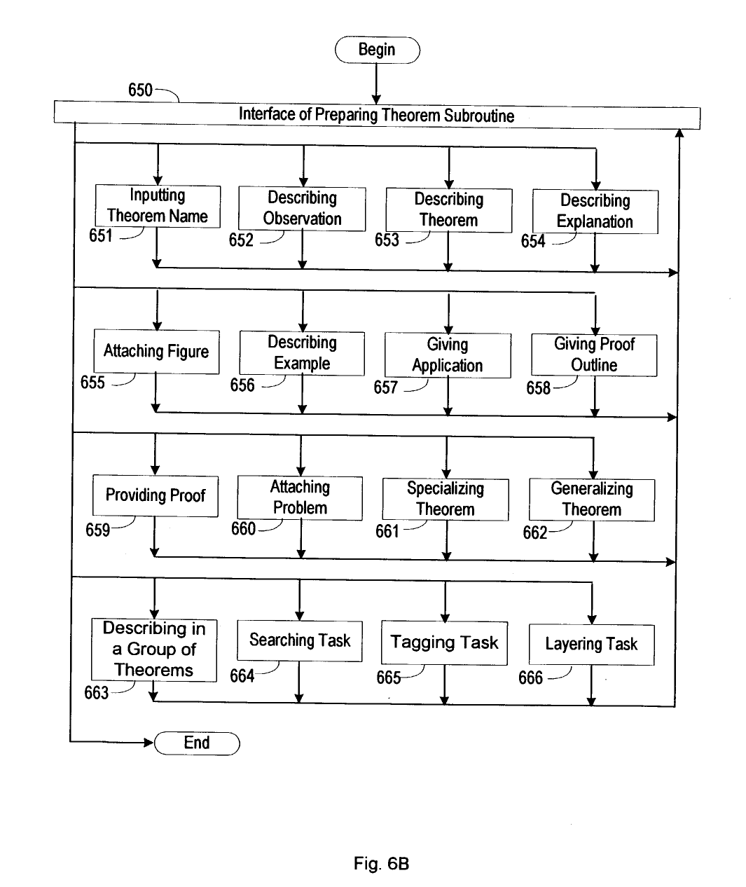

Based on user selection, the generating subroutine task 330 will produce subroutines in a series of commands or in forms of window interfaces. The item in a control box or on a menu or a command corresponding to an unselected option will be grayed, disabled, or deleted. Each generated subroutine consists of preprogrammed actions. These generated subroutines will guide author to describe each aspect of each object and guide reader to access information about each object from different aspects. If author selects a cause-and-effect paragraph pattern for describing an aspect, when a subroutine runs to that aspect, a corresponding paragraph pattern and related phrases will display. For example, when author chooses cause and effect approach for describing an aspect, [cause] and [effect] could appear on a text window and cause-and-effect paragraph patterns could display on a help window. The cause-and-effect patterns could be “if . . . , then . . . ”, “because of”, “since”, “due to”, “therefore”, “consequently”, “for this reason”, “be the cause of”, “as a result”, etc. FIG. 6A gives an example of a generated subroutine for preparing a theorem in a series of steps. FIG. 6B gives an example of a generated subroutine for preparing a theorem in window interface. FIG. 7A gives an example of a generated subroutine for studying a theorem in a series of steps. FIG. 7B gives an example of a generated subroutine for studying a theorem in window interface. The generated subroutines are linked to the hot spots on a writing guide or a reading guide by either the system or user.

The executing subroutine task 335 manages all the generated subroutines. It could display all the generated subroutines in text forms or graphic forms such as buttons. In case a generated subroutine has to start or finish before another generated subroutine can start, the second subroutine will be disabled until the first subroutine has started or finished. User can run a generated subroutine manually by pressing the button or clicking a hotspot. If a subroutine is going to call other subroutines, the subroutine will start these subroutines automatically.

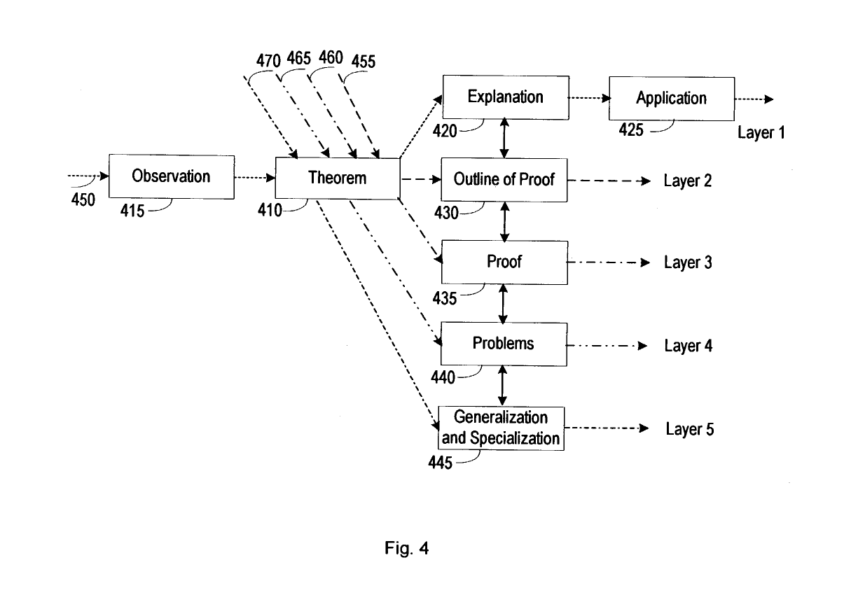

The layering task 340 lets author specify a layer number to an object, layer numbers to different aspects of the object, or sub-layer numbers to different descriptions of each aspect of the object. Author could use different layer number or sub-layer number to reflect author's opinion on the relative difficulty of an object, an aspect, or a description and to suggest reader how the information should be accessed. Reader can view the objects with layer numbers being the same or in a range. A complex and dynamic layering mechanics could be established. A layering example will be given in FIG. 4.

Author may wish to present the same information in different ways for different readers. The converting task 345 enables the author to prepare information in one form and then convert it from this form to other forms. The author can start the description in a paragraph of text, in the form of table, or in figure with some associated explanations. Since people intend to give more explanations in text form and keep the description concise in table form or figure form, usually the description in form of text is redundant while description in table or graphic form is concise. Therefore, when information is converted from a redundant form to a concise form, many words should be deleted and when information is converted from a concise form to redundant form, more words may need to be added. The converting task 345 lets user specify which words are common to two forms and which words are specific to just one form but not another form and edit the information after conversion.

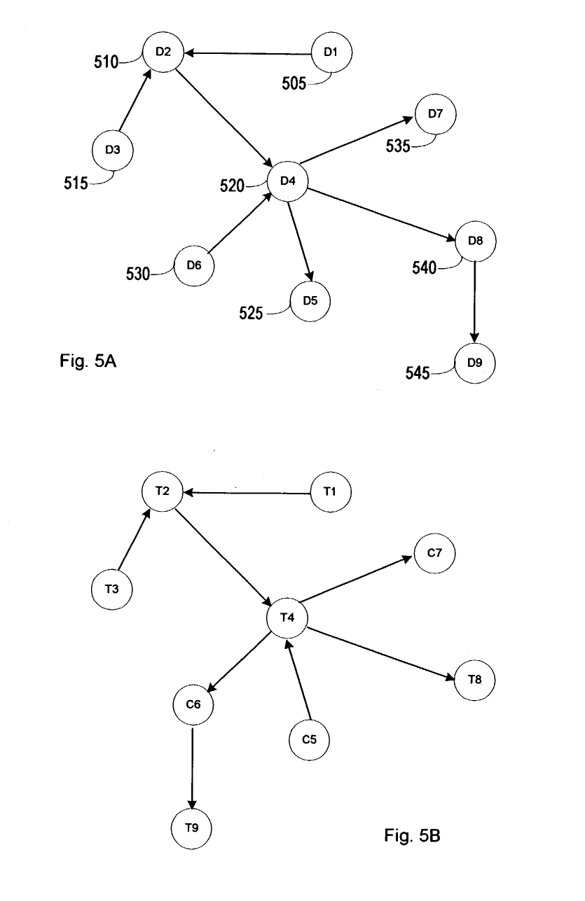

The designing course task 350 lets reader design a customized course. Reader could specify one or more starting objects and one or more desiring objects on a reading template, or through interface. After reader specifies these objects, the designing course task 350 will find the paths from starting objects to desiring objects, ignore unrelated objects, and show the paths on the reading template. When there are several possible paths, the system could choose one randomly, or choose one based on the user's understanding, or let user make a decision. There are two examples, one is shown in FIG. 5A and another is shown in FIG. 5B. The task could also bind a course with time schedule. Based on reader's time schedule, background, expectation, and time estimation for exploring each aspect of an object, the task could include the necessary objects and cover the necessary aspects of each required object in the customized course.

Taking notes plays an important role in study and advanced research. From time to time, people take notes while reading. The notes may be a question mark, or what user understands about an object, or some conjectures occurred in user mind in a split of second, or a simple reminder about what user is going to do next. The taking note task 355 provides interface for user to take notes, link the notes with related objects, and organize notes. The main purpose of the taking note task 355 is to let user be able to access notes easily later and make the notes meaningful even after a long time.

The linking task 360 is same as the one 180 in FIG. 1. It is explicitly displayed here since it is one of the most frequently used tasks.

A good teacher has to evaluate the progress of a student in order to adjust the teaching strategy toward the student. Similarly, the evaluating progress task 365 is to capture feedback from reader, evaluate reader progress, and modify various settings. By collecting information from reader and capturing reader feedback, the system can estimate how well that the reader understands an object, identify if the reader needs more help, and adjust the help level setting. It collects information from reader directly or indirectly when reader takes a review, solves a problem, takes a test, or plays a game. The collected information could be also used to generate statistics information about a group of users. The task could collect many types of information. One type of information is the right or wrong information. This type of information is obtained when reader takes a self-test or plays game. Another type of information is the time reader takes to accomplish a task. On detecting that a reader perhaps needs more help, the system will give the reader more explanations, more examples, and more straightforward problems. On detecting that a reader perhaps understands very well, the system will assign the reader more challenge problems, guide the reader to explore more aspects of an object, and encourage the reader for further study.

The other tasks 370 provide all other tasks needed to complete the dynamic teaching material procedure. These tasks could include feedback task, reforming task, comparing task, searching task, and tagging task. The searching task is to find all the objects related to a key word, a structure, a tag, or a methodology. The tagging task is to associate a property related to an object a label. For example, a theorem could have tags of observation, application, proofs, and problems.

FIG. 4 shows an example of the description of an object by layer. To understand an object, reader needs to examine every aspect of the object one by one. A layer approach enables reader to access each aspect of the object in such a sequence that could be most suitable to the reader. In this example, the object is a theorem. The related objects of the theorem 410 could include observation 415, explanation 420, possible application 425, outline of proof 430, proof 435, associated problems 440, more generalization case or more specialization case 445. If a reader is not familiar with the theorem, too much information pouring into the reader too quickly perhaps will make the reader suffocated. Instead of pouring into reader, information will be presented to reader layer by layer.

When reader just hears about a theorem 410, perhaps it is better for the reader to know the background about the theorem, understand what the theorem means, and aware what applications the theorem may have. The very first layer 450 could include the observation 415, the theorem 410 itself, the explanation 420, and the application 425. This layer not only makes reader be familiar with the theorem, but also makes reader have more confidence on the theorem, which in turn will help reader to understand the theorem better psychologically.

After understanding general idea, many readers feel easier to proceed to detail that is complex. With proper preparation from first layer, reader may want to proceed to see the general idea of a proof The second layer 455 may include the theorem 410, and the outline of proof 430. After reader has known clearly what the theorem is talking about, felt confident on the theorem, obtained the general idea of proof, the reader is ready to proceed to the third layer 465. On the third layer, reader will be shown that how actually the theorem is proved. This layer may include the theorem 410, and the proof 435.

To have more feelings, reader may want to do some exercise. The fourth layer 470 may include the theorem 410 and associated problems 440.

The next layer 470 may include the theorem 410 and its generalization and specialization 445. The generalization and specialization of a theorem will help reader to understand the theorem better.

FIG. 5A shows a group of concepts and their relations displayed by the system. The arrow line could stand for any relation. Here suppose the arrow line stands for such a relation that the concept at the ending point of an arrow line uses the concept at the starting point of the arrow line directly in its definition. For example, the concept D4 520 uses the concepts of D2 510 and D6 530 directly in its definition while the concept D4 520 itself is directly used in the definitions of concepts D5 525, D7 535, and D8 540. If user knows concept D2 510 already and wants to understand concept D5 525, the user can select concept D2 510 as a starting point and D5 525 as an ending point. Then the designing course task 350 in FIG. 3 will find that the user has to learn the concepts D6 530, D4 520, and D5 535.

FIG. 5B is similar to FIG. 5A. The only difference is that FIG. 5B is built based on a group of theorems and their corollaries. Again user can select one or more starting points and one or more ending points, the designing course task 350 in FIG. 3 will find the path for the user.

It is also possible to have concepts, theorems, and corollaries all in same map or text form. When user selects starting points and ending points, the designing course task 350 in FIG. 3 will find proper path for user.

FIG. 6A is the flowchart of an example of a generated subroutine. This subroutine helps author to prepare a theorem. It shows the steps corresponding to the selected options. Each step involves a preprogrammed action. With different selection of options, more or less steps are possible. Each step could generate a corresponding tag and take corresponding information from author. If there are more than one tag under a same category, the system will further itemize the tags. For example, if there are more than one proof, instead of tagging all proofs with a same proof tag, author could tag different proofs with proof one, proof two, etc. Alternatively, author could put different proofs under different sub-tags of the proof tag. The system uses these tags or sub-tags to access related aspect of the theorem.

At step 610, the subroutine provides a proper interface and prompts author to input the name of a theorem or an identification of the theorem in case the theorem has no name. The system will generate a title tag for the theorem at step 610.

At step 611, the subroutine provides a proper interface and prompts author to give an observation about the theorem. The observation could be background about the theorem, some fact about theorem, some experience about the theorem, and the limitation of the theorem. The observation could help reader to feel more confident on a particular theorem and understand its limitation. Repeat step 611 and step 612 until at step 612, there is no more observation needed to add. Step 611 produces an observation tag.

At step 613, the subroutine provides a proper interface and prompts author to describe the theorem. Repeat step 613 and step 614 until at step 614 no different description needs to be added. A theorem might have several equivalent text forms and one or more mathematical forms. These different forms will serve the needs of different readers or a same reader at different stages. Step 613 generates a theorem tag.

At step 615, the subroutine provides a proper interface and asks author to give detail explanation of the theorem. A theorem could be very concise and look confused to a beginner. Some explanation may help reader to understand the theorem better. This step will generate an explanation tag.

At step 616, the subroutine provides a proper interface and asks author to attach a figure to the theorem. Since usually figure can convey more information than text alone, reader may find it is easier to understand the theorem with proper figure attached. Step 617 asks author if another figure needs to be attached. If there is one, repeat step 616 and step 617. Otherwise, go to step 618. Step 616 generates a figure tag.

At step 618, the subroutine provides a proper interface and asks author to give an example. Example may help reader to see how to use the theorem and understand the theorem better. Repeat step 618 and step 619 until there is no another example needed to give. Step 618 generates an example tag.

At step 620, the subroutine provides a proper interface and reminds author to give a typical application about the theorem. Usually a theorem has some typical applications. If a reader understands the typical applications of the theorem, the reader could understand the theorem better and be able to apply the theorem in similar situations. Step 621 asks author if there is another typical application. If yes, repeat step 620 and step 621. Otherwise, go to step 622. Step 620 generates an application tag.

At step 622, the subroutine provides a proper interface and asks author to describe the general approach of a proof Author could include the proof methodology into a proof outline. User could assign a methodology tag to the proof methodology. At step 623, the subroutine provides a proper interface and asks author to give the proof in detail. Step 624 asks author if there is any more proof If yes, repeat step 622 to step 624. Otherwise, go to step 625. Step 622 generates a proof outline tag and step 623 generates a proof tag.

Repeat step 625 and step 626 until at step 626 no another problem needs to be added. At step 625, the subroutine provides a proper interface and prompts author to attach a problem to the theorem. Step 625 produces a problem tag. Problems could be the origin of a concept or a theorem. Some problem could serve as the observation of the theorem.

At step 627, the subroutine prompts author to describe the relations between the theorem and its related theorems in text forms, mathematical formulas, or figures. A theorem built on a particular structure could have similar theorems built on different structures. One example is similarity among the factor theorem for subjection, the factor theorem for epimorphism, and the factor theorem for group epimorphism. Further, a theorem could have connections with other theorems through proof, description, methodology, etc. An example is the first isomorphism theorem, the second isomorphism theorem, and the third isomorphism theorem in group theory. In addition, some theorem could have one or more lemmas, and one or more corollaries.

At step 628, the subroutine asks author to make the theorem more special ore more general and produces one or more specialization and generalization tags.

At step 629, the subroutine prompts author to put a layer number to different forms of the theorem, different figures, different examples, different applications, and different problems. The subroutine also provides interfaces for author to establish various links between the theorem and related theorems in database. The links could be based on the same keyword, similar structure, or similar proof approach.

FIG. 6B is an example of a generated subroutine in window interface for helping author to prepare theorem. It is similar to FIG. 6A. The window interface 650 for preparing theorem will appear. Since writing process usually involves several iterations, window interface may be more convenient. With window interface, author can launch any of these tasks one or more times. Instead of providing all the proof to a theorem at once, the author could provide different proofs at different stages.

The inputting theorem name task 651 lets author specify the name of a theorem or the identification of the theorem. Calling this task will generate a title tag.

The describing observation task 652 provides proper interface and asks author to give an observation to the theorem. A theorem could be based on some observations. The observation will make reader to understand the background of the theorem and feel more natural about the theorem. Calling this task will generate an observation tag.

The describing theorem task 653 provides proper interface and asks user to state the theorem. A theorem could have several different forms. Different forms may be particular useful to different applications, different users, or different stages of a user. Calling task will produce a theorem tag.

The describing explanation task 654 reminds author to give an explanation to the theorem. Explanation may help reader to understand the theorem better especially when the theorem is very concise. Calling this task will produce an explanation tag.

The attaching figure task 655 asks author to attach a figure to the theorem. Figure could let a reader see more clearly on the relation among each part of the theorem and therefore help reader to understand the theorem better. Calling this task will generate a figure tag.

The describing example task 656 provides proper interface and lets author attach an example to the theorem. By going through example, a reader could understand the theorem better. Calling this task will produce an example tag.

The giving application task 657 prompts author to give an application related to the theorem. A reader could understand the theorem better and know how to apply the theorem in similar situations after the reader has examined the typical applications associated with the theorem. Calling this task will generate an application tag.

The giving proof outline task 658 lets author describe the general approach of a proof. A reader may just want to have some idea about how a proof is about before the reader goes into the detail of the proof. Calling this task will provide a proof outline tag.

The providing proof task 659 tells author to give a proof of the theorem in detail. Calling this task will generate proof tag.

The attaching problem task 660 reminds author to associate a problem to the theorem. Calling this task will produce a problem tag.

The specializing theorem task 661 lets author give a special case of the theorem. Calling this task will generate a specialization tag.

The generalizing theorem task 662 asks author to give a more general case of the theorem. Calling this task will generate a generalization tag.

The describing in a group of theorems task 663 prompts author to describe the relation between the theorem and other theorems. Calling this task will produce a group relation tag.

The searching task 664 allows author to search and display related information on the teaching material under constructed.

The tagging task 665 lets author put tags, edit tags, and modify tags.

The layering task 666 lets author assign layer numbers to the objects created by the tasks 651 to 663.

FIG. 7A is the flowchart of an example of a generated subroutine. This generated subroutine helps a reader to examine a theorem from different aspects. It shows the steps corresponding to the selected options. Each step involves a preprogrammed action. How information is presented in each step depends on selection of the options in the setting up task 315 of FIG. 3. With different selection of options, more or less steps are possible. The reader can press enter key or select next button to proceed to next step.

At step 710, the system presents observations to reader in either text form or graphic form with or without voice.

At step 711, the system presents the theorem to the reader.

At step 712, the system presents related information to the reader. The information could include related concepts, theorems, and the relations between the theorem and other theorems.

At step 713, the system shows related figures to reader.

At step 714, the system gives explanation about the theorem to reader. The explanation could be given in text, table, figure, and voice.

At step 715, the system shows applications to reader.

At step 716, the system describes the general idea of a proof to reader.

At step 717, the system presents the proof to reader in detail.

At step 718, the system assigns reader some related problems.

At step 719, the system present reader more general case or more special case.

At step 720, the system compares the theorem with other theorems.

FIG. 7B is an example of a generated subroutine in window interface for helping reader to examine theorem. It is similar to FIG. 7A. The window interface 750 for examining theorem will appear. Through the interface, reader can launch each task under it. Each task could have accompanied text, figures or voice and could be executed one or more times. Depending on setting, when there are several objects under a same tag, a task could display all the objects or some of these objects. A task could also display a different object each time when it starts.

The displaying observation task 751 presents the observation of a theorem to reader in text, figure, or table. There could be accompanied voice also.

The displaying theorem task 752 presents the theorem to the reader. Depending on setting, when there are several different forms of the theorem, some or all of these different forms of theorems will be presented. The displaying theorem task 752 could also display different form of the theorem when it starts at different time.

The displaying related figure task 753 shows reader one or more related figures. These figures are used to help reader to understand the theorem better and see the connection between the theorem and other theorems. Depending on setting, the task could show figure one by one, show some of them, or show all at once.

The displaying explanation task 754 gives reader explanation about the theorem. There could be accompanied voice also.

The displaying application task 755 shows reader possible applications of the theorem. When there are several applications, the task could show all the applications or some of them.

The displaying proof outline task 756 shows reader the general idea of a proof The displaying proof task 757 shows reader the proof in detail. The keyword in the proof may be highlighted so reader can jump to a related concept when needed. When there are several different proofs, depending on setting, some of them will be displayed.

The assigning problem task 758 assigns a problem to a reader. Which problem will be assigned to reader could depend on the layer number of the problem, which layer the reader chooses, the background of the reader, and the reader's time schedule. Usually the reader may wish to solve some simple problems when the reader just contacts the theorem. As the reader knows the theorem better and better, the reader may want to work on problems that are more challenge.

The showing the specialization of the theorem task 759 shows a reader the special cases of the theorem if there is one.

The showing the generalizations of the theorem task 760 shows reader the generalizations of the theorem if there is one. The showing the relation between the theorem and other theorems task 761 illustrates the theorem in a group of theorems. A reader could understand the theorem better by examining the theorem in a group of theorems.

The searching task 762 lets reader search and display related information from the teaching materials and database. The tagging task 763 lets reader put a tag on an interesting place of the theorem. A tag could serve as a bookmark. Reader could put question mark on a statement of the theorem and come back to study the statement later.

The linking task 764 lets reader link the theorem to other theorems. The connection between two theorems could be based on the similarity of structure, methodology, keyword, etc.

The taking note task 765 lets reader take notes. Reader may have some comments on the theorem. Reader may have some idea about a different proof. The task lets reader write down whatever in reader's mind and associate the notes with the theorem. Later when reader reviews the theorem, reader will be also able to check the notes the reader took. The getting feedback from reader task 766 obtains feedback from the reader. The feedback could include the time escaped and the inquiry about some object.

FIG. 8 shows a dynamic learning procedure. For all the books on paper, the information is not prepared for dynamic use. Even for the information on an electrical book, if the information is not prepared for dynamic use, the procedure described in FIG. 3 can not be applied. Since most of information is presented non-dynamically, it is necessary to find out a way to understand and remember information better.

To really understand something, usually reader has to go through three stages called “from thinness to thickness, from thickness to thinness, and from thinness to thickness”. The first stage “from thinness to thickness” means that reader knows nothing or little about a specific topic at beginning and understands the topic more and more with time advance. At this stage, reader often feels confused by a lot of information pouring into brain. To have a clear view of the information, a reader has to go through the second stage called “from thickness to thinness”, which means to condense the huge content and master its essential. At this stage, reader will see more clearly the relation among different parts of the information by solving problem, distinguishing similar concepts, and recapitulating the main ideas. A more aggressive reader may want to go through the third stage called “from thinness to thickness”. The third stage enables reader to make a statement more special or more general, to apply methodology to different problems, to find more connections among different objects, to give different proof, to see a theorem differently, etc. This stage is the stage of possible discovery or invention. The dynamic learning procedure 125 guides reader to read a book and helps reader to go through the three stages relatively easier and systematically. First, the procedure guides user to survey to become familiar with a resource and produce a reading guide. On the reading guide, a hot object is linked to a corresponding generated subroutine. By following a subroutine, reader is guided to search for related information from the resource, examine an object from every aspect systematically, and input the information taken from the resource into user own database system. Then, the procedure lets reader search for and display related information from database, take notes, make comparisons, build various connections, and put on tags. Further, this procedure could evaluate user's progress, collect information from user, and generate challenge questions.

The window interface 810 for dynamic learning procedure will appear. The interface could be in the form of menu or any other convenient form. Through the interface, a user can launch any of tasks and generated sub-routines.

The setting up task 815 does all the setting up works. The setting up works could include selecting a subject, a sub subject, topic, and help options, choosing the statements and questions used in survey, and specifying the default aspects of each type of objects under consideration.

The overall guide task 820 has several functions.

The first function of the overall guide task 820 is to guide reader to survey. Survey does help people to become more familiar with a resource such as a paper or book. Survey helps user to understand the structure of the resource, to be alert to particular information, to take the best approach to read resource, and to raise questions. The overall guide task 820 generates a sequence of advice at proper time to guide reader to acquire enough information so that the reader could deep read particular section, chapter or paragraph. Depending on user's setting, user's feedback, and the specialty of a particular subject, more or less questions could be generated. The advice could include the statements and questions similar to the following:

“Check title please.”

“Check subtitles please.”

“Check the publication date.”

“Check table of contents.”

“Read preface.”

“What is the general structure used by author?”

“What does the main theorem talk about?”

“Find out the summary of each chapter.”

“Read the first couple of paragraphs and last couple of paragraphs of each chapter.”

“Check index please.”

“Look for lists, tables, and figures.”

“Review survey information.”

“Do you want to read the book?”

“What do you expect to get from reading the book?”

“Raise purpose questions and try to speculate the answers.”

The overall guide task 820 could also provide interface for user to write down important words and draw important objects on a new window. This window will serve as a guide for user to study.

The overall guide task 820 could also provide interface for user to link some objects on the new windows with related subroutines. With the establishment of the linking, user can click an object and launch a corresponding subroutine.

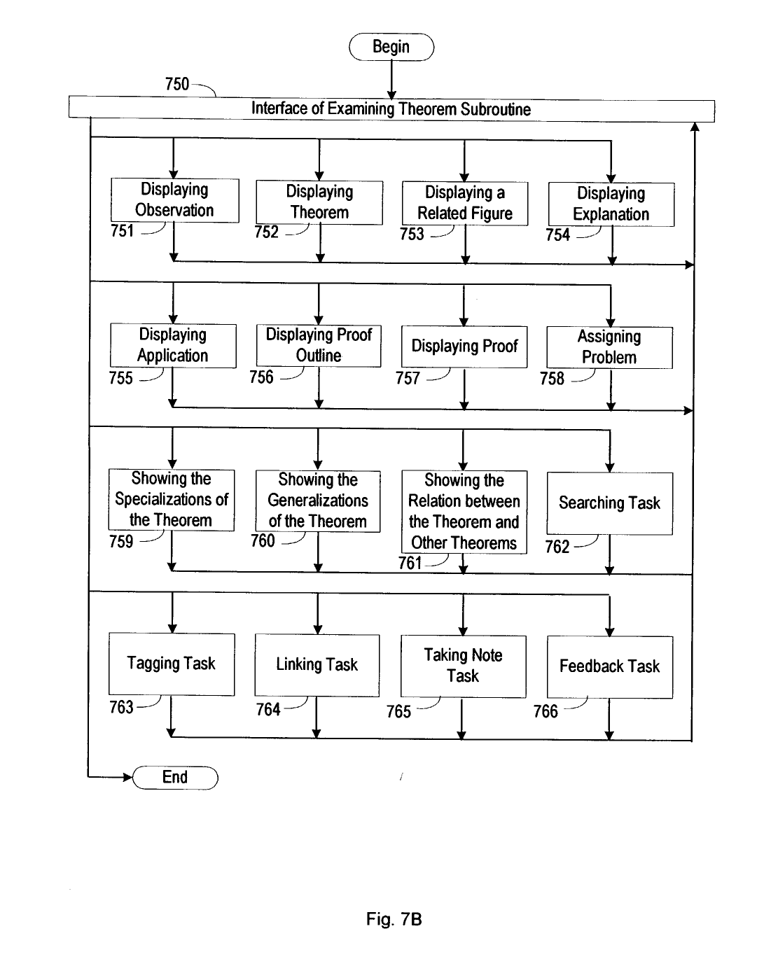

The generating subroutine task 825 is to generate a group of subroutines. By running the setting up task 815, user can select options for each type of objects with each option associated with a preprogrammed action. A generated subroutine could be started directly by user, by procedure, by a task, or by another generated subroutine. A generated subroutine also could provide interface for reader to input information into database. An example of generated subroutine to study a theorem is given in FIG. 9.

The executing subroutine task 830 manages all the generated subroutines. It could display all the generated subroutines in text form or graphic form such as button. User can run a generated subroutine manually by pressing the button or clicking a hotspot. If a subroutine is going to call other subroutines, the subroutine will start these subroutines automatically.

The searching database task 835 is same as the searching database task 150 in FIG. 1. Since this task is one of the most common used tasks, it is displayed in FIG. 8 for emphasize. The detail will be given in FIG. 16.

The displaying object task 840 has been described as 160 in FIG. 1. It is included in FIG. 8 because it is one of the very frequently called tasks. The detail will be given in FIG. 22.

The exploring object task 845 lets user explore an existed object in database from every aspect. This task could call the displaying object task 840. This task lets user be able to see an object in a big picture and to zoom in to examine the object in detail. Sometimes user wants not only to check an object in a group of related objects, but also to focus on one object, to examine each aspect of the object, and to look at the different descriptions. This task enables user to view an object in text form, in table form, or in figure, check its affiliated objects such as background, explanation, basic idea, user notes, related lemmas, corollaries, similar theorems, etc. One example is shown in FIG. 4 by the vertical arrows.

The comparing task 850 is same as the comparison task 185 in FIG. 1. This task tries to find the relation between two objects by set theory when both objects are described by set language.

The taking note task 855 is same as the taking note task 355 in FIG. 3. This task is a very commonly called task.

The tagging task 860 is same as the tagging task 763 in FIG. 7B. It is a frequently called task. This task also helps user to bring two related objects together. For example, if user feels a particular theorem is closed related to another theorem, user can attach a same tag to both theorems. When user views one theorem, user will notice the tag and therefore user can view another. In this way, user could have a better understanding of the knowledge and know where to find the related information.

The linking task 865 is same as the on 180 in FIG. 1. It is a very commonly used task. This task lets user link an object to other objects. Through this task, user can organize all the scattered knowledge into an integration body. For example, user can link many laws in hydrostatics and hydrodynamics to three Newton's laws. User can further link Newton's second law to the special theory of relativity and treat Newton's second law as an approximation of the special theory of relativity in low speed. The linking task 855 also helps user to organize information. User can sort the applications into typical applications and associate each application with proper example. With connections built among different objects, user has a whole picture about these scattered objects, understands each object better, and is able to find related information quickly. Further, user can link an object to a piece of program or proper tool.

The evaluating user progress task 870 is same as the one 365 in FIG. 3. It is a commonly used task.

Other procedures and tasks 875 may includes to the review procedure 130, the solving problem procedure 135, the taking test procedure 140, the playing game procedure 145, the updating database task 165, and reforming task 170 in FIG. 1.

FIG. 9 is an example of the generated subroutine to study theorem. The subroutine guides user to locate a theorem and related objects of the theorem from book or paper, to search related information from database, to take notes, and to make links. While guiding reader to search for related information, the subroutine captures information input from the reader, saves the information into computer, and generates corresponding tags. With all the information available in computer, user can display two or more theorems separated by a several chapters on a book together. Further, a theorem can be displayed differently by replacing some of the concepts in the description of the theorem by their equivalent concepts.

The generated subroutine to study theorem has a window interface 910. Under the control of the window interface 910, there are some tasks. User can start a task. A task could start other tasks also.

The finding out background task 911 prompts user to find out the background information about a theorem and input the background information into database.

The finding out theorem task 912 asks user to locate the theorem from book or paper and input the theorem into database. The task could call the reforming task 170 to make the description of the theorem more formalized.

The finding out explanation task 913 asks user to locate explanation of the theorem on the book or paper and input it into database. After a user has understood what the theorem means, the user can also give explanation on the theorem in user's own words. This task will generate an explanation tag.

The recalling related theorem task 914 asks user to recall related theorems when user have difficulty to understand the theorem. A related theorem could be a theorem, which has the similar structure, has some same keywords in its description, or addresses a similar or same problem as the original theorem. With a clear understanding the related theorems, it may help user to understand the theorem better and easier. In case user has difficulty to recall, user can search database for the related theorems by keywords, structure, methodology, and other links.

The searching database task 915 is same as the one in FIG. 1. Its detail will be given in FIG. 16. It is to let user search related information from database. The related information could be in form of concepts, theorems, structures, proof methods, connections, etc. They could be in text format, table format or graphic format.

The displaying object task 916 is same to the one in FIG. 1. It is one of the most common called tasks.

The thinking about proof outline task 917 asks user to try to figure about the general idea behind the proof It is a mental exercise for user to compare user's approach against the author's, and in many situations, the standard one. The main purpose is to force user to think.

The going through proof task 918 asks user to go through the proof actually. User can input the proof into database to keep a record. Also user can take notes and associate the notes with the proof The feeling about proof task 919 prompts user to calm down to think. It could ask user if the proof make sense, why it works, if there is a simple way to do it, if the proof is similar to a previous one, etc. The main purpose is to force user to have a clear understand about the proof The attaching figure task 920 provides interface, asks user to draw a figure, and associates the figure to the theorem. The figure could be a copy of a figure from a book or drawn by user. Drawing a figure usually helps user to understand better.

The generated subroutine also reminds user to look at a theorem from different point of views such as specialization, generalization, and modifying keywords.

The specializing theorem task 921 asks user to think about special cases of the theorem. The purpose is to force user think and therefore to make user understand better.

The generalizing theorem task 922 asks user to try to make the theorems more generalized. Even through user can not generalize it, the task makes user think and therefore help user to understand the theorem better.

The modify keyword task 923 asks user to modify some keywords in the theorem to see how the theorem should change. User can replace a keyword by a similar one, and see if the theorem still make sense, or in order to make it make sense, how the theorem should change. Further, user can change some definitive word such as from “all” to “any” and from “one” to “at least one”. The task makes user to think hard and therefore user could understand the theorem better.

The raising question task 924 encourages user to raise more questions. This task usually takes place when user has understood the theorem well. A good question may lead to a good direction. The task provides interface for user to input these questions into database and associate the questions to the theorem. It could encourage user to answer these questions and provide interface for user to link the answers to the questions.

The comparing task 925 is same as the one in FIG. 1.

The taking note task 926 is same as the on in FIG. 8. It is displayed explicitly here to emphasize that taking notes plays important role. User can view all the notes associated with the theorem later. Further, user can itemize the notes by assigning proper tag to each of them. Later user can view all the notes associated with many different theorems and with a particular tag such as a question mark.

The tagging task 927 is same as the one in FIG. 8. It is one of the most common called tasks.

The linking task 928 is to let user link the theorem and its affiliated objects to related objects in database. It is same as the one in FIG. 1.

The generating smart question task 929 is to generate smart question and advice to encourage user to explore various objects from different point of views based on user feedback. A smart question and advice could be generated based on the similar structure, type of theorem, training, etc. Questions and advice will be raised when user can not understand a particular theorem or can not solve a problem. The task will give advice and ask a series related questions around the theorem and its related problems to guide user from unknown to known, or from known to unknown, or from both sides. How smartly the task could generate questions depends on many aspects. One of the most important aspects is the classification of the problem. A good classification about the type of problem may give more practical and concrete guidance. For example, if a problem is just considered as a general mathematics problem, the task could not offer more help than some general advice. But if the problem is first classified into a geometric problem, further into a construction problem, and finally into a intersection problem of two loci, then the task could give some specific advice. One example of specific advice is “reduce the problem to the construction of one point.” Another is “split the condition into two parts so that each part yields a locus for the unknown point; each locus must be either a straight line or a circle.” The specific advice could be one saved in the database, which has been successfully used to solve a similar problem before. Further, with applying other intelligent technologies such as pattern recognition, smart questions could be also generated on spot.

FIG. 10 shows a review procedure. Either system automatically sets up a review goal or user sets up a review goal. This goal may include how many hours the user wish to spend on a subject, or on each topic under a subject, how well the user wants to understand the objects. If a user wants to do some search in this field, the user may want to investigate every possible aspect and make user database more complete. The user may want to make more links and take more notes. If a user just wants to understand the object, the user may choose very different way. An object could have many aspects. Depending on time schedule, the user may just want to review some important aspects of the object. User could review objects in the same sequence as they appear on a book or review objects in a sequence determined by user or determined randomly by the system.

Through the window interface 1010, user can launch any of the related tasks under the review interface.

The setting up task 1015 enables user to set up how user wants to review going on. The task could provide interface for user to specify the review scope, objects, aspects of each type of objects under consideration, and total hours. There could be many kinds of reviews such as reviewing a related theorem, a solved problem, and a related typical application. With each different type of objects, there are many aspects. Based on needs, user can enable some of the aspects and disable the rest aspects.

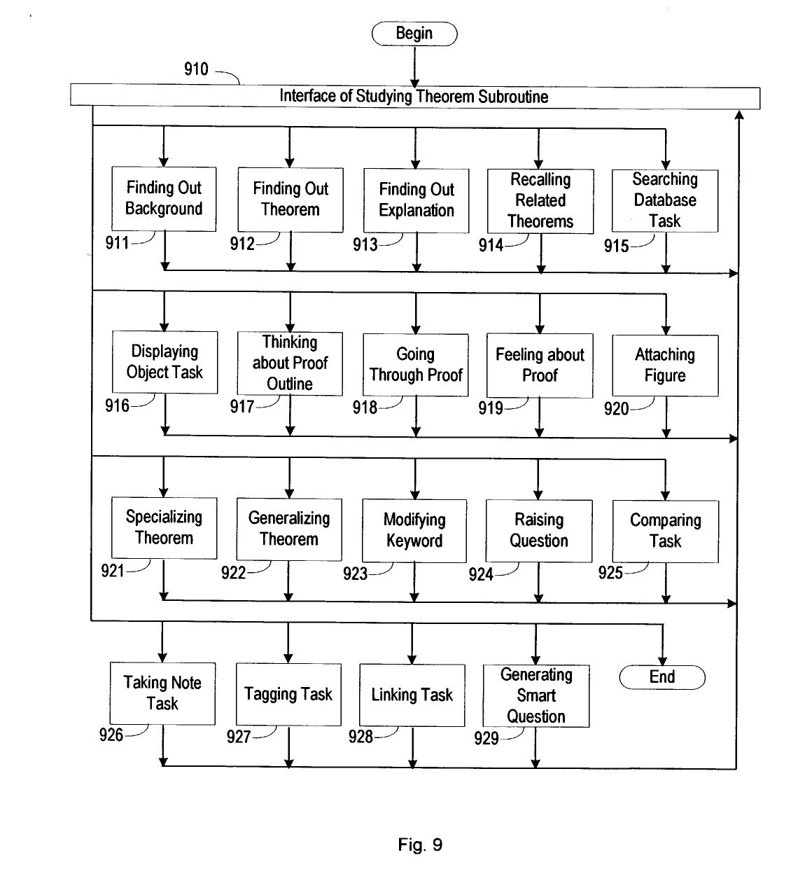

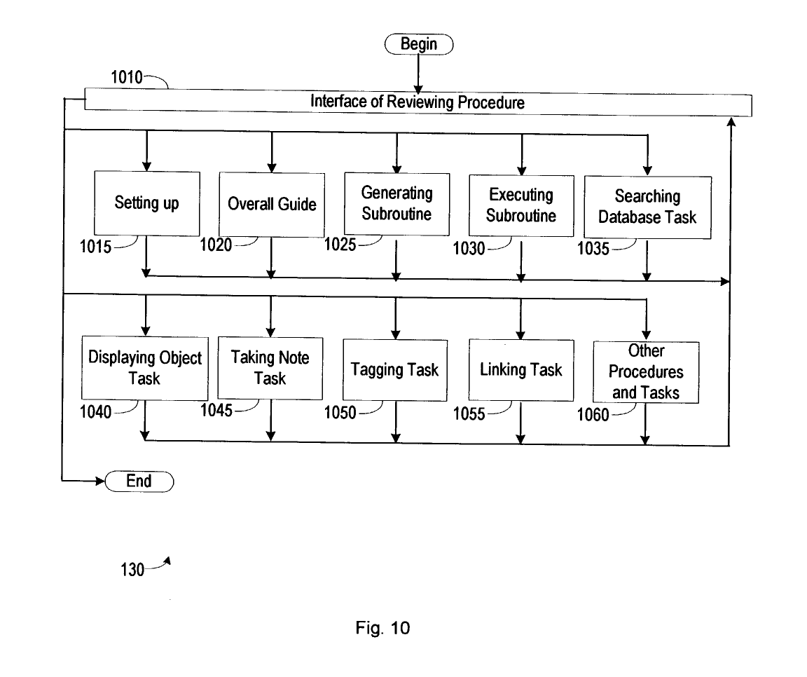

Based on the selections with setting up task 1015, the overall guide task 1020 generates a review guide by displaying related objects in a window. The task provides user interface to modify the review guide. Some of the displayed objects are linked to corresponding generated subroutines. In another window, the task could display all the generated subroutines in text form or graphic form such as button. User can start a generated subroutine from either window by pressing the button or clicking a hotspot. If a subroutine is going to call other subroutines, the subroutine will start these subroutines automatically. An example for reviewing a theorem and an example for reviewing a problem are given in FIG. 11 and FIG. 12 respectively.

The generating subroutine task 1025 is to generate subroutine to handle a specific object. Based on user's selection with setting up task 1015, the generating subroutine task 1025 generates subroutines to handle different types of objects. Each generated subroutine consists of a series of preprogrammed actions.

The execute procedure 1030 manages all the generated subroutines. User can start a subroutine and a subroutine can start other subroutines. The task could display all the generated subroutines and let user start a subroutine.

The searching database task 1035 is same as the one in FIG. 1. It is one of the most common used tasks.

The displaying object task 1040 is same as the one in FIG. 1. The detail will be shown in FIG. 22. It is one of the most common used tasks. It will display an object in text format or graphic format.

The taking note task 1045 is same as the one in FIG. 8.

The tagging task 1050 is same as the one in FIG. 9.

The linking task 1055 is same as the linking task 180 in FIG. 1 The other procedures and tasks 1060 could include the solving problem procedure 135, the taking test procedure 140, the playing game procedure 145, the reforming task 170, the feedback task 175, and the comparing task 185.

FIG. 11 is an example of a generated subroutine to review a theorem. This figure shows how a generated subroutine leads user to review theorems systematically on every aspect user has chosen.

Under the window interface 1110, there are tasks. User can launch any of the tasks.

The prompting a theorem name task 1111 asks user to input the name of a theorem or the identification if the theorem has no name.

The stating theorem task 1112 asks user to state a theorem.

The recalling observation task 1113 asks user to recall the observation related to the theorem.

The recalling meaning task 1114 asks user to recall what the theorem means.

The recalling proof outline task 1115 asks user to recall the general idea of a proof as well as the methodology of the proof.

The recalling proof task 1116 asks user to recall the proof of the theorem by actually writing down each step of proof It could also encourage user to think about possible new proof.

The looking at theorem differently task 1117 asks user to look at the theorem differently. The task could ask a user if the user can feel why the theorem is right and if the user can state the theorem from different point of views.

The specializing theorem task 1118 asks user to recall the specialization of the theorem, make the theorem more specialized, and specialize the theorem differently.

The generalizing theorem task 1119 asks user to recall the generalization of the theorem, make the theorem more generalized, and generalize the theorem differently.

The modifying theorem task 1120 asks user to replace one or more keywords of the theorem by similar keywords to see how the theorem should change in order to make sense.

The recalling typical application task 1121 asks user to recall the typical applications of the theorem. Some user such as an engineer in an application field may be required to familiarize each typical application well. The task could also encourage user to look for possible new applications.

The recalling typical example task 1122 asks user to recall the typical examples related to the theorem. This task may guide user to further recall selected specific aspects of a typical example. For example, Newton's second law has many typical examples. With a systematic review of all typical examples relevant to Newton's second law, students could be able to understand the law better and achieve better results in their examinations.

The showing related not task 1123 displays all notes related to the theorem.

The searching database task 1124, the taking note task 1125, the tagging task 1126, and the linking task 1127 are same as the corresponding one in FIG. 10.

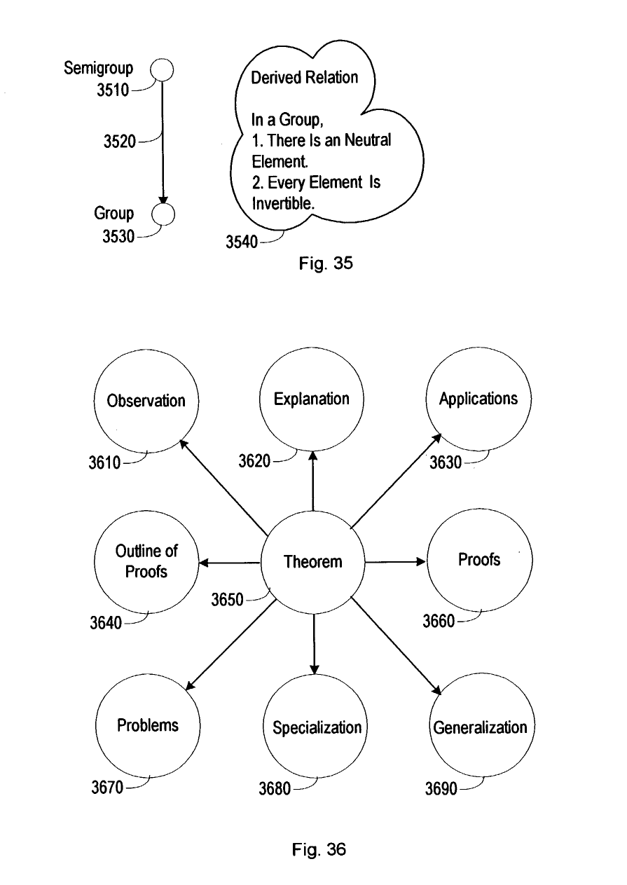

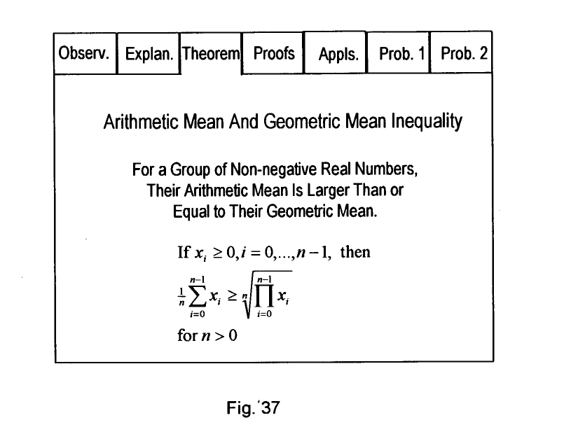

The exploring theorem task 1128 provides interface to let user examine every aspect of the theorem user wishes to check. The interface could be similar to one as FIG. 36 or FIG. 37.

By capturing user response, the feedback task 1129 checks that if user's answers are correct and supplies user with related information.

FIG. 12 shows an example of a generated subroutine to review a problem. It lets user recall as much information as possible, search for related objects from database, and make new links. It could ask user to state the problem, explain what the problem means, the solution approach, etc.

There are many tasks under the control of window interface 1210.

The selecting a saved problem task 1211 lets user select a solved problem from database.

The displaying the problem task 1212 displays the problem.

The recalling meaning task 1213 asks user to recall the meanings of the problem. It could proceed by asking questions such as what is the unknown, what is the data, etc.

The recalling solution task 1214 asks user to recall the general idea to solve the problem.

The looking at the problem differently task 1215 asks user to look at the problem differently. The task could ask a user that if the user can obtain the answer directly or differently, modify the problem, and make the problem into a theorem.

The stating related concepts and theorems task 1216 asks user to state related concepts and related theorems. A user could search database for related objects in case the user has difficulty to recall.

The specializing the problem task 1217 asks user to make the problem more specialized or specialize the problem differently.

The generalizing the problem task 1218 asks user to make the problem more generalized or generalize the problem differently.

The showing related note task 1219 lets user view the notes associated with the problem.

The searching database task 1220, taking note task 1221, tagging task 1222, and linking task 1223 are same as the corresponding ones in FIG. 10.

The exploring problem task 1224 is to let user examine every aspect of the problem.

The applying the method to other problem task 1225 asks user to generalize the methodology for solving the problem and apply the methodology to other problems.

FIG. 13 shows the detail of the solving problem procedure 135 in FIG. 1. Under the window interface 1310, user can launch many tasks.

Different type of problem may need a different question. The setting up task 1315 lets user choose general questions associated with each type of problems. This task also lets user set up help level and specify problem type and sub-type if possible.

According to George Polya, effective problem-solving method consists of four main phases: understanding the problem, devising a plan, carrying out the plan, and looking back at the solution. Understanding the problem includes identifying unknowns, condition(s), and data, labeling them, and determining the solubility of the problem. Devising a plan means drawing on prior knowledge to frame an appropriate technique, restating the problem if necessary. The chosen technique is then carried out in the third stage. The final phase consists of checking the correctness of the solution and adding the problem to one's store of knowledge for use in solving future problems. The solving problem procedure 135 will generate proper questions and advice at each stage to guide user to proceed, provide interface for user to work on, and capture related information. More intelligent and more concrete questions could be generated if the problems have been sorted according to its type.

A problem may be a new problem or may be a left problem. User can start a new problem by opening a new problem task 1320. User can continue to work on a problem left before by opening an existed problem task 1325. At step 1330, user will be asked if user wants to start from beginning and forget what he has done before. If user prefers to continue the work one left before, the recovering status task 1335 will be called to recover the status. If user prefers to restart, the resetting status task 1340 will reset the saved status about the problem and delete any user comment made about the problem before. When user wants to leave a problem that user is working on currently, user can do so by calling the saving status task 1345. The status about a problem could include the symbols induced, the figures drawn, auxiliary problems, comments, etc.

The understanding problem procedure 1350 is to guide user to understand the problem. According to G. Polya, the procedure may raise instructions and questions similar to the following at proper time.

“What is the unknown?”

“What are the data?”

“What is the condition?”

“Is it possible to satisfy the condition?”

“Is the condition sufficient to determine the unknown?”

“Is it insufficient? Or redundant? Or contradictory?”

“Draw a figure.”

“Introduce suitable notation.”

“Separate the various parts of the condition.”

“Can you write them down?”

The finding connection procedure 1355 is to guide user to find out the relation between data and unknown, assumption and conclusion. Based on problem type and feedback from user, the procedure could raise proper instruction and questions at proper time. According to G. Polya, the procedure may raise instructions and questions similar to the following:

“Consider auxiliary problems if an immediate connection cannot be found.”

“Have you seen it before?”

“Have you seen the same problem in a slightly different form?”

“Do you know a related problem?”

“Do you know a theorem that could be useful?”

“Look at the unknown! And try to think of a familiar problem having the same or a similar unknown.”

“Here is a problem related to yours and solved before. Could you use it?”

“Could you use its result?”

“Could you use its method?”

“Should you introduce some auxiliary element in order to make its use possible?”

“Could you restate the problem?”

“Could you restate it still differently? Go back to definitions.”

“If you cannot solve the proposed problem try to solve first some related problem.”

“Look around for an appropriate related problem.”

“Could you imagine a more accessible related problem?”

“A more general problem?”

“A more special problem?”

“An analogous problem?”

“Could you solve some part of the problem?”

“Keep only one part of the condition, drop the other part; how far is the unknown then determined, how can it vary?”

“Could you derive something useful from the data?”

“Could you think of other data appropriate to determine the unknown?”

“Could you change the unknown or data, or both if necessary, so that the new unknown and the new data are nearer to each other?”

“Did you use all the data?”

“Did you use the whole condition?”

“Have you taken into account all essential notions involved in the problem?”

The carrying out plan procedure 1360 is to guide to actually solve the problem. Based on user selection and feedback from user, more or less advice will be given. According to G. Polya, the procedure may include the following questions:

“Carrying out your plan of the solution, check each step.”

“Can you see clearly that the step is correct?”

“Can you prove that it is correct?”

The looking back procedure 1365 is to guide user to check the answer. This procedure helps user to understand the problem better. According to G. Polya, the procedure may include the following questions:

“Can you check the result?”

“Can you check the argument?”

“Can you derive the solution differently?”

“Can you see it at a glance?”

The searching database task 1370 is same as the one in FIG. 1. The task lets user search related information from database.

The displaying object task 1375 is same as the one in FIG. 1. This task enables user to display related objects in various formats.

The feedback task 1380 is same as the on in FIG. 1. This task is to obtain feedback from user and collect necessary information to help user.

The generating intelligent question task 1385 presents user a new generated question or advice on spot. These questions and advice are based on user's response and the detail classification of problem. For each different type of problems, there are corresponding advice and questions. Knowing that a problem is a geometric construction problem, the task could give specific advice instead of general advice. The task could give advice “if you cannot construct the required figure, think of the possibility of constructing a figure similar to the required figure” instead of “if you cannot solve the problem, try to solve a related problem”.

FIG. 14 shows the detail of the taking test procedure 140 in FIG. 1. First, this procedure lets user set up the scope. Then the procedure selects a statement, which is the definition of a concept, the description of a theorem, or simply a fact. Further, the procedure will display the statement with one or more keywords blanked, provide several choices, and ask user to select one. Also the procedures could modify the statement, display the modified statement, and ask user to answer true or false. In addition, it could select a problem and then ask user to solve the problem with some modification.

The window interface 1410 enables user to start a task.

A test could consist of filling blank problems, multiple choice problems, true and false problems, and modified problems. A different type of problem is linked to a different subroutine. Different subject may have different type of test. The setting up 1415 is to set up the test such as specifying test type, test scope, and test difficulty.

The procedure could select a statement at step 1420. The procedure displays the statement with some keywords blanked at step 1425 and then asks user to fill the empty spot at step 1430.

The procedure could modify the statement and display the modified statement at step 1435. One way to modify is to replace a keyword by one of its synonyms, or one of its antonyms, or a similar one. Another way to modify is to narrow or to expand the domain of the statement. Then the procedure asks user to make judgement if this modified statement is true or not at step 1440.

The procedure could also display the statement with a keyword blanked and supply multiple choices at step 1445. Then the procedure asks user to select one from multiple choices at step 1450. The multiple choice could consist of the keyword, its equivalents, its antonyms, its similarities, and unrelated words. When a keyword is about the domain or range, such as all and any, the procedure could provide multiple choices such as all, any, each, at least one, at most one, exactly one, etc.

The procedure could select a saved problem from database at step 1455. The procedure will modify the problem and display the modified problem at step 1460. How to modify a problem could involve many different branches of artificial intelligence. The procedure could generate a modified problem by replacing a number by a different number in a saved problem and changing a name to a different name. The procedure could also simply retrieve a problem from database prepared by author. Then the procedure will ask user to solve problem at step 1465.

Based on user input, the procedure will make comparison and display the result to user at step 1470. For a problem of filling blank, the procedure could call an algorithm shown in FIG. 30 to judge if two objects are equivalent. For a problem of multiple choices, or selecting true or false, the procedure has answer already when preparing the problem. For a problem prepared by author, there could be answer in database.

The solving problem procedure 135, the searching database task 150, and linking task 180 could be included in other procedures and tasks 1475.

FIG. 15 shows the playing game procedure 145 in FIG. 1. This procedure provides some exercise such as filling blanks, selecting one from multiple choices, listing related objects, filling color or area pattern, and making connection. The purpose is to let user be familiar with related objects such as concepts and theorems. With playing game, user will feel more natural about the objects and gradually the objects will become part of their knowledge. The procedure could give some yes or no question by modifying a theorem. The procedure could be also present a theorem in different form, erase some key words, ask user to fill the right words, and list related objects. The procedure could ask user to complete half-completed information map and assign properties to a line connecting two objects or a boundary shape.

Under the window interface 1510, user can set up, fill blanks, select one from multi-choices, complete an uncompleted map, and list related objects.

The setting up task 1515 enables user to set up the scope, game types, etc.

The selecting object task 1520 provides interface for user to select one object or several objects. Depending on setting, an object could be in form of map, table, or text. The task could also provide interface for user to select by subject, keyword, and property.

The procedure displays a statement with some keywords blanked at step 1525. The statement could be a definition, a description of a theorem, or a fact. Then the procedure asks user to fill the blanks at step 1530.

The procedure can modify a statement and display the modified one at step 1535. Then the procedure asks user to answer true or false at step 1540.

The procedure could display the object at step 1545. Then the procedure will specify the requirements at step 1550 and ask user to list the related objects at step 1555.

The procedure could display a set of related objects as individual points at step 1560. At step 1565, the procedure specifies relations and their representatives. A line with different line patterns, line colors, and line weights could stand for a different relation. A shape with different colors and area patterns could stand for different relations. At step 1570, the procedure could ask user to color map by grouping the objects with certain property in one shape and the object with different property in different shape. At step 1575, the procedure asks user to draw a map by connect related objects by a proper line.

The comparing task 1580 is same as the one in FIG. 1. On capturing user feedback, the comparing task 1580 is to compare the user response with the one saved in database or generated by the procedure. This task may use topology to check if two maps are equal topologically.

The showing answer task 1585 will show the answers.

The counting score and feedback to user task 1590 is to show user the score and provide other feedback to the user.

The other procedures and tasks 1595 could includes the problem solving procedure 135, the searching database task 150, and the linking task 180.

FIG. 16 shows a searching database task. The searching object task consists of inputting keywords or tag label, selecting objects, and jumping to a related object. Search can be done graphically or through text. For example, user can search database for theorems having one or more specified keywords. User could specify a set of keywords that a candidate theorem must have each of the keywords in its description, and specify another set of keywords that any candidate theorem must not contain any of the keywords in its description. Further, user can search database for objects with specific notes, structure and methodology. User can also search for objects with custom defined property.

User can launch any of the tasks under the window interface 1610.

The setting up search rule 1615 defines the search rules. The rule can be defined by logical combination of some keywords. The search rules could be any rule to help the system to make correct decision during its search processing. One of most common rules is the logical combination of some keywords, which specify which keywords a candidate must have, which keywords it must not have, which keywords it could do not have but it should have alternate keywords. Further, the sequence of keywords could be specified. In addition, which affiliated objects should be checked and which affiliated objects should not be checked. A theorem may have associated problems, proofs, and explanations. User can specify that if the task should check a keyword in proof of theorems.

The setting up search scope task 1620 is to let user set up the search scope. Some keywords used in different subjects may have different meaning. The restriction of search scope reduces the ambiguity and makes the system work faster.

The other setting up task 1625 is to let user be able to set up other setting such as displaying formats for different type of objects.

The displaying object task 1630 is same as the one in FIG. 1. When an object has been found, the object and its related objects will be displayed. Depending on the setting, part or all of the selected properties of an object will be displayed in one or more formats. Focus can be on the relation between the given object and its neighbor objects.

The selecting object task 1635 lets user select desired objects from map, table or text description. The selected objects will be highlighted. User can associate a task or a subroutine with a highlighted object.

The searching by subject task 1640 guides user to search objects by subject. After user inputs a subject name such as mathematics, the searching by subject task 1640 will show all the related objects under the subject such as mathematics. Under the subject mathematics, there are different topics such as linear algebra, topology, probability, etc. User can select one of the topics, such as linear algebra, then select a sub-object under the topic. User can also go back or go forward as regular window interface can provide. Furthermore, user can put a bookmark on some position, which lets user jump to that position later.

The searching by keyword task 1645 guides user to search objects by keywords. The task searches for all the objects associated with some keywords in a way specified by the search rules. User can specify where user wants to find the keywords. For example, if user is going to look for a theorem related to a keyword, user can specify whether to find the specified keyword in description, in proof, or in associated user notes.

The search by tag task 1650 lets user search for objects with a specific tag. For example, there is theorem called T1:

If x and y are invertible elements for an associative composition Δ on E, then xΔy is invertible for Δ, and (xΔy)*=y*Δx*.

User may assign a tag on (xΔy)*=y*Δx* and label the tag as L1.

There is another theorem called T2:

If f is a bijection from E onto F and if g is a bisection from F onto G, then g·f is a bijection from E onto G, and (g·f)*=f*·g*.

For (g·f)*=f*·g* is pretty like (xΔy)*=y*Δx*, user may assign the same tag L1 to (g·f)*=f*·g.

When user sees theorem T1 and finds that there is a tag called L1, the user can search for all the theorems having tag L1. In this case, user will find both of theorems T1 and T2.

The searching by other links task 1655 lets user search by other links. An example is to search related objects by the order appeared on a particular book. Another example is to search all objects directly being linked to an object or all objects referring to an object.

The other tasks 1660 include any auxiliary task to accomplish a search task.

FIG. 17 shows the preparing display task. This task does all the preparation work for displaying an object or a group of objects in various formats such as in map, table, text, and figure.

The window interface 1710 enables user to launch a task under its control.

The default setting 1715 lets user set up all the default settings. User can specify a scope and select all the objects under the scope.

The inputting object name task 1720 lets user specify name of an object or names of objects. The procedure could obtain the object name from user explicitly by this task or implicitly by other procedure or task.

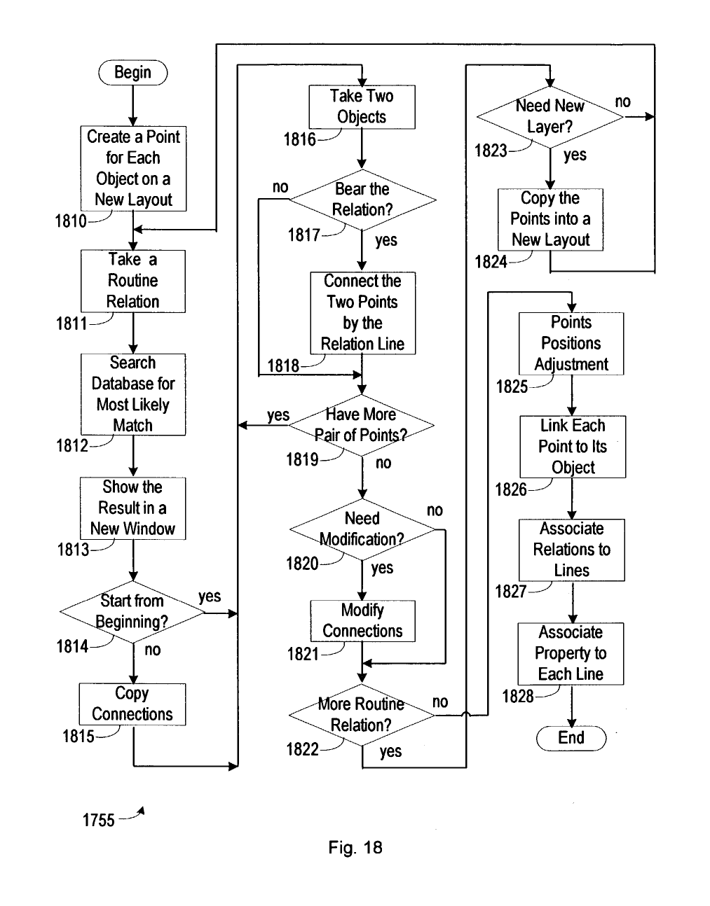

The building table procedure 1725 enables user to present the related information about objects in form of table. The detail of the procedure will be given in FIG. 20.

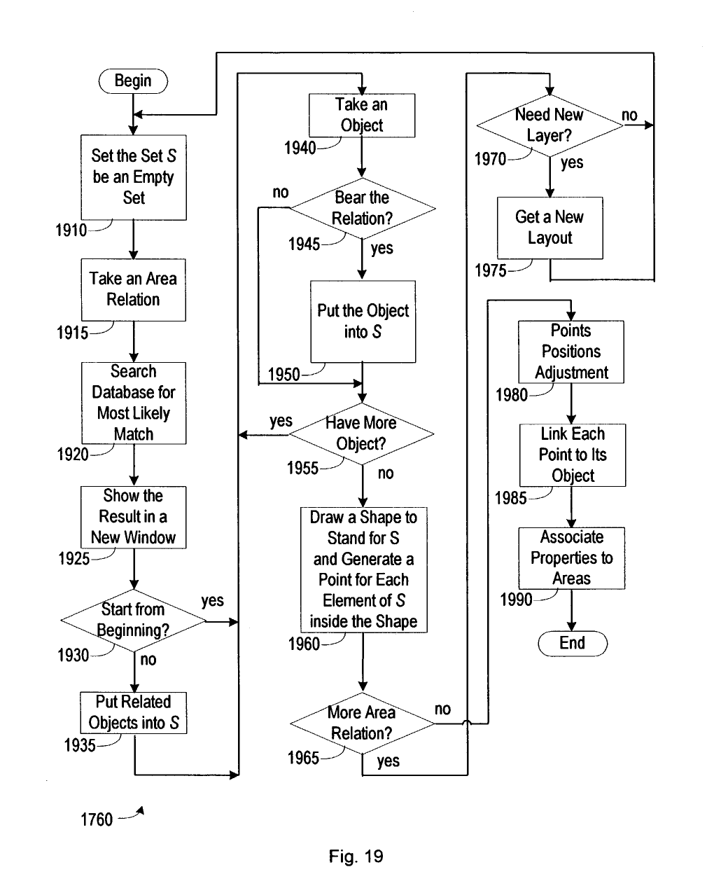

The building text procedure 1730 enables user to display text in a boundary shape such as a cloudy shape or a regular text window with vertical scroll bar control, horizontal bar control, page up and page down functions. The detail of building text procedure 1730 is given in FIG. 21.

A picture may be worth of many words. User may create some pictures. The creating figure task 1735 lets user create figures and associate the figures to related objects.

The creating voice task 1740 enables user to create voice and associate it to related objects.

Besides table and text window, information map is one of the most common methods to illustrate the relations among objects. The interface of creating information map task 1745 provides user interface to build a map with related objects connected by lines and with different areas filled by different colors and area patterns. The lines could have different line patterns, line colors, and line weights.

There are two very common relations. One relation is called as routine relation, which exists between two objects. For example, when considering if an object is derived from another object, people could define a relation called derived relation. Two objects have the derived relation if one object is derived from another object. A line could be connected these two objects if the relation is symmetric. A line with arrow at one end could be used to link these two objects if the relation is unsymmetrical. The derived relation is a routine relation. Another relation is area relation, which is among a group of objects. When considering if an object has a particular property, people could define a relation called property relation. An object has the property relation if the object has the particular property. Based on if an object has a particular property, a set of objects could be separated into two subsets. Each object in the first subset has the particular property and each object in the second subset does not have the particular property.

The specifying relation task 1750 lets user specify the relations and their representations. One of most common relations is a routine relation, which could be represented by a line or a line with arrow at one or both ends. Lines with different line patterns, line colors, line widths, and line weights could represent different routine relations. A line could have one associated relation or more associated relations. There could be no line or more than one line between two objects. Some line could be thicker and some line could be thinner to reflect the relative information contained in these lines. More properties could be associated with a particular line.

Another most common relation is an area relation, which could be represented by a colored area or patterned area. Areas with different colors and different patterns could represent different area relations. More properties could be associated with a particular area.

A more complex map could have both lines and colored areas. Further, a map could have one or more layers of lines and one or more layers of colored areas. User can view each layer separately or jointly. An information map in 3-dimenstions could also be built.

Like a regular metropolitan map, an information maps could consist of many lines with different line patterns, line weights, and line colors and different color areas. User can zoom in to examine each of the affiliated objects of an object. User can also zoom out to see general connections. When user examines an object called house, user can zoom in to check everything in the house. The object bigger than the house is a community. User can zoom out to check the relations between the house and other houses in the community. The object bigger than a community is a city. By continually zooming out, user can check the relations among different communities in the city. The object bigger than the city is a state. User can check the relations among different cities of the state by zooming out further.

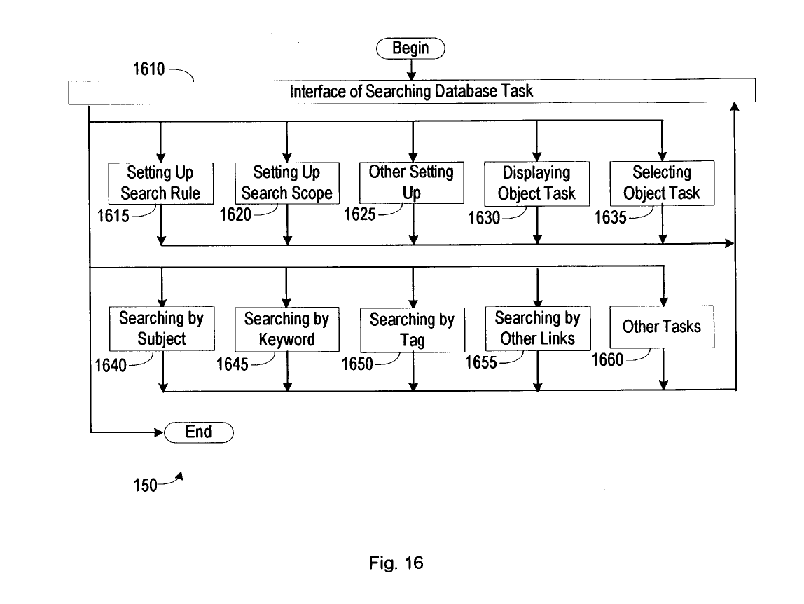

The routine procedure 1755 enables user to build an information map. The detail will be given in FIG. 18.

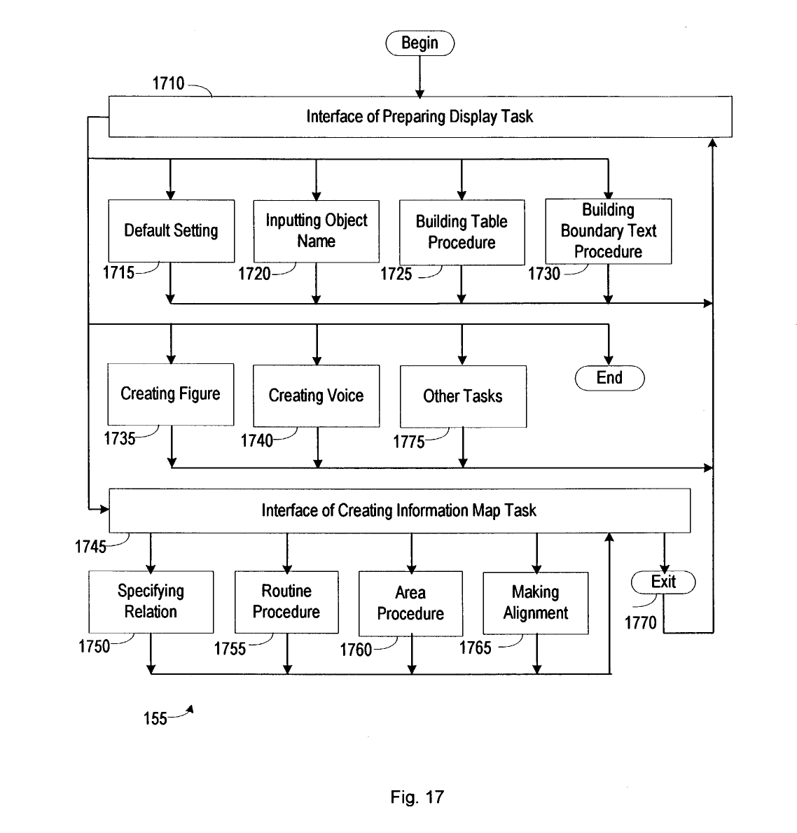

The area procedure 1760 builds an information map with different areas colored by different colors. The detail will be given in FIG. 19.

User can build a map with several layouts with each layout for a different relation on a same group of objects. User can view each layout separately or view some of the layout overlapped. When viewing several layouts overlapped, the objects on different layouts of a map may need to be aligned. The alignment task 1765 will align up the objects on different layouts of a map.

The exit task 1770 lets user exit and returns control to window interface 1710.

The other tasks 1775 may includes tasks such as searching database task 150, displaying object task 160, reforming task 170, and feedback task 175.

FIG. 18 shows the flowchart of routine procedure 1755 in FIG. 17 for building a map with routine relations. There could be one or more layouts in a map. In each layout, there could be one or more types of routine relations. Each layout consists of several objects with each object as a node, routine relations with each relation as connections among objects, and texts as labels. A different type of line stands for a different relation or relations. There could be no line, one line or more lines between two objects. One example will be given in FIG. 33.

At step 1810, the procedure creates a group of objects on a new layout as a set of points or nodes. The procedure also provides interface for user to move them to proper positions. Go to step 1811.

At step 1811, the procedure takes one routine relation. The relation is one of the routine relations specified by the specifying relation task 1750 in FIG. 17. Go to step 1812.

At step 1812, the procedure tries to find a routine map with the same relation and almost same objects. Go to step 1813.

At step 1813, the procedure shows the results if it finds any in database. Go to step 1814.

User may want to build a new map based on an existed one or simply start from very beginning. At step 1814, the procedure will provide interface for user to specify if user wants to start from beginning or make use some of the work saved in database. If user wants to make use of some work done previously, the user can select the interesting portion of a map and copy it into the new layout at step 1815. If not, go to step 1816.

At step 1816, the procedure takes two objects having not been checked for the relation before. Go to step 1817.

At step 1817, the procedure will make a judgement if the selected two objects bearing the relation. If they do bear that relation, go to 1818. If they do not bear the relation, go to step 1819. The procedure may call the algorithms described from FIG. 26 to FIG. 32 to obtain the judgement. The procedure could also provide interface for user to overrule the judgement made by the procedure.

At step 1818, the procedure connects the two points together by a line for the two objects bear the relation. The procedure could also provide interface for user to modify the connection. Go to step 1819.

At step 1819, the procedure checks if any point pair has not been considered. If there is any such point pair, the procedure will go to step 1816. If not, the procedure will go to step 1820.

Repeat steps 1816 to 1819 until all the point pairs have been examined.

At step 1820, the procedure will ask user if the user wants to make any modification. If yes, go to step 1821 and otherwise, go to step 1822.

At step 1821, the procedure provides interface for user to modify the connections. Go to step 1822.

At step 1822, the procedure will check if any routine relation has not been considered. If yes, go to step 1823 and otherwise, go to step 1825.

At step 1823, the procedure will check if a new layer needed. If yes, go to step 1824 and otherwise, go to step 1811.

At step 1824, the procedure copies the points into a new layout and then go to step 1811.

Repeat steps 1811 to step 1822 until all the routine relations have been considered.

At step 1825, the procedure will provide interface for user to just the positions of each object on different layers. Then go to step 1826.

At step 1826, the procedure will link each point or node to its corresponding object in database so that when user clicks the node, the information about the related object could be displayed. Go to step 1827.

At step 1827, the procedure will link each type of line to a corresponding relation so that when user clicks the line, the relation will be displayed. Go to step 1828.

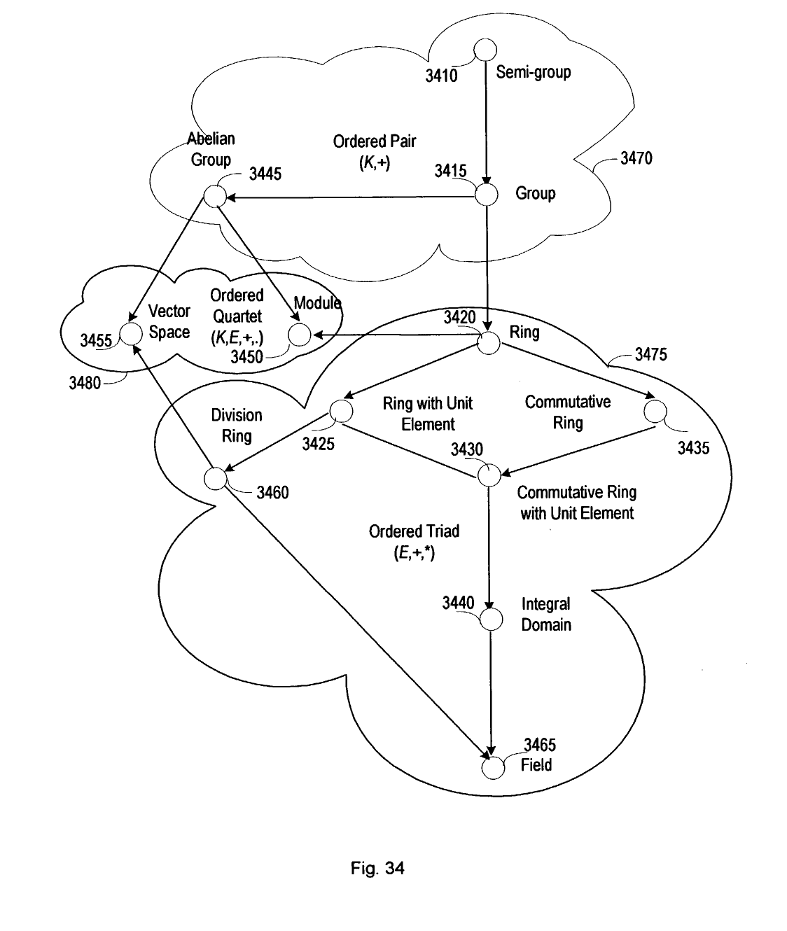

At step 1828, the procedure will provide interface for user to link other properties related to two objects to the line connecting these two objects together. When user clicks the line, not only the relation will be displayed but also the associated properties will be displayed. One example will be in FIG. 35.

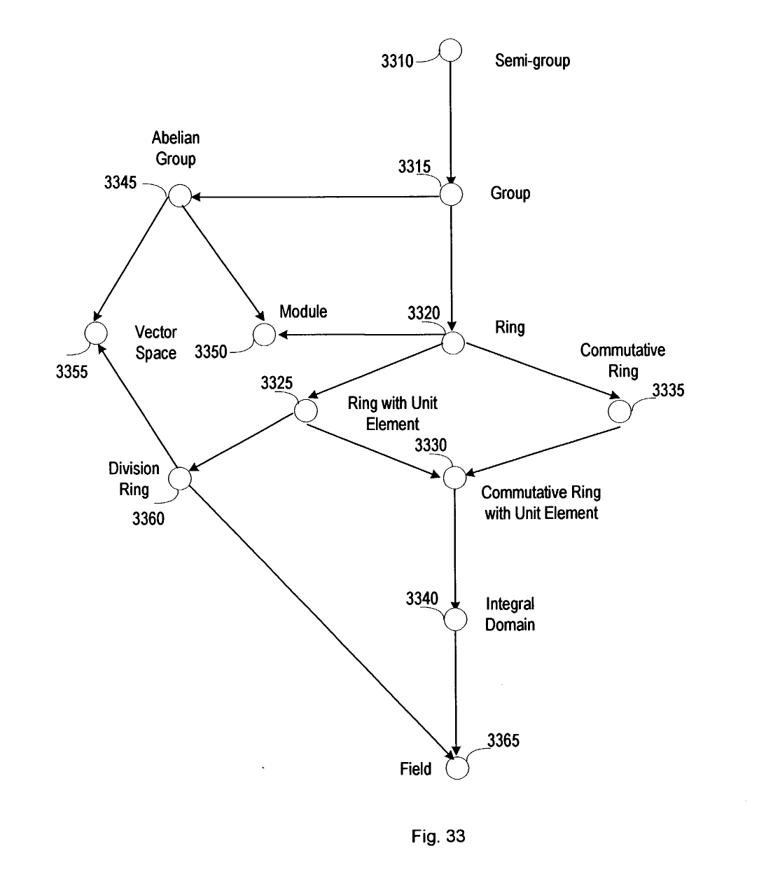

FIG. 19 shows the flowchart of area procedure 1760 in FIG. 17 for building a map with area relations. There could be one more layouts in a map. In each layout, there could be one or more types of area relations. Each layout consists of several objects with each object as a node, area relations with each relation represented by different shape, different fill color or fill pattern, and texts for labels. If a subset of a group of objects has a common property, it is convenient to represent the subset by a boundary shape filled with color or pattern. User can fill a boundary shape with different fill color or fill pattern to stand for different common properties. One example will be given in FIG. 34.

At step 1910, the procedure sets up an empty set S for an area relation. If an object bears the relation, this object will be included in the set S. If this object does not bear the relation, this object will not be included in the set S. Go to step 1915.

At step 1915, the procedure will take an area relation. The relation is one of the area relations specified at the specifying relation task 1750 in FIG. 17.

It could save time by building a colored area map from a colored area map saved in database if the saved colored area map has the same relation and almost same set of objects as one to be built. At step 1920, the procedure searches the database for a possible match. Go to step 1925.

At step 1925, the procedure will show the most matched map if it finds any. Go to step 1930.

User can build an area map from scratch or copy from a previous one in database. At step 1930, the procedure will provide interface for user to specify if the user wants to start from beginning or build from a saved map. If user prefers to start from beginning, the procedure will go to step 1940. Otherwise, the procedure will go to step 1935.

At step 1935, the procedure puts related objects bearing the area relation into the set S, and then goes to step 1940.

At step 1940, the procedure takes an object having not been considered for the area relation from a group of objects specified by the inputting object name task 1720 in FIG. 17. Then the procedure will go to step 1945.

At step 1945, the procedure checks if the object bear the area relation. If no, go to step 1955. If yes, go to step 1950. The procedure may call the algorithm described in FIG. 27 to judge if the object has the specified property.

If the object bears the relation, at step 1950, the procedure puts the object into the set S. Then the procedure goes to step 1955.

At step 1955, the procedure checks if any object has not been examined for the area relation. If yes, go to step 1940 and otherwise, go to step 1960.

When all objects have been considered, at step 1960, the procedure draws a shape to stand for S and generates points or nodes inside the shape with each node for an element of the set S. The shape could be in any form such as circle, rectangle or cloud. The procedure could also provide interface for user to change the shape. The procedure then goes to step 1965.

At step 1965, the procedure checks if there is any area relation, which is specified by the specifying relation task 1750 in FIG. 17 but has not been examined yet. If yes, go to step 1970 and otherwise, go to step 1980.

At step 1970, the procedure asks user if the user wants a new layer for the new area relation. If yes, create a new layer at step 1975 and then go to step 1910. If not, go to step 1910.

At step 1975, the procedure can create a new layout. Go to step 1910.

When all area relations have been examined, at step 1980, the procedure will show the position of each point and let user align up the points. Go to step 1985.

At step 1985, the procedure will provide interface for user to link each point to its corresponding object in database. When user clicks a node, its corresponding property will be displayed. Then the procedure goes to step 1990.

At step 1990, the procedure will provide interface for user to link each area to a corresponding area relation. When user clicks any point inside an area, the corresponding area relation will be displayed.

FIG. 20 shows the flowchart of a building table procedure 1725 in FIG. 17.

At step 2010, the procedure prompts user to select a proper table form. There could be many different forms with different form for different purpose. Go to step 2015.

At step 2015, the procedure asks user if user wants to start from very beginning or to uses a related table existed in database. If user wants to start from beginning, go to step 2040. Otherwise, go to step 2020.

At step 2020, the procedure searches in database the most likely matched table, which could have more items or less items than the required. Go to step 2025.

At step 2025, the procedure checks if such a table exists. If not, go to step 2040. Otherwise, go to step 2030.

At step 2030, the procedure displays the result found in database. Go to step 2035.

At step 2035, the procedure provides interface for user to copy the related part of the table into the new table. Then go to step 2040.

At step 2040, the procedure fills the table with related information. The information to be filled in the table depends on the setting up in the default setting 1715 of FIG. 17. The table is then filled with the content under corresponding tags of related objects. Then go to step 2045.

At step 2045, the procedure provides interface for user to modify the table.

FIG. 21 shows the flowchart of a building boundary text procedure 1730 in FIG. 17.

At step 2110, the procedure asks user to specify a boundary shape for filling text. Usually the boundary shape could be in any arbitrary shape. The very common shapes are text windows with vertical and horizontal scrolls, rectangles, and clouds. Go to step 2115.

At step 2115, the procedure asks user to specify the tags of an object to be included. Go to step 2120.

At step 2120, the procedure fills the boundary shape with the contents under the selected tags of specified objects. Go to step 2125.

At step 2125, the procedure will provide interface for user to modify the text.

FIG. 22 shows a displaying object task 160 in FIG. 1. This task lets user select the displaying format, display objects in various formats such as map, table, boundary text and figure, and associate voice with objects. The task could also enable user to zoom in to check the detail of an object, to zoom out to check the relation between the object and other objects.

The window interface 2210 enables user to start any tasks under its control.

The setting up task 2215 does all the set up works related to display objects. One of the works is to set up the default display format for each type of object.

The specifying display format task 2220 enables user to specify the display format for an object.

The inputting object name 2225 enables user to input object names for display.

The pronouncing voice task 2230 enables user to record voice and links the voice file to the related objects.

The task for displaying an object consists of step 2235 to step 2280.

At step 2235, the procedure asks user if the user wants to display objects in the form of map. If yes, go to step 2240 and otherwise go to step 2250.

At step 2240, the procedure calls the preparing display task 155 to build a map if the map is not available. Go to step 2245.

At step 2245, the procedure shows the information map.

At step 2250, the procedure asks user if the user wants to display objects in form of table. If it is, go to step 2255 and otherwise go to step 2265.

At step 2255, the procedure calls the preparing display task 155 to build a table if the table does not exist in database. Go to step 2260.

At step 2260, the procedure will display the table.

At step 2265, the procedure asks user if the user wants to display objects in form of boundary text. If yes, go to step 2270 and otherwise go to step 2280.

At step 2270, the procedure calls the preparing display task 155 to have a boundary shape filled with text. Go to step 2275.

At step 2275, the procedure displays the boundary text.

The other displaying methods 2280 include any other forms to display objects. The procedure could display objects in form of file cabinet, file folder, cascaded cards, or roller cards. The procedure could also display the image files attached with objects. The image files are scanned and inputted into the database by user and could be in any image format.

The viewing control task 2285 provides interface for user to examine objects and their relations. This task enables user to zoom in and zoom out, to move around, and to jump from one layer of map to another. As one is watching an electrical world map, user can observe an object closely as near view and examine its relation with other objects as far view. With keywords linked to corresponding objects, user can jump around or have a temporary drift. User can examine an object transversely by looking at the object from many different aspects.

FIG. 23 shows an updating database task 165 in FIG. 1. When an object is input into database, the system will check if it exists in database already. If not, the system will check if there is an equivalent one in database already. If the object has no any equivalent object in database, the object will be added into the system as a new object. If there are some equivalent objects in database, user will be asked that if the user wants the object to be added as a substitute of equivalent objects in database.

The window interface 2310 enables user to be able to update the database.

The setting up task 2315 lets user do all setting up works such as current working scope.

The adding new subject task 2320 lets user establish a new subject such as physics or chemistry into database.

The adding new topic task 2325 lets user create a new topic under a subject.

The creating new object task 2330 lets user build a new object under a topic. This task could call steps 2335 to 2375.

At step 2335, the task asks user input the name of the object and its description. Go to step 2340.

At step 2340, the task searches database for related objects. Go to step 2345.

At step 2345, the task will go to step 2350 if the system has found an exact object in database and the task will go to step 2355 otherwise. The task may call the algorithm described in FIG. 26 to tell if two objects are identical.

At step 2350, the task shows the one in database.

At step 2355, the task will go to step 2360 if the system has found an equivalent one in database and go to step 2375 otherwise. The task may call the algorithm described in FIG. 30 to tell if two objects are equivalent.

At step 2360, the task shows all the equivalent objects in database. Go to step 2365.

At step 2365, the task asks user if the user wants to make the object as one of the equivalent objects and associate them together. If yes, go to step 2370.

At step 2370, the task links all the equivalent objects together.

At step 2375, the task creates the object in customer database.

The linking object task 2380 is same as the one in FIG. 1. This task provides interface for user to link two objects together or unlink some connections among objects.

The modifying object task 2385 provides interface for user to modify an object in the database.

The assigning property task 2390 provides interface for user to assign property to an object in database.

In many languages, an object usually could be described in many different ways. On one hand, the flexibility of a language provides author various ways to describe an object to meet the needs of different people. On another hand, the flexibility of a language makes comparison complex and difficult. In order to identify the relation between two objects, the system could employ any artificial intelligence technology such as pattern recognition and training. Further the system could preprocess the description of an object to make the preprocessed description of the object more formalized. A major function of the reforming task 170 in FIG. 1 is to make the description of an object more formal. FIG. 24 describes this function. It consists of many tasks with each task focusing on a different role. An object can be defined by well-known objects and a set of object defined previously. A well-known object or a previously defined object is referred as an element. Here the relation between two elements is also considered as an element. Two objects are considered the same if each of them consists of the same elements. Sometimes these elements could be separated into several groups for easy to compared. For example, in a theorem, one could separate the elements into the subject group, the cause group, and the effect group. Two theorems will be considered the same if each group of the first theorem is equivalent to the corresponding group of second theorem.

The window interface 2410 enables user to start each task to perform a corresponding function.

The creating and modifying rule task 2411 lets user set up rule and change rule. The rule includes all the requirements on the acceptable formats. User could specify the rule by a way similar to describing the syntax of a computer language. In a particular subject, some symbols are usually used to represent a particular type of object. When user change the symbols for a particular object, all the symbols regarding that type of object will be changed correspondingly.

The searching for related example task 2412 searches for all related examples in a specified scope of database, which could serve as models. There could be several standard ways to describing an object. After database has collected many different ways of describing a particular type of object, the system could have the flexibility to describe an object differently.

The displayed related example task 2413 displays all the examples for a particular type of object or display only the example most likely matched to the input object. This task is usually called by the searching for related example task 2412. User could call this task directly to show the examples found.

The literal regulation task 2414 is to make the text description standard. There could be several acceptable ways of describing a same object or relation. For example, “A is invertible for A.” is another way of saying, “A has an inverse with respect to A.” Nevertheless, from time to time, people may say “A is invertible.” or “A has an inverse.” Under circumstances, all of these descriptions are considered as equivalent. If the first two descriptions are chosen as standards, the last two descriptions should be changed. The task tries to modify the description of an input object so that the description is more close to one of the standards. The task also provides interface for user to modify the description manually.

The symbol substitution task 2415 is to replace a symbol under a certain scope automatically. For example, in most time, one may use S to stand for a set. If the symbol S has been used to different object, then one may use F for the set.

The separation task 2416 is to let user separate an object into several small objects. For example, when a theorem has many assumptions and several conclusions, user may wish to separate the theorem into several smaller theorems with each theorem has several assumptions and one conclusion directly related to these assumptions. With the separation, user may understand the theorem better by knowing that some assumptions have nothing to do with certain conclusion or for some conclusion to be hold, it is not necessary to have all the assumptions to be met. Separating a set into several small subsets could be done by user or by the system.

For example, a theorem could be “A if and only if B.” This theorem could be separated into two theorems. One is “If A, then B.” and another is “If B, then A.”

There is another example. Suppose there is a theorem “If A, then B and C.” This theorem also could be separated into two theorems “If A, then B.” and “If A, then C.”

The third example is a little bit complex. Suppose that the theorem “If A₁ and A₂, then B and C” really means “If A₁ holds, then B is true” and “If A₂ holds, then C is true”, then this theorem could be separated into two theorems. The first one is “If A₁, then B.” and the second one is “If A₂, then C.”

The completion task 2417 is to make a description closed to standard concepts by replacing a statement with another statement, which is derived from the first statement and other statements. The first statement alone is not equivalent to second statement. However, together with other statements, people can derive the second one from the first one.

For example, there are two descriptions. One is “Set G is commutative. The identity element e in G is such an element that for any a in G, aΔe=a.” Another is “Set G is commutative. The identity element e in G is such an element that for any a in G, aΔe=eΔa=a.”

Generally aΔe=a does not mean eΔa=a. Since G is commutative, for any a in G and b in G, aΔb=bΔa. Therefore, people can derive eΔa=a from aΔe=a and hence obtain aΔe=eΔa=a, which is the standard definition of the identity element e no matter whether G is commutative or not.

This inverse could also take place when an object needs to be described differently.

The combination task 2418 is to combine several smaller theorems into a big theorem. This strategy may be used to generate a new problem. For example, if A₁ holds, then B₁ is true, and if A₂ holds, then B₂ is true. When A₁ and A₂ do not contradict with each other, one can say that if A₃ holds, then B₃ is true. Where A₃ is the union of A₁ and A₂, and B₃ is the union of B_{1 and B}₂.

The recapitulating task 2419 is to replacing description of an object in several more basic concepts by a more advanced concept. For example, people can define a field as:

There is a nonempty set called F. Each element of F is called an element. There are two operations on F, one is called addition and another is called multiplication. Denote the addition operation by + and the multiplication operation by ·. The addition of any two elements of F is still an element of F and the multiplication of any two elements of F is still an element of F. The addition and multiplication have the following properties:

1. Any a, bεF, a+b=b+a;

2. Any a, b, cεF, (a+b)+c=a+(b+c);

3. There is an element denoted as 0 such that for any aεF, a+0=a;

4. For any aεF, there is an element b in F such that a+b=0;

5. For any a, bεF, a·b=b·a;

6. For any a, b, cεF, (a·b)·c=a·(b·c);

7. There is an element e which is not 0 such that for any aεF, a·e=a;

8. For any aεF with a≠0, there is an element b of F, such that a·b=e;

9. For any a, b, cεF, a·(b+c)=a·b+a·c.

People can simplify the definition by more advanced terminology when realizing that:

Property 1 is called commutative for + operation and property 5 is called commutative for · operation;

Property 2 is associative for + and property 6 is associative for ·;

Property 1 and property 3 define an identity element for + and property 5 and property 7 define a unit element for ·;

Property 1 and property 4 say that any aεF has an inverse element for + and property 5 and property 8 say that any aεF with a≠0 has an inverse element for ·;

Property 5 and property 9 define distributive of · operation over + operation;

The addition of any two elements of F is still an element of F is called closure for addition and the + operation is binary operation;

The multiplication of any two elements of F is an element of F is called closure for multiplication and the · operation is binary operation;

The set F with the two binary operations defined on it is called algebraic structure with two compositions.

One can define field as:

A field is an algebraic structure with two compositions. One composition is called addition and another composition is called multiplication. The multiplication is distributive over the addition. There is an identity element for addition and there is a unit element for multiplication. Every element has an inverse element for addition and every nonzero element has an inverse element for multiplication. Both compositions are commutative and associative.

The decomposing task 2420 replaces a previously defined object in the description of the object by the corresponding description of the previously defined object and then reorganizes the modified description. It could also replace the most complex previously defined object in the description of the object by the corresponding description of the most complex previously defined object. Replacing all, some or just most complex previously defined object depends on setting.

The displaying result task 2421 is to display the original input expression, the preprocessed expression, etc.

The tagging task 2422 is same as the one 860 in FIG. 8.

The feedback task 2423 is same as the one 175 in FIG. 1 to get user's feedback, which is used to modify the regulation.

The modifying result task 2424 provides user interface to modify results.

The saving result 2425 provides user interface for user to save the results into system.

The inputting object task 2426 provides interface for user to input an object and its description.

Most of these tasks are relatively independent. Sometimes a series of these tasks should be work together in a certain order to generate initial results. For example, once user inputs an object, a series of tasks will be executed automatically in a certain order. First, the searching for related example task 2412 is called to look for an example or model from database. Then the display related example 2413 is called to display the result. The literal regulation task 2414 will be called to make statement more standard. When user wants to change the symbol, the symbol substitution task 2415 will be called to replace a symbol by another one. Finally, the displaying result 2421 and the modifying result 2424 will be called to display the result and let user modify the result.

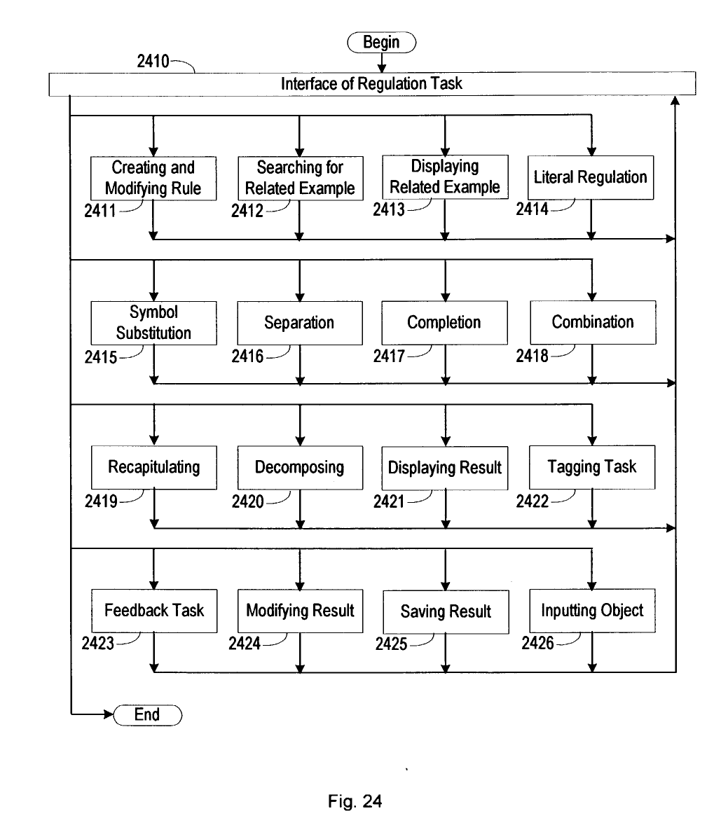

FIG. 25 shows two equivalent objects S₁ and S₂. S₁ 2510 has elements S_{1A} 2520, S_{1B} 2530 and S_{1c} 2540, while S₂ 2550 has elements S_{2A} 2560 and S_{2B} 2570. Each element further consists of several elements. S_{1A} 2520 has elements {e1, e2, e3}, S_{1B} 2530 has elements {e4, e6, e7}, and S_{1C} 2540 has {e3, e5, e6}. S_{2A} 2560 has elements {e1, e2, e4, e5, e6} and S_{1B} 2570 has elements {e1, e3, e5, e7}. S₁ is considered to be equivalent to S₂ since S₁=S_{1A}∪S_{1B}∪S_{1C}={e1, e2, e3, e4, e5, e6, e7}=S_{2A}∪S_{2B}=S₂. Here two same elements of an object are considered one element. This is needed for dealing with definition with some concepts overlapped. There are many redundancies in human language. For example, by definition, there is a unit element in any integral domain, sometimes people still say an integral domain with unit element for emphasizing that there is a unit element in the integral domain.

FIGS. 26 to 32 assume that two or more copies of an object are same as one copy of the object. In case people must distinguish different copies of the object, people could consider them being different, use different symbols to stand for them, and attach an additional property that they are identical.

For efficiency, the system could compare two objects by their main features first. If they are identical or equivalent on these main features, the system will continue to compare other features. Otherwise, they are different. For example, semigroup, group, and abelean group are algebraic structures with one composition and an ordered pair, which could be represented by a set and a composition. While ring, division ring, integral domain, ideal, and field are algebraic structures with two compositions and an ordered triad, which could be represented by a set and two compositions. If one object is described by an algebraic structure with one composition and another object is described by an algebraic structure with two compositions, these two objects are different and no need for further comparison.

FIG. 26 is the algorithm to tell if two objects are identical. Here there are two objects A and B. Objects A and B are considered to be identical if both objects have same immediate elements with the only difference being sequence of these elements. For example, suppose S₁, S₂, S₃, and S₄ are different objects, if A={S₁, S₂, S₃} and B={S₁, S₃, S2}, then they are identical. However, if B={S₁, S₄} with S₄={S₂, S₃}, they will not be considered being identical even they consist of the same basic elements.

Suppose that two objects are given. One is denoted by A and another by B. At step 2610, the algorithm decomposes A into a set of immediate sub-objects called {Aᵢ}. Go to step 2615.

At step 2615, the algorithm decomposes B into a set of immediate sub-objects called {Bⱼ}. Go to step 2620.

At step 2620, the algorithm checks if the number of sub-objects {Aᵢ} is equal to the number of sub-objects {Bⱼ}. If both sets have same number of sub-objects, go to step 2625 and go to step 2260 otherwise.

At step 2625, the algorithm checks if {Aᵢ} or {Bⱼ} has become empty. If one of them is empty, go to step 2650. Otherwise, go to step 2630.

At step 2630, the algorithm takes a sub-object denoted by A′ from the set {Aᵢ} and deletes this sub-object from the set {Aᵢ}. Go to step 2635.

At step 2635, the algorithm tries to find the sub-object A′ in {Bⱼ}. If the algorithm successes, go to step 2645. Otherwise, go to step 2640.

At step 2645, the algorithm deletes the sub-object A′ from the set {Bⱼ}. Go to step 2625 for next iteration.

At step 2650, the algorithm checks if both sets {Aᵢ} and {Bⱼ} are empty. If yes, go to step 2655. Otherwise, go to step 2660.

At step 2640 or step 2660, the algorithm returns false, which means that objects A and B are not identical.

At step 2655, the algorithm returns true, which means that objects A and B are identical.

FIG. 27 is the algorithm to check if an object α is contained in set an object A.

Two objects α and A are given.

At step 2710, the algorithm checks if the object a is related to the object A. If it is clearly that there is no any connection between them, and then go to 2770. Otherwise, go to 2715.

At step 2715, the algorithm checks if the object a is contained in the object A. If it is clearly that the object a is contained in the object A, go to step 2765. Otherwise, go to 2720.

At step 2720, the algorithm decomposes the object A into a set of sub-objects {Aᵢ} and marks each sub-object Aᵢ. Go to step 2725.

At step 2725, the algorithm takes a marked sub-object and unmarks it. This sub-object is denoted by A′. Go to step 2730.

At step 2730, the algorithm makes a judgement if object α is contained in the sub-object A′. This can be accomplished by calling this algorithm with replacing A by A′. If the answer is true, go to step 2765 and if not, go to step 2735.

At step 2735, the algorithm checks if there is any marked sub-object in {Aᵢ}. If there is any marked sub-objects in {Aᵢ}, go to step 2725 and otherwise go to step 2740.

At step 2740, the algorithm checks if the object a is compound object. If α is not a compound object, go to 2770. Otherwise, go to step 2745.

At step 2745, the algorithm decomposes α one level down into a set of sub-objects {αⱼ} and mark each of the generated sub-objects. Go to step 2750.

At step 2750, the algorithm takes a marked sub-object denoted by α′ and unmarks it. Go to step 2755.

At step 2755, the algorithm checks if the sub-object α′ is contained in object A. It can be accomplished by calling this algorithm by replacing α with α′. If the sub-object α′ is contained in object A, go to step 2760. Otherwise, go to step 2770.

At step 2760, the algorithm checks if there is any marked sub-object in {αⱼ}. If there is any marked sub-object in {αⱼ}, go to step 2750. Otherwise go to step 2765.

At step 2765, the algorithm returns true, which means object α is contained in object A.

At step 2770, the algorithm returns false, which means object α is not contained in object A.

FIG. 28 is the algorithm to find out relative complement of object B in object A, which is a set consisting of all the sub-objects in A but not in B. The set is denoted by A-B. Since people intend to define an object by some of previously defined objects instead of by very basic objects, this algorithm tries to find as bigger sub-object in A but not in B as possible.

At step 2810, the algorithm makes the sets C and D be empty and set {Aᵢ} be {A}. Go to step 2811.

At step 2811, the algorithm checks if object A is an empty set. If object A is an empty set, go to step 2828. Otherwise, go to step 2812.

At step 2812, the algorithm checks if object A is equivalent to object B. If it is sure, go to step 2828 and otherwise go to step 2813.

At step 2813, the algorithm decomposes object A one level down into a set of sub-objects {Aᵢ} and marks each of the sub-objects. Go to step 2814.

At step 2814, the algorithm checks if there is any marked sub-object in {Aᵢ}. If yes, go to step 2815. Otherwise, go to step 2822.

At step 2815, the algorithm takes a marked sub-object A′ and unmarks it. Go to step 2816.

At step 2816, the algorithm checks if sub-object A′ is contained in object B. This can be accomplished by calling the algorithm in FIG. 27 with a substituted by A′ and A substituted by B. If sub-object A′ is contained in object B, go to step 2817 and otherwise go to step 2818.

At step 2817, the algorithm makes the set D equal to {A′}. Go to step 2820.

At step 2818, the algorithm checks if the sub-object A′ is a compound sub-object. If it is a compound sub-object, go to step 2821 and otherwise go to step 2819.

At step 2819, the algorithm appends A′ to the set C and go to step 2820.

At step 2820, the algorithm deletes sub-object A′ from set {Aᵢ} and then go to step 2814.

At step 2821, the algorithm makes the set D equal to sub-object {A′} and go to step 2814.

At step 2822, the algorithm checks if the set D is empty. If it is empty, go to step 2827 and otherwise go to step 2823.

At step 2823, the algorithm marks all the sub-objects of {Aᵢ} and then go to step 2824.

At step 2824, the algorithm checks if there is any marked sub-object in {Aᵢ}. If there is any marked sub-object, go to step 2825 and otherwise go to step 2828.

At step 2825, the algorithm takes a marked sub-object denoted by A′ from the set {Aᵢ} and unmarks it. Then go to step 2826.

At step 2826, the algorithm finds A′-B by calling itself with replacing A by A′ and appends A′-B to C. Then go to 2824.

At step 2827, the algorithm sets A-B be {Aᵢ} and then go to step 2829.

At step 2828, the algorithm sets A-B be C and then go to step 2829.

At step 2826, the algorithm returns A-B.

FIG. 29 is the algorithm to find out A∪B, the union of A and B.

At step 2910, two objects A and B are given. The algorithm sets the union of A and B be B. Go to step 2915.

At step 2915, the algorithm checks if A is equivalent to B. If yes, go to step 2945 and otherwise go to step 2920.

At step 2920, the algorithm decomposes object A one level down into a set of sub-objects {Aᵢ}, and mark each of the sub-objects. Then go to step 2925.

At step 2925, the algorithm checks if there is any marked object in {Aᵢ}. If yes, go to step 2930 and otherwise go to step 2945.

At step 2930, the algorithm takes a marked object A′, and unmarks it. Then go to step 2935.

At step 2935, the algorithm finds A′-B by calling the algorithm in FIG. 28 with A substituted by A′. Go to step 2940.

At step 2940, the algorithm appends A′-B to A∪B and then go to step 2925.

At step 2945, the algorithm returns A°B, the union of A and B.

FIG. 30 is the algorithm to test if object A is equivalent to object B.

Two nonempty objects A and B are given.

At step 3010, the algorithm calls the algorithm in FIG. 28 to find out A-B and then go to step 3015.

At step 3015, the algorithm checks if A-B is an empty set. If it is an empty set, go to step 3020. Otherwise, go to step 3035.

At step 3020, the algorithm finds B-A by calling the algorithm in FIG. 28 with A and B changed positions. Then go to step 3025.

At step 3025, the algorithm checks if B-A is empty. If it is empty, go to step 3030. Otherwise, go to step 3035.

At step 3030, the algorithm returns true.

At step 3035, the algorithm returns false.

FIG. 31 shows the algorithm to find the intersection of two objects A and B. The intersection is denoted by A∩B.

At step 3110, the algorithm lets the set C be an empty set and {Aᵢ} be {A}. Then go to step 3115.

At step 3115, the algorithm checks if {A} or {B} is empty set. If either A or B is empty set, go to step 3180. Otherwise, go to step 3120.

At step 3120, the algorithm tests if A is equivalent to B. If they are equivalent, go to step 3175. Otherwise, go to step 3125.

At step 3125, the algorithm checks if A is a compound object. If it is not, go to 3170. Otherwise, go to step 3130.

At step 3130, the algorithm decomposes the object A one level down into a set of sub-objects {Aᵢ}. If there are repeated objects, delete the redundant objects. Mark the rest and go to step 3135.

At step 3135, the algorithm checks if there is any marked object in {Aᵢ}. If there is any marked object in {Aᵢ}, go to step 3140, and otherwise go to step 3160.

At step 3140, the algorithm takes a marked object A′ and unmarks it. Then go to step 3145.

At step 3145, the algorithm checks if A′ is contained in B by calling the algorithm in FIG. 27 with α substituted by A′ and A substituted by B′. If A′ is not contained in B, go to step 3135. Otherwise, go to step 3150.

At step 3150, the algorithm deletes A′ from {Aᵢ} and go to step 3155.

At step 3155, the algorithm appends A′ to the set C. Then go to step 3135.

At step 3160, the algorithm checks if there is any compound object in {Aᵢ}. If there is any compound sub-object in {Aᵢ}, go to 3165. Otherwise, go to step 3180.

At 3165, the algorithm replaces one of the most complex sub-objects by its one level further down sub-objects, and marks all new sub-objects. If there are repeated sub-objects in {Aᵢ}, delete all repeated sub-objects except one. The sub-object to be kept is an unmarked one if there is any unmarked object or any of the sub-objects if all sub-objects are marked. Also, delete any new generated sub-object that has been considered before. Then go to 3135.

At step 3170, the algorithm checks if object A is contained in object B by calling the algorithm in FIG. 27 with α substituted by A and A substituted by B. If object A is contained in object B, go to step 3175. Otherwise, go to step 3180.

At step 3175, the algorithm sets C={Aᵢ} and then go to step 3180.

At step 3180, the algorithm sets A∩B=C.

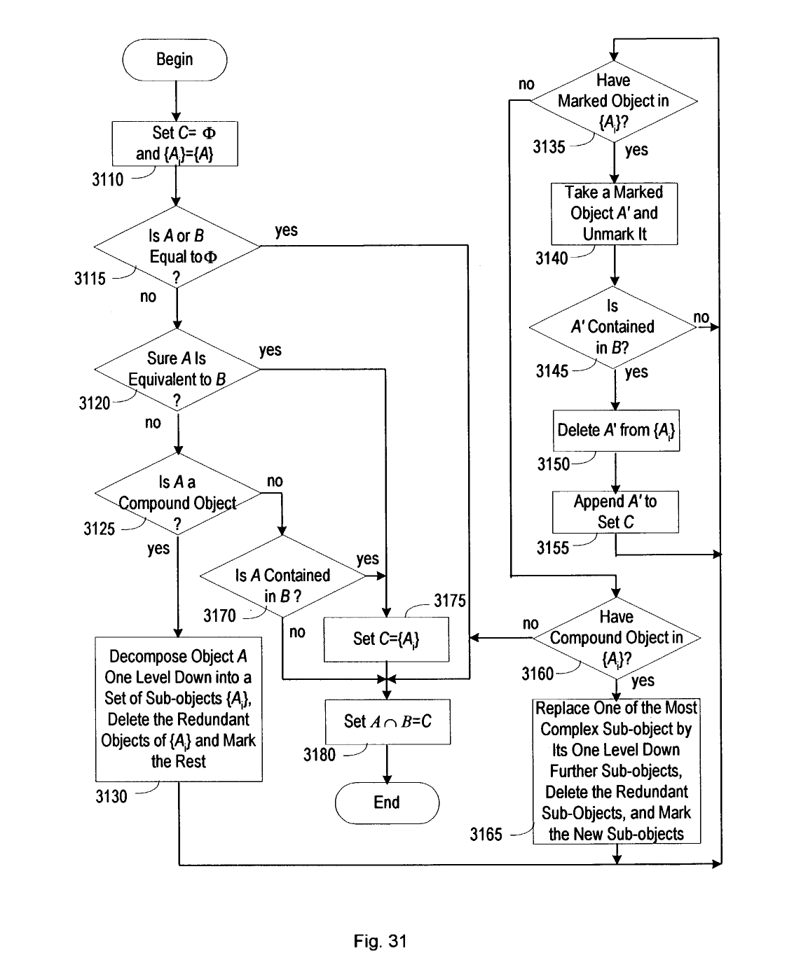

FIG. 32 shows the algorithm to find A∩B, A∪B, A-B, and B-A simultaneously.

Sometimes it may need to find all above the relations between A and B.

Both objects A and B are given.

At step 3210, the algorithm decomposes object A all the way down into a set of sub-objects {Aᵢ}, delete redundant objects, then go to step 3215.

At step 3215, the algorithm marks all the sub-objects. Go to step 3220.

At step 3220, the algorithm decomposes object B all the way down into a set of sub-objects {Bⱼ}. Delete redundant objects. Then go to step 3225.

At step 3225, set the intersection, the union, the relative complement of A in B, and the relative complement of B in A be empty. Go to step 3230.

At step 3230, the algorithm checks if either {Aᵢ} or {Bⱼ} is empty set. If yes, go to step 3255. If not, go to step 3235.

At step 3235, the algorithm checks if there is any marked object in {Aᵢ}. If no, go to step 3255. Otherwise, go to step 3240.

At step 3240, the algorithm takes a marked object A′ and unmarks it. Go to step 3245.

At step 3245, the algorithm checks if there is an equivalent object in {Bⱼ}. If no, go to step 3230; otherwise go to step 3250.

At step 3250, the algorithm appends the sub-object A′ into A∩B, and deletes it from {Aᵢ} and {Bⱼ}. Go to step 3230.

At step 3255, the algorithm sets A-B={Aᵢ}, B-A={Bⱼ}, A∪B=A∩B)∪(A-B)∪(A-B) and returns A∩B, A-B, B-A, and A∪B.

FIG. 33 shows an example of information map depicting the routine relations among a set of definitions. Here the routine relation is based on if a concept is derived directly from another concept. When one concept is derived directly from another concept, then these two concepts have a routine relation and an arrow is drawn from the second one to the first one. For simplicity, one can say the first concept contains the second one.

Semigroup, 3310, is contained directly in a group, 3315. Since the relation is based on “be contained directly”, there is an arrow from 3310 to 3315. The relations among the concepts ring 3320, ring with unit element 3325, commutative ring 3335, commutative ring with unit element 3330, integral domain 3340, abelian group 3345, module 3350, vector space 3355, division ring 3360, and field 3365 are also based on “be contained directly”. The relations are also shown in FIG. 33.

After each node has been linked to its corresponding object, when user clicks a node, the corresponding description about the object will be displayed.

FIG. 34 is an example of information map with both routine relations and area relations. It just likes FIG. 33 except more properties are shown there. First, semigroup 3410, group 3415, abelian group 3445 all belong to an algebraic structure with one composition, which is generally denoted by an ordered pair (K,+), where K is the set and + is the composition. Second, the ring 3420, ring with unit element 3425, commutative ring 3435, commutative ring with unit element 3430, integral domain 3440, division domain 3465, and field 3465 all have an algebraic structure with two compositions. The algebraic structure is generally be denoted by an ordered triad (E, +, *) with one set and two compositions. Where E is the set, + is the first composition, and * is the second composition on. Third, the module 3450 and vector space 3455 are ordered triples (K, E, . . . ) with K is ring or division ring, E is Abelian group, and is a function from the Cardetian product K×E into E. User could define area relations based on if an object could be described by an ordered pair (K,+), or an ordered triad (E, +, *), or an ordered triples (K, E, . . . ). The cloudy shape 3470 includes all the objects with an ordered pair (K,+), the cloudy shape 3475 includes all the objects with an ordered triad (E, +, *), and the cloudy shape 3480 includes all the objects with an ordered triples (K, E, . . . ). Each cloudy shape could be filled by a different color or filled with a different pattern. After each cloudy shape has been linked to corresponding property, when user clicks inside a cloudy shape, the corresponding property will be displayed.

FIG. 35 shows the relation between two objects in an information map. There is an arrow 3520 from semigroup 3510 to group 3530. When user clicks semigroup 3510, user could zoom in to check all related aspects of semigroup 3510, such as definition, observation, related theorems, etc. Some property could be assigned the arrow 3520 so that when user clicks the arrow 3520, a text or figure will display the difference between a semigroup and a group, as in the cloudy shape 3540.

FIG. 36 shows an example of preparing and exploring an object from different aspects. This example is in form of graphic interface. In this example, an author is lead to fill each of the desired aspects of a theorem and a reader is lead to examine a theorem from every aspect. When user examines a theorem 3650, the user could check the observation 3610, the explanation 3620, the typical applications 3630, outline of each of its proofs, the various proofs, and the various related problems 3670. Further, user could examine the specialization 3680, and the generalization 3690 of the theorem.

FIG. 37 shows another example of preparing and exploring an object from different aspects. This example is in form of tab control. In this example, the theorem has associated observation, explanation, one or more proofs, one or more applications, problem 1 and problem 2, a text description of the theorem, and a mathematical expression of the theorem. Under the tag of proofs, there could be several sub-tags labeled as 1, 2, 3, etc. for different ways of proof.

FIG. 36 and FIG. 37 are just two examples of exploring object. More forms for displaying an object are possible. People may prefer a form better than another form for a specific type of object. The different forms may be converted to each other.

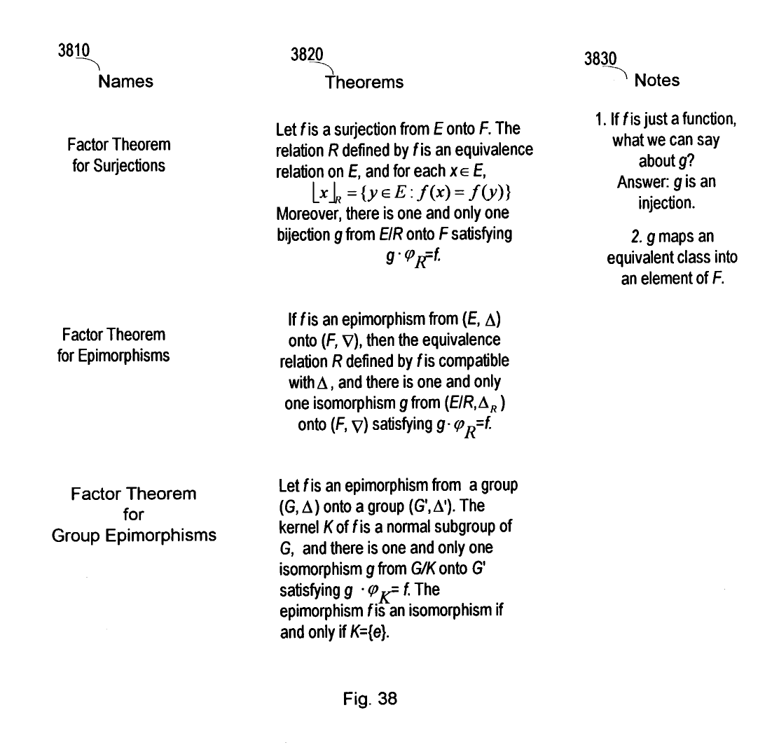

FIG. 38 shows comparison among a group of theorems in a boundless table. In this example, the theorem names are shown under the column of name 3810, the descriptions in the column of theorem 3820. A custom column called notes 3830 is also included. There are two user notes with the factor theorem for subjections. The keywords in the description of these theorems could be highlighted. When user clicks a highlighted keyword, a definition of the keyword will be displayed.

What is claimed is:

1. A system for aiding study comprising:
teaching means for helping an author to describe objects from various aspects and for helping a reader to access information about said objects dynamically;
learning means for guiding a reader to survey a resource and to examine objects systematically and for letting said reader input new objects into database, establish links among objects, attach tags, and take notes;
solving problem means for letting a reader search for related objects and display said related objects in various forms and providing said reader advice on solving a problem;
displaying means for displaying objects in various formats by letting a user specify displaying format and by preparing objects in forms selected from the group consisting of window, cloud, table, map, figure, graphic interfaces with hot links, and cascaded multiple windows with each window having a tab and for providing said user various ways to view objects, wherein said various ways include zooming in, zooming out, moving up, moving down, moving left, moving right, moving one level up, and moving one level down;
searching means for letting a user search for related objects, consisting of searching object by subject, searching object by keyword, and searching object by tag, wherein said searching object by subject is to display all objects under a subject, let said user select an object from said all objects, then display all the sub-objects under said object, and so on, wherein searching object by keyword is to specify keywords, define search rule, and find all the objects connected to said keywords, and wherein searching object by tag is to specify a tag and find all the objects associated with said tag; and
linking means for letting a user building relations among objects by establishing internal connections among objects and for displaying said relations by approaches selected from the group consisting of lines, arrows, boundary shapes, tags, and highlights, wherein each line with different color, pattern, and weight represents a different relation.

2. The system of claim 1, further comprising:
reviewing means for guiding a reader to review objects systematically by generating a review guide, letting said reader modify said review guide, and linking hot objects with corresponding generated subroutines, wherein each generated subroutine consists of a series of preprogrammed actions and guides said reader to review an object from various aspects;
taking test means for testing a reader by generating blank-filling problems, true-and-false problems, and multiple choice problems, wherein each blank-filling problem is obtained by selecting a statement and displaying the statement with a word blanked, wherein each true-and-false problem is created by selecting a statement, replacing a word in the statement by one selected from the group consisting of the word, its synonyms, its antonyms, similar words, and unrelated words, and displaying the modified statement, wherein each multiple choice problem is produced by selecting a statement, blanking a word in the statement, supplying words selected from the group consisting of the word, its synonyms, its antonyms, similar words, and unrelated words, and displaying the modified statement;
comparing means for finding relations between two objects by describing objects in set language, detecting if said two objects are identical, if said two objects are equivalent, and if an object is contained in another object, and finding out the relative complement of an object in another object, the union of said two objects, and the intersection of said two objects;
feedback means for modifying help level, changing teaching strategy, and altering problem assignment by capturing reader's response, said response including time escaped, typed text, captured voice, and selection; and
regulating means for preprocessing input information by methods selected from the group consisting of symbol substitution, separation, completion, combination, recapitulation, and decomposition.

3. The system of claim 1, further comprising:
updating means for adding a new object, modifying an existed object, and marking a plurality of interchangeable objects equivalent;
loading information means for loading, displaying, modifying, and saving a user's information;
read training means for tutoring a reader how to read effectively and efficiently by tracking the progress of said reader, shifting focus, and adjusting schedule;
calculation training means for teaching a reader how to do arithmetic operations quickly by tracking the progress of said reader and adapting strategy to said reader; and
memory training means training means for coaching a reader how to remember objects better by tracking the progress of said reader, finding out weak portion, and changing focus.

4. The system of claim 1, wherein teaching means includes:
setting up means for letting an author specify general writing arrangement, for letting a reader specify general reading arrangement, indicate help requirements, and assign a default display format for each type of objects, and for letting a user select default aspects about each type of objects under consideration;
general writing guide means for generating a writing guide by creating a writing template based on author's selection through said setting up means, letting said author modify said writing template to produce a modified writing template, and associating hot objects on said modified writing template with generated subroutines;
general reading guide means for generating a reading guide by creating a reading template based on reader's selection through said setting up means, letting said reader modify said reading template to produce a modified reading template, and associating hot objects on said modified reading template with generated subroutines; and
subroutine generating means for generating a subroutine to guide said author to describe an object systematically from every aspect selected by said author with said setting up means and for generating a subroutine to guide said reader to examine an object systematically from every aspect selected by said reader with said setting up means.

5. The system of claim 1, wherein learning means includes:
setting up means for letting a reader select default aspects about each type of objects and indicate a help level;
overall guide means for generating a reading guide by asking questions and giving advice to guide said reader to search for related information from a resource and providing interface for reader to write down important objects and link hot objects to generated subroutines; and
subroutine generating means for generating a subroutine to guide said reader to examine an object systematically from each aspect and provide interface for said reader to fill information about said each aspect.

6. The system of claim 1, wherein solving problem means includes:
setting up means for letting a reader specify problem type;
understanding problem means for helping said reader to understand said problem by raising a series of questions and recommendations and providing interface for said reader to describe the problem;
finding connection means for helping said reader to find the connection between the known and the unknown of said problem by raising a series of questions and recommendations and providing interface for said reader to indicate the connection;
carrying out plan means for guiding said reader to actually solve said problem by raising a series of questions; and
looking back means for guiding said reader to explore said problem further by raising a series of questions and recommendations and providing interface for said reader to work on.

7. A method for helping an author to organize and present information and for helping a reader to access and organize information in a study aid system, said study aid system consisting of input devices, output devices, CPU, and databases, said method comprising:
setting up means for letting said author specify general writing arrangement, for letting said reader specify general reading arrangement, indicate help requirements, and assign a default display format for each type of objects, and for letting a user select default aspects about each type of objects;
general writing guide means for generating a writing guide by creating a writing template based on said author's selection through said setting up means, letting said author modify said writing template to produce a modified writing template, and associating hot objects on said modified writing template with generated subroutines;
general reading guide means for generating a reading guide by creating a reading template based on said reader's selection through said setting up means, letting said reader modify said reading template to produce a modified reading template, and associating hot objects on said modified reading template with generated subroutines;
subroutine generating means for generating a subroutine for helping said author to describe an object systematically from each aspect selected by said author through said setting up means and for generating a subroutine for helping said reader to examine an object systematically from each aspect selected by said reader through said setting up means; and
linking means for letting said user building relations among objects by establishing internal connections among objects and for displaying said relations by approaches selected from the group consisting of lines, arrows, boundary shapes, tags, and highlights, wherein each line with different color, pattern, and weight represents a different relation.

8. The method of claim 7, further comprising:
layering means for guiding said reader to access information by letting said author associate each aspect of an object with a layer number and associate each description of a same aspect with a sub-layer number and by letting said reader examine objects layer by layer, wherein layer number reflects the relative difficulty to understand an aspect and sub-layer number reflects the relative difficulty to understand a description;
converting means for transforming information from one form to a different form by letting said author prepare description in first form, specify which portion of said description will be available to second form and which portion of said description will be available only to said first form, copy related portion of said description from said first form to said second form, and edit the description in said second form;
designing course means for generating a study itinerary for said reader by letting said reader specify at least one of the starting points and at least one of the desired points, finding out the paths from said starting points to said desired points, and letting said reader select one path from said paths and modify the path;
evaluating progress means for estimating how well said reader understand a particular topic by capturing reader's response, said response including time escaped, typed text, captured voice, and selection.

9. The method of claim 7, further comprising:
searching means for letting said user search for related objects, consisting of searching object by subject, searching object by keyword, and searching object by tag, wherein said searching object by subject is to display all objects under a subject, let said user select an object from said all objects, then display all the sub-objects under said object, and so on, wherein searching object by keyword is to specify keywords, define search rule, and find all the objects connected to said keywords by rule, and wherein searching object by tag is to specify a tag and find all the objects associated with said tag;
taking note means for letting said reader locate related objects from notes quickly and find related notes from objects quickly by providing interface for said reader to write down notes and to draw figures and by linking said notes and said figures to related objects, wherein said notes consist of comments, questions, conjectures, and reminder; and
tagging means for finding objects with a particular property quickly by letting said reader put a tag on objects with said property, wherein said tag is a label selected from the group consisting of bookmarks, keywords, property identifiers, methodology indicators, and aspect markers.

10. A method for helping a reader to study a resource comprising:
setting up means for letting said reader select default aspects about each type of objects and help options;
overall guide means for generating a reading guide by asking questions and giving recommendations to guide said reader to search for related information from said resource and providing interface for said reader to write down important objects and link hot objects to generated subroutines;
subroutine generating means for generating a subroutine to guide said reader to examine an object systematically from each aspect selected by said reader through said setting up means and to provide interface for said reader to fill information about said object from each aspect;
searching means for letting said reader search for related objects, consisting of searching object by subject, searching object by keyword, and searching object by tag, wherein said searching object by subject is to display all objects under a subject, let said reader select an object from said all objects, then display all the sub-objects under said object, and so on, wherein searching object by keyword is to specify keywords, define search rule, and find all the objects connected to said keywords by rule, and wherein searching object by tag is to specify a tag and find all the objects associated with said tag;
displaying means for displaying objects in various formats by letting said reader specify displaying format and preparing objects in forms selected from the group consisting of window, cloud, table, map, figure, graph with hot link, and cascaded multiple windows with each window having a tab and for providing said reader various ways to view objects, wherein said various ways include zooming in, zooming out, moving up, moving down, moving left, moving right, moving one level up, and moving one level down; and
linking means for letting said reader building relations among objects by establishing internal connections among objects and for displaying said relations by approaches selected from the group consisting of lines, arrows, boundary shapes, tags, and highlights, wherein each line with different color, pattern, and weight represents a different relation.

11. The method of claim 10, further comprising:
exploring means for letting said reader examine an object from various point of views by displaying interfaces with each interface linked to a corresponding aspect of said object;
comparing means for finding relations between two objects by describing objects in set language, detecting if said two objects are identical, if said two objects are equivalent, and if an object is contained in another object, and finding out the relative complement of an object in another object, the union of said two objects, and the intersection of said two objects;
taking note means for letting said reader locate related objects from notes quickly and find related notes from objects quickly by providing interface for said reader to write down notes and to draw figures and by linking said notes and said figures to related objects, wherein said notes consist of comments, questions, conjectures, and reminder; and
tagging means for finding objects with a particular property quickly by letting said reader put a tag on objects with said property, wherein said tag is a label selected from the group consisting of bookmarks, keywords, property identifiers, methodology indicators, an aspect markers.

12. The method of claim 11, wherein exploring means is arranged to provide the following services:
displaying related sub-objects in form of map;
displaying related sub-objects in form of table;
displaying related sub-objects in form of boundary shape;
providing graphic interfaces with each interface linked to display a corresponding a sub-object;
displaying said object by figure; and
displaying related sub-objects by cascaded multi-windows with tabs.

13. The method of claim 10, further comprising:
subroutine executing means for displaying and managing all the generated subroutines;
evaluating progress means for estimating how well said reader understand a particular topic by capturing reader's response, said response including time escaped, typed text, captured voice, and selection;
reviewing means for guiding said reader to review objects systematically by generating a review guide, letting said reader modify said review guide, and linking hot objects with corresponding generated subroutines, wherein each generated subroutine consists of a series of preprogrammed actions and guides said reader to review an object from various aspects;
taking test means for test said reader by generating blank-filling problems, true-and-false problems, and multiple choice problems, wherein each blank-filling problem is obtained by selecting a statement and displaying the statement with a word blanked, wherein each true-and-false problem is created by selecting a statement, replacing a word in the statement by one selected from the group consisting of the word, its synonyms, its antonyms, similar words, and unrelated words, and displaying the modified statement, wherein each multiple choice problem is produced by selecting a statement, blanking a word in the statement, supplying words selected from the group consisting of the word, its synonyms, its antonyms, similar words, and unrelated words, and displaying the modified statement; and
updating means for adding a new object, modifying an existed object, and marking a plurality of interchangeable objects equivalent.

14. A method for helping a reader to review objects systematically comprising:
setting up means for letting said reader specify the review scope and review aspects of each type of objects under consideration;
overall guide means for guiding said reader to review by displaying related objects in a window, letting said reader to modify said window, and linking related objects to corresponding generated subroutines;
subroutine generating means for creating said generated subroutines to guide said reader to review objects systematically from each aspect selected by said reader through said setting up means, wherein each subroutine consists of a series of preprogrammed actions;
searching means for letting said reader search for related objects, consisting of searching object by subject, searching object by keyword, and searching object by tag, wherein said searching object by subject is to display all objects under a subject, let said reader select an object from said all objects, then display all the sub-objects under said object, and so on, wherein searching object by keyword is to specify keywords, define search rule, and find all the objects connected to said keywords by rule, and wherein searching object by tag is to specify a tag and find all the objects associated with said tag;
displaying means for displaying objects in various formats by letting said reader specify displaying format and preparing objects in forms selected from the group consisting of window, cloud, table, map, figure, graph with hot link, and cascaded multiple windows with each window having a tab and for providing said reader various ways to view objects, wherein said various ways include zooming in, zooming out, moving up, moving down, moving left, moving right, moving one level up, and moving one level down; and
linking means for letting said reader building relations among objects by establishing internal connections among objects and for displaying said relations by approaches selected from the group consisting of lines, arrows, boundary shapes, tags, and highlights, wherein each line with different color, pattern, and weight represents a different relation.

15. The method of claim 14 further comprising subroutine executing means for displaying and managing all the generated subroutines;
taking note means for letting said reader locate related objects from notes quickly and find related notes from objects quickly by providing interface for said reader to write down notes and to draw figures and by linking said notes and said figures to related objects, wherein said notes consist of comments, questions, conjectures, and reminder; and
tagging means for finding objects with a particular property quickly by letting said reader put a tag on objects with said property, wherein said tag is a label selected from the group consisting of bookmarks, keywords, property identifiers, methodology indicators, an aspect markers.

16. The method of claim 14 further comprising
comparing means for finding relations between two objects by describing objects in set language and then finding if said two objects are identical, if said two objects are equivalent, if an object is contained in another object, the relative complement of an object in another object, the union of said two objects, the intersection of two objects;
reforming means for preprocessing input information by a method selected from the group consisting of symbol substitution, separation, completion, combination, recapitulation, and decomposition;
solving problem means for letting said reader search for and display related objects in various forms and for guiding said reader to solve a problem by asking question and giving advice to help said reader to understand said problem, to find out connection between the known and the unknown, to carry out a plan, and to look back for further exploring said problem;
taking test means for testing said reader by generating blank-filling problems, true-and-false problems, and multiple choice problems, wherein each blank-filling problem is obtained by selecting a statement and displaying the statement with a word blanked, wherein each true-and-false problem is created by selecting a statement, replacing a word in the statement by one selected from the group consisting of the word, its synonyms, its antonyms, similar words, and unrelated words, and displaying the modified statement, wherein each multiple choice problem is produced by selecting a statement, blanking a word in the statement, supplying words selected from the group consisting of the word, its synonyms, its antonyms, similar words, and unrelated words, and displaying the modified statement; and
feedback means for modifying help level, changing teaching strategy, and altering problem assignment by capturing said reader's response, said response including time escaped, typed text, captured voice, and selection.

17. A method for helping a reader to solve a problem comprising:
setting up means for letting said reader specify problem type;
understanding problem means for helping said reader to understand said problem by raising a series of questions and recommendations, providing interface for said reader to describe said problem;
finding connection means for helping said reader to find the connections between the known and the unknown of said problem by raising a series of questions and recommendations and providing interface for said reader to indicate said connections;
carrying out plan means for guiding said reader to actually solve said problem by raising a series of questions;
looking back means for guiding said reader to explore said problem further by raising a series of questions and recommendations;
searching means for letting said reader search for related objects, consisting of searching object by subject, searching object by keyword, and searching object by tag, wherein said searching object by subject is to display all objects under a subject, let said reader select an object from said all objects, then display all the sub-objects under said object, and so on, wherein searching object by keyword is to specify keywords, define search rule, and find all the objects connected to said keywords by rule, and wherein searching object by tag is to specify a tag and find all the objects associated with said tag; and
linking means for letting said reader building relations among objects by establishing internal connections among objects and for displaying said relations by approaches selected from the group consisting of lines, arrows, boundary shapes, tags, and highlights, wherein each line with different color, pattern, and weight represents a different relation.

18. The method of claim 17 further comprising
feedback means for modifying help level, changing teaching strategy, and altering problem assignment by capturing said reader's response, said response including time escaped, typed text, captured voice, and selection;
intelligent question generation means for guiding said reader to work on detail by preparing advice and questions for problems in each smaller category, capturing said reader's response, classifying said problem into one of smaller categories, and raising corresponding questions and advice;
saving current status means for providing interface to save any component selected from the group consisting of said problem itself, data, unknown, symbol, auxiliary line, auxiliary problem, figure, partial of solution, attempt, and guess; and
recovering status means for retrieve any component saved for said problem.

19. A method for a user to take a self-test and play game comprising
means for generating a blank problem by selecting a statement, displaying said statement with a word blanked, and asking said user to fill blank;
means for generating a true and false problem by selecting a statement, replacing a word in said statement by one selected from the group consisting of its synonyms, its antonyms, similar words, and unrelated words, displaying the modified statement, and asking said user to judge if said modified statement is true or false;
means for generating a multiple choice problem by selecting a statement, blanking a word in said statement, supplying words selected from the group consisting of its synonyms, its antonyms, similar words, unrelated words, displaying the modified statement, and asking said user to judge if said modified statement is true or false;
means for listing related objects by listing part of the related objects, specifying requirement, and asking said user to list all other related objects; and
means for drawing a map by presenting a partially completed map, specifying requirement, and asking said user to make said partially completed map completed.

20. The method of claim 19 further comprising
means for said user specifying test scope and test type;
means for generating a modifying saved problem by modifying a problem saved in database, displaying the modified problem, and asking said user to solve said modified problem;
means for judging if the answer supplied by said user is correct by describing related objects in set language and then finding if said objects are equivalent;
means for showing score and sending feedback to said user.

21. A method for searching related objects from database comprising:
setting up means for a user specifying search rule and search scope;
displaying means for displaying objects in various formats by letting said user specify displaying format and preparing objects in forms selected from the group consisting of window, cloud, table, map, figure, graphic interfaces with hot links, and cascaded multiple windows with each window having a tab and for providing said user various ways to view objects, wherein said various ways include zooming in, zooming out, moving up, moving down, moving left, moving right, moving one level up, and moving one level down;
searching object by subject means for displaying all objects under a subject, letting said user select an object from said all objects, then displaying all the sub-objects under said object, and so on;
searching object by keyword means for searching for all the objects associated with a keyword by specifying keywords, defining search rule, and finding all the objects connected to said keywords by rule; and
searching object by tag means for searching for all the objects with a tag by specifying said tag and find out all the objects associated with said tag.

22. The method of claim 21 further comprising:
searching object by being referred means for searching for all objects being referred by an object;
searching object by referring means for searching for all objects referring to an object; and
searching object by sequence means for displaying all the objects according to a particular order.

23. A method for preparing and displaying object in various forms comprising:
building table means for presenting information about an object in form of table by specifying the form of table, specifying tags to be included, and filling the table with information under related tags;
building boundary text means for presenting information about an object in form of boundary text by specifying boundary shape, specifying tags to be included, and filling the boundary with information under related tags;
building map means for presenting the relations among a group of objects in form of map;
displaying means for displaying objects in various formats by letting a user specify displaying format and preparing objects in forms selected from the group consisting of window, cloud, table, map, figure, graph with hot link, and cascaded multiple windows with each window having a tab and for providing said user various ways to view objects, wherein said various ways include zooming in, zooming out, moving up, moving down, moving left, moving right, moving one level up, and moving one level down; and
viewing control means for viewing objects from various point of aspects by zooming in, zooming out, moving up, moving down, moving left, moving right, moving one level up, and moving one level down.

24. The method of claim 23 further comprising:
creating figure means for creating a figure and associating said figure with a related object;
creating voice means for creating voice file and associating said voice file with a related object; and
generating voice means for constructing pronunciation from a related voice file when an object is displayed.

25. The method of claim 23, wherein building map means comprises:
specifying relation means for letting said user specify relations and their graphic representatives;
building routine relation means for helping said user build a map consisting of routine relations for said group of objects;
building area relation means for helping said user build a map consisting of area relations for said group of objects; and
alignment means for helping said user make the same objects on different layout aligned up.

26. The method of claim 25, wherein building routine relation means comprise the following steps:
creating a node on a new layout with each node representing an object in said group of objects;
taking a routine relation;
searching database for a most likely matched map, showing the most likely matched map, and copying related part of said most likely matched map into said new layout;
taking two objects having not been considered for said routine relation and checking if said two objects have said routine relation;
establishing a connection between said two objects if said two objects have said routine relation and connecting said two objects by the corresponding representative of said routine relation;
linking each node to its corresponding object;
associating the corresponding representative of a routine relation to said routine relation; and
attaching specific property between two particular objects to the representative between said two particular objects.

27. The method of claim 25, wherein building area relation means comprise the following steps:
setting a set be empty and creating a new layout;
taking an area relation;
searching database for a most likely matched map, showing the most likely matched map, and putting related objects into said set;
taking an object having not been considered for said area relation and checking if said object has said area relation;
putting said object into said set if said object has said area relation;
drawing a shape for said set and generating nodes inside said shape with each node representing an object contained in said set;
linking each node to its corresponding object; and
associating the corresponding representative of an area relation to said area relation.

28. A method for regulating input object comprising:
symbol substitution means for replacing a symbol by a different symbol;
separation means for splitting an object into several small objects;
completion means for replacing a requirement on an object by a new requirement derived from said requirement and other requirements on said object;
combination means for merging several small objects into a big object;
recapitulating means for making an description of an object more concise by replacing said description in several more basic concepts by a description in a more advanced concept; and
decomposing means for replacing a complex object in the description of an object by the description of said complex object.

29. The method of claim 28, further comprising:
literal regulation means for making the literal description of an object close to standard description;
creating and modifying rule means for a user setting up the rule and changing the rule above acceptable formats;
searching for related example means for said user searching for related examples to serve as models;
tagging means for finding objects with a particular property quickly by letting said user put a tag on objects with said property, wherein said tag is a label selected from the group consisting of bookmarks, keywords, property identifiers, methodology indicators, an aspect markers; and
feedback means for modifying help level, changing teaching strategy, and altering problem assignment by capturing said user's response, said response including time escaped, typed text, captured voice, and selection.

30. A method for finding the relations between two objects, wherein each object is described by set language, comprising:
means for finding if two objects are identical;
means for finding if an object is contained in another object;
means for finding the relative complement of an object in another object;
means for finding the union of two objects;
means for finding if two objects are equivalent; and
means for finding the intersection of two objects.

31. The method of claim 30, wherein means for finding if an object is contained in another object comprises the following steps:
specifying two objects;
returning false if the first object is not related to the second object for sure;
returning true if said first object is contained in said second object for sure;
decomposing said second object into a first group of sub-objects and marking each sub-object in said first group of sub-objects;
taking a marked sub-object from said first group of sub-objects and unmarking said sub-object;
returning true if said first object is contained in said sub-object;
decomposing said first object into a second group of sub-objects and marking each sub-object in said second group of sub-objects; and
returning true if every sub-object in the second group of sub-objects is contained in said second object and returning false otherwise.

32. The method of claim 30, wherein means for finding the relative complement of a first object in a second object comprises the following steps:
setting a first set be empty, a second set be empty, and a third set be said second object;
setting the relative complement of said first object in said second object be empty set and returning if said third set is empty;
setting the relative complement of said first object in said second object be empty and returning if said second object is equivalent to said first object for sure;
decomposing said second object one level down into a group of sub-objects and assigning said group of sub-objects as said third set;
taking a sub-object from said third set;
setting said second set be said sub-object and deleting said sub-object from said third set if said sub-object is contained in said first object;
setting said second set be said sub-object if said sub-object is not contained in said first object and said sub-object is a compound object;
appending said sub-object to said first set and deleting said sub-object from said third set if said sub-object is not contained in said first object and said sub-object is not a compound object;
setting the relative complement of said first object in said second object be said third set and returning if said second set empty;
taking each sub-object in said third set, finding the relative complement of said first object in said sub-object, and appending said relative complement of said first object in said sub-object to said first set; and
setting the relative complement of said first object in said second object be said first set and returning.
